(19) United States
(12) Patent Application Publication
(10) Pub. No.: US 2015/0019317 A1
(43) Pub. Date: Jan. 15, 2015

(54) Systems and methods to enable offer and rewards marketing and CRM (network) platform

(71) Applicant: Spring Marketplace, Inc., Chicago, IL (US)

(72) Inventor: Bruce Mitchell, San Francisco, CA (US)

(73) Assignee: Spring Marketplace, Inc., Chicago, IL (US)

(21) Appl. No.: 14/329,781

(22) Filed: Jul. 11, 2014

Related U.S. Application Data
(60) Provisional application No. 61/845,984, filed on Jul. 13, 2013.

(51) Int. Cl. G06Q 30/02

(52) U.S. Cl. CPC G06Q 30/0226; G06Q 30/0238
USPC 705/14.27

(57) ABSTRACT

Systems and methods for providing and operating a customer loyalty and rewards platform including network-based and merchant-based registration and management, including mobile messaging, remote and local customer registration options, enrollment and automated payment card account association therewith.

### CROSS-REFERENCE TO RELATED APPLICATIONS

This application claims the benefit of U.S. Provisional Application No. 61/845,984 filed Jul. 13, 2013, which is incorporated herein by reference in its entirety.

### BACKGROUND OF THE INVENTION

1. Field of the Invention

The present invention relates to customer loyalty and rewards programs in electronic communications networks, and more particularly, systems and methods for providing and operating a customer loyalty and rewards platform including consumer or customer network-based and merchant-based registration and the management thereof

2. Description of the Prior Art

Generally, prior art is known to provide digital loyalty and rewards system and methods. By way of example, relevant prior art includes the following U.S. Patents and Publications:

U.S. Publication 2013/0073361 for “Methods and systems for offering targeted deals to customers and real-time automatic redemption thereof” filed on Sep. 20, 2012, describes wherein a customer can select from coupons to them, such as offers made to the customer (which may need to be purchased), vouchers purchased by the customer, and the like. A redemption choice is received from the cardholder indicating one or more coupons to ‘load’ onto the cardholder's card product. Information about offers, coupons, vouchers, etc., loaded onto a cardholder's card product can be stored in an offer deployment system. When the cardholder uses the card product to purchase a good or service, a transaction approval request is generated from at least one of a merchant, an acquirer, an association, a bank, and an issuer. The transaction approval request is processed wherein the step of processing comprises at least one of querying the offer deployment system which determines whether an offer loaded onto the cardholder's card product can be applied to the purchase. If so, the value of the offer is applied to the transaction. Preferably, offer value is applied to the amount of the transaction approval request before the request is received by the ultimate financial institution or card transaction processing system responsible for approving the transaction such that the amount of the transaction which must be approved is the purchase price of the good or service less the applied value of the offer. A receipt can be issued to the cardholder wherein the receipt indicates the purchase and use of the coupon.

U.S. Publication 2012/0191525 for “Systems and Methods to Facilitate Loyalty Reward Transactions” filed Jan. 23, 2012, describes wherein Reward communications can be processed as transactions over the communications system in a way similar to credit/debit transactions. The enhanced communications system allows simpler and/or more efficient implementation of complex loyalty programs, and provides new options for creating new loyalty programs. In one embodiment, a transaction handler for the processing of transactions on financial accounts, such as credit accounts, debit accounts, prepaid accounts, bank accounts, stored value accounts and the like, is configured to support transactions for crediting rewards to a reward account and/or transactions for redeeming rewards from a reward account.

U.S. Pat. No. 6,327,573 for “Multiple party reward system utilizing single account” filed Dec. 31, 1998, describes using one reward/loyalty card for multiple accounts and enabling a frequent shopper reward system capable of tracking performance data of a plurality of members or account holders linked to a single frequent shopper account. Additionally, the document discloses transacting with at least one of the present sub-account holders, calculating a reward level, allocating, to at least one of the present sub-account holders, at least a portion of the determined reward level, and updating the retrieved customer record.

U.S. Pat. No. 8,429,009 for “Universal Affinity System” filed Jul. 16, 2008, describes tracking loyalty/reward programs through the use of a third-party card or other medium. The system enables: a merchant to determine incentives, such as discounts, advertisements, or other offers, for a given customer or set of customers; uploaded these incentives to respective customer “personal account lockers”; and universal ID is encoded as a bar code, the bar code may be provided to a corresponding customer on a variety of different media, such as on an adhesive label that the customer may apply to another device or item, printed on a credit or debit card, printed on a key-chain card, or printed on any other device or item that a customer may be likely to carry with him or her.

U.S. Publication 2013/0054454 for “Wallet Service Enrollment Platform Apparatuses, Methods and Systems” filed Sep. 21, 2012, describes wherein a user may input username and password credentials into the wallet widget (e.g., 210) to get authenticated. The user may have control (e.g., create, view, manage, cancel, etc.) over the individual relationships and may configure permissions for each service they connect to. In one embodiment, the WSEP may allow approved services, issuers and merchants permissions to obtain various information relating to the user and wallet such as consumer profile 225, billing agreement 230, redemption 235, loyalty and rewards 240, coupons/offers 245, wish lists and stored items 250, merchant applications/widgets 255, Value Added Resellers (VAR)/Software-as-a-service (SaaS) commerce wallet plug-ins 260, analytics 265, account or points balance information 270, payments 275, and/or the like. In one implementation for example, the WSEP may manage which services can connect to the wallet. In a further implementation, the WSEP may pass along information from an approved and connected service such as a loyalty program (e.g., Star Woods Points program) to a merchant such that the merchant may provide the customer a special deal, offer or an opportunity to use or exchange points/currency when transacting. In one implementation, approved commerce services, issuers and merchants may be able to push information relating to any of the above to the wallet.

None of the prior art documents referenced herein or any known prior art provides the solutions to the longstanding unmet needs that are satisfied by the systems and methods of the loyalty platform of the present invention.

### SUMMARY OF THE INVENTION

The present invention relates to systems and methods for providing and operating a customer loyalty and rewards platform including network-based and merchant-based registration and management, including mobile and electronic messaging, remote and local customer user registration options, enrollment, and credit, debit, and other electronic payment card account association with the customer loyalty and rewards platform.

The present invention further provides credit, debit, electronic payment, and/or card account enrollment automatically, as well as the functions of adding promotional and/or discount offer(s) to profile, adding cards, credit, debit, and other electronic payment card accounts or electronic payment accounts, redeeming promotional or discount offers, real-time automated functionality, providing data for a marketplace of vendors and customers, including account and activity data, providing a coalition network model, and combinations thereof.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of a virtualized computing system for embodiments of the invention.

FIG. 2 is a schematic diagram of one embodiment of the invention.

FIG. 3 is a graphic user interface diagram of an embodiment of the invention.

FIG. 4 is another GUI diagram of an embodiment of the invention.

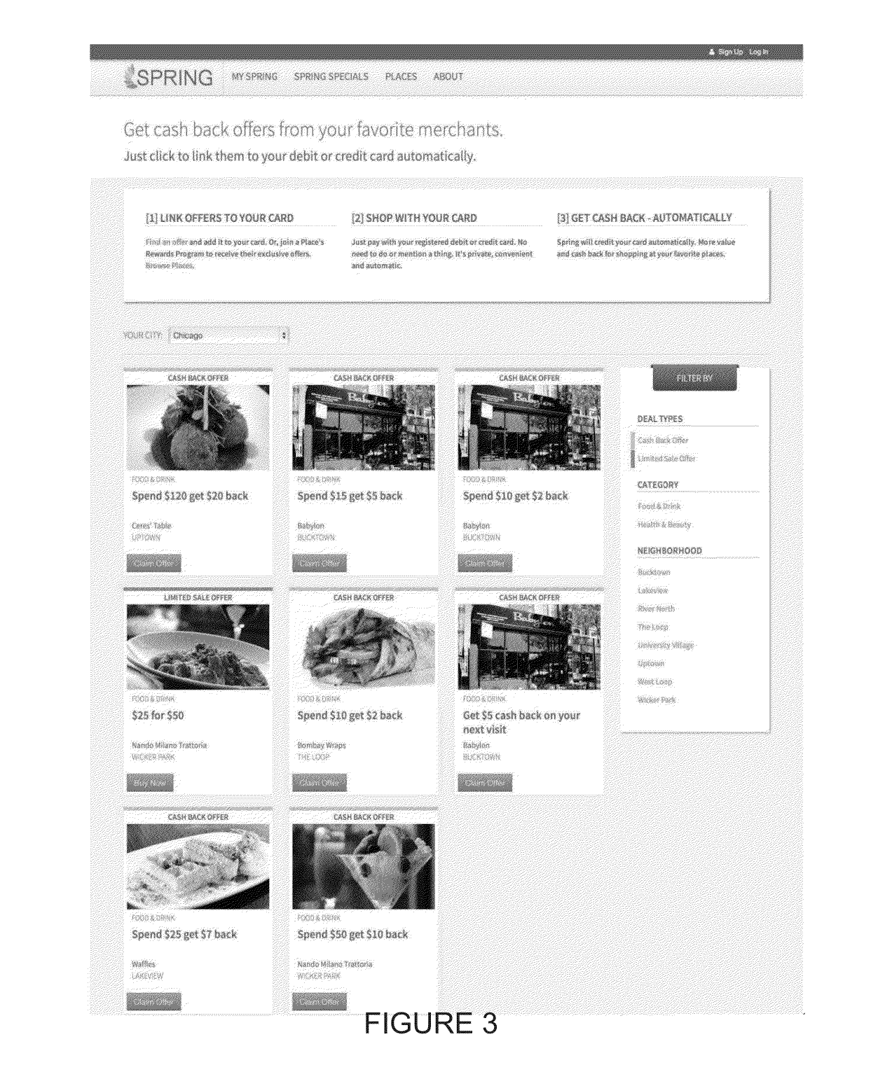

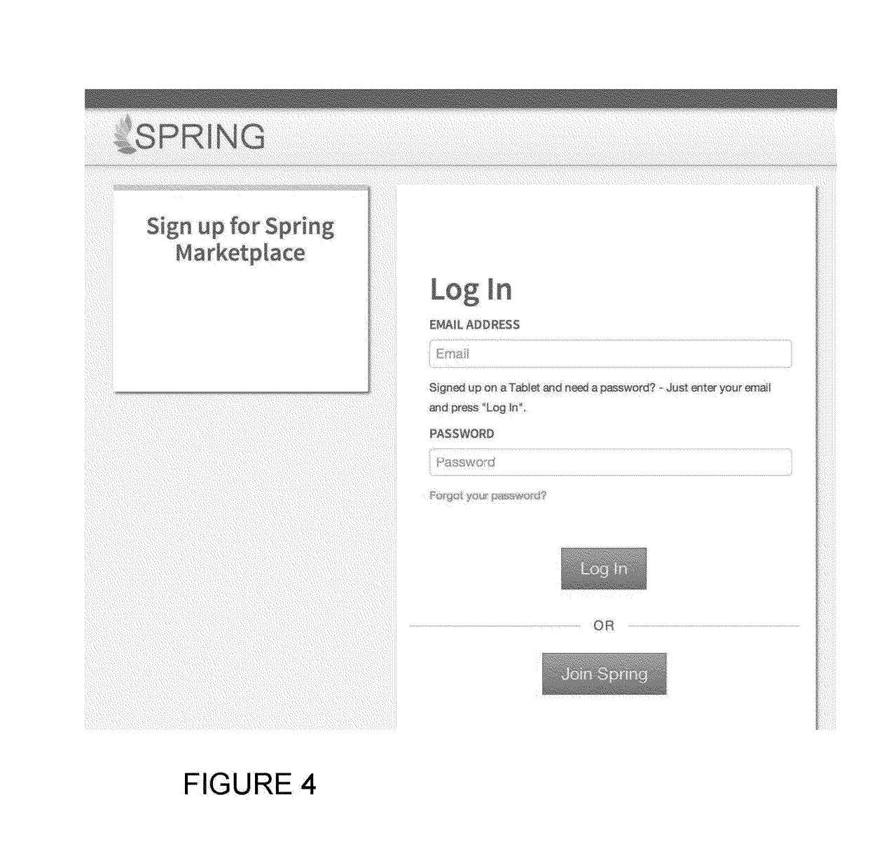

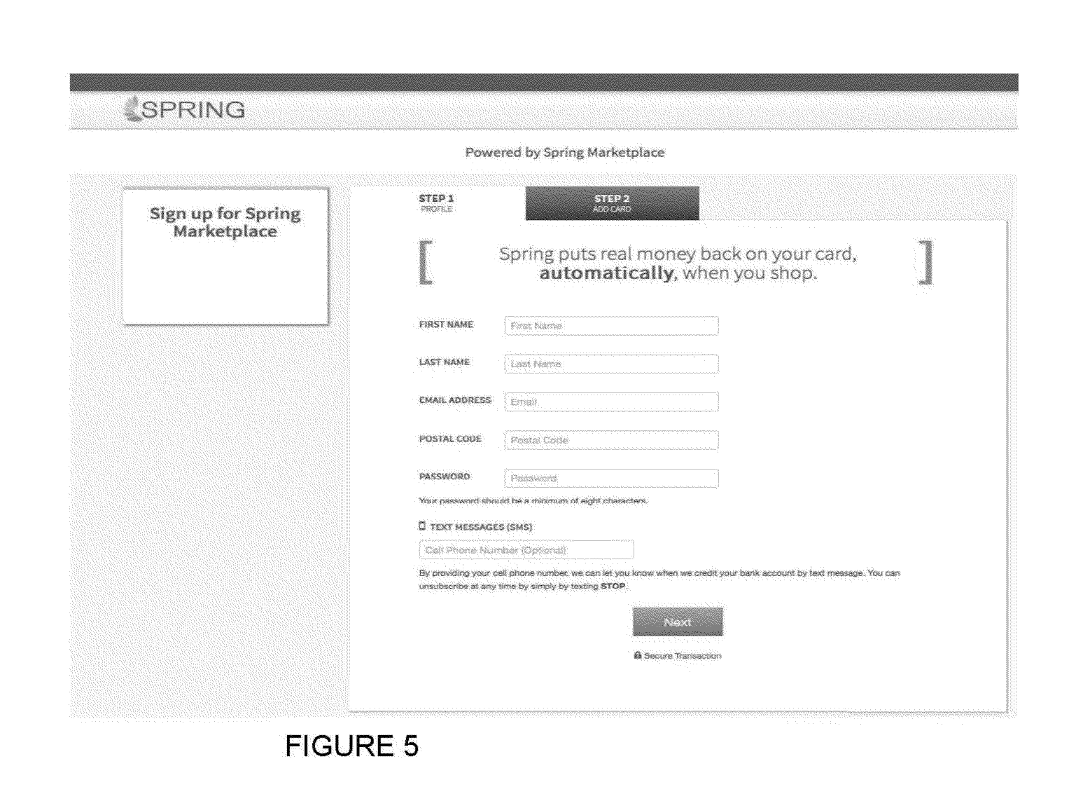

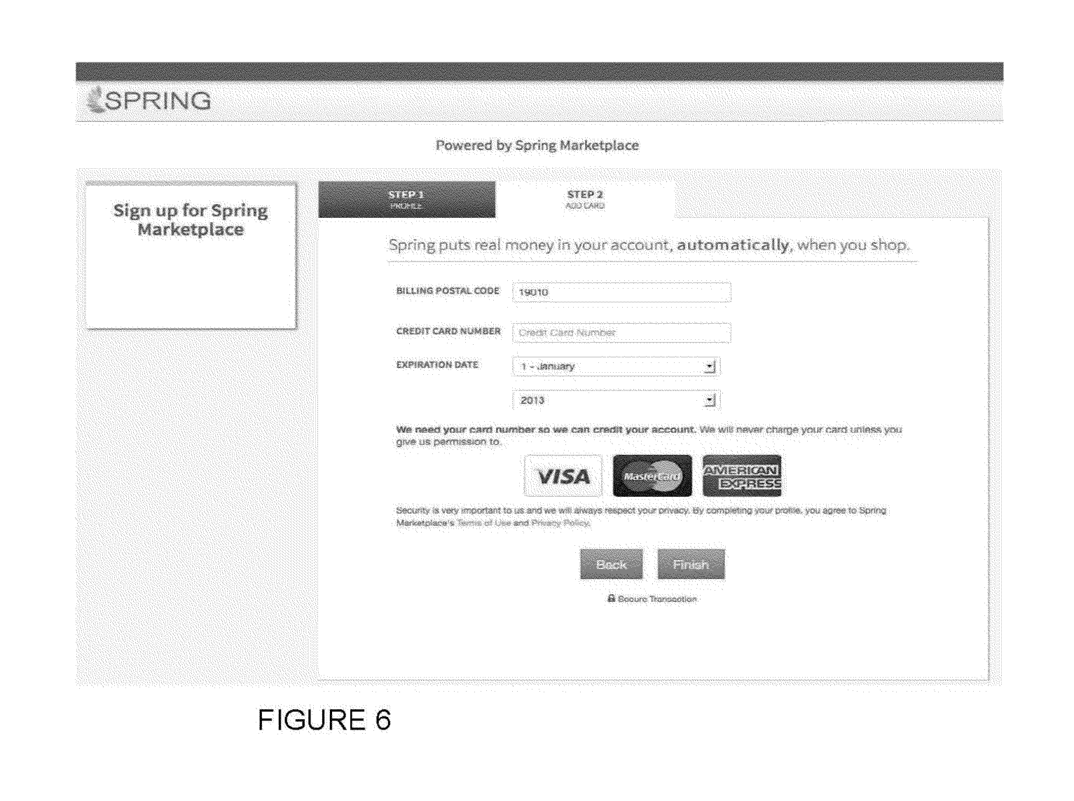

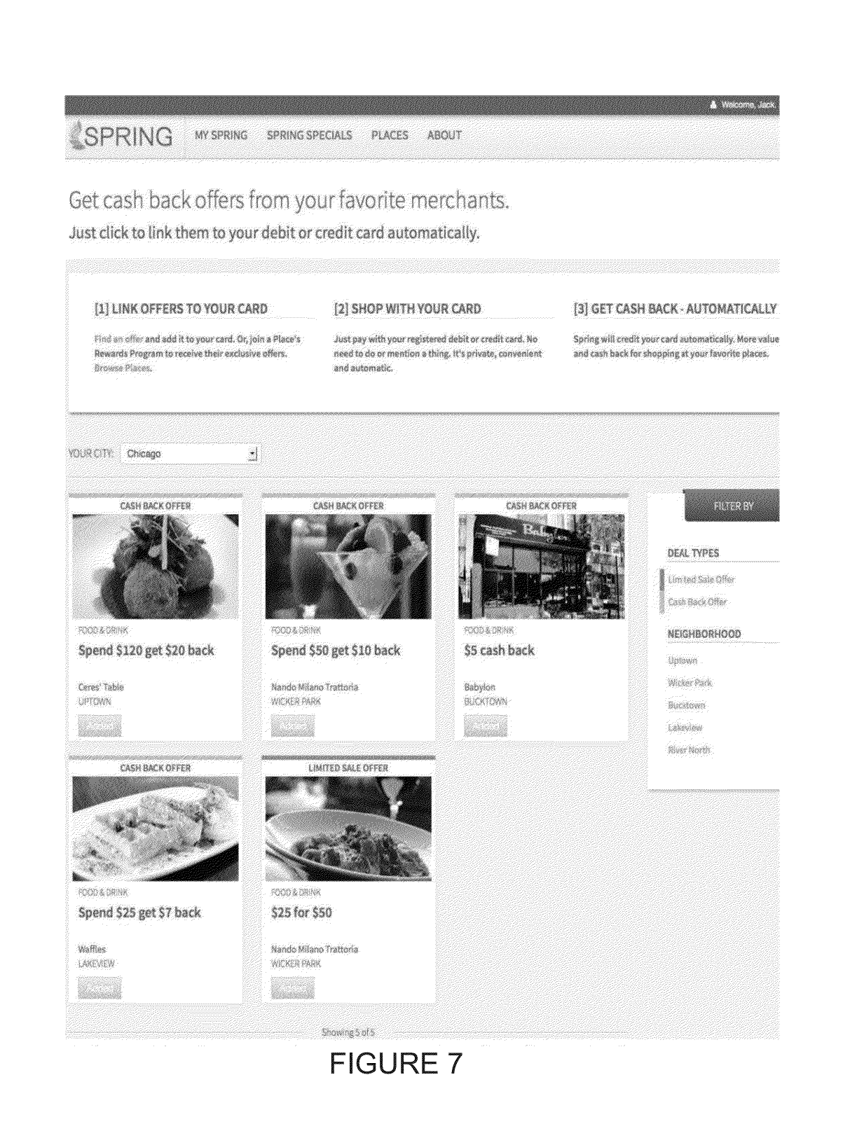

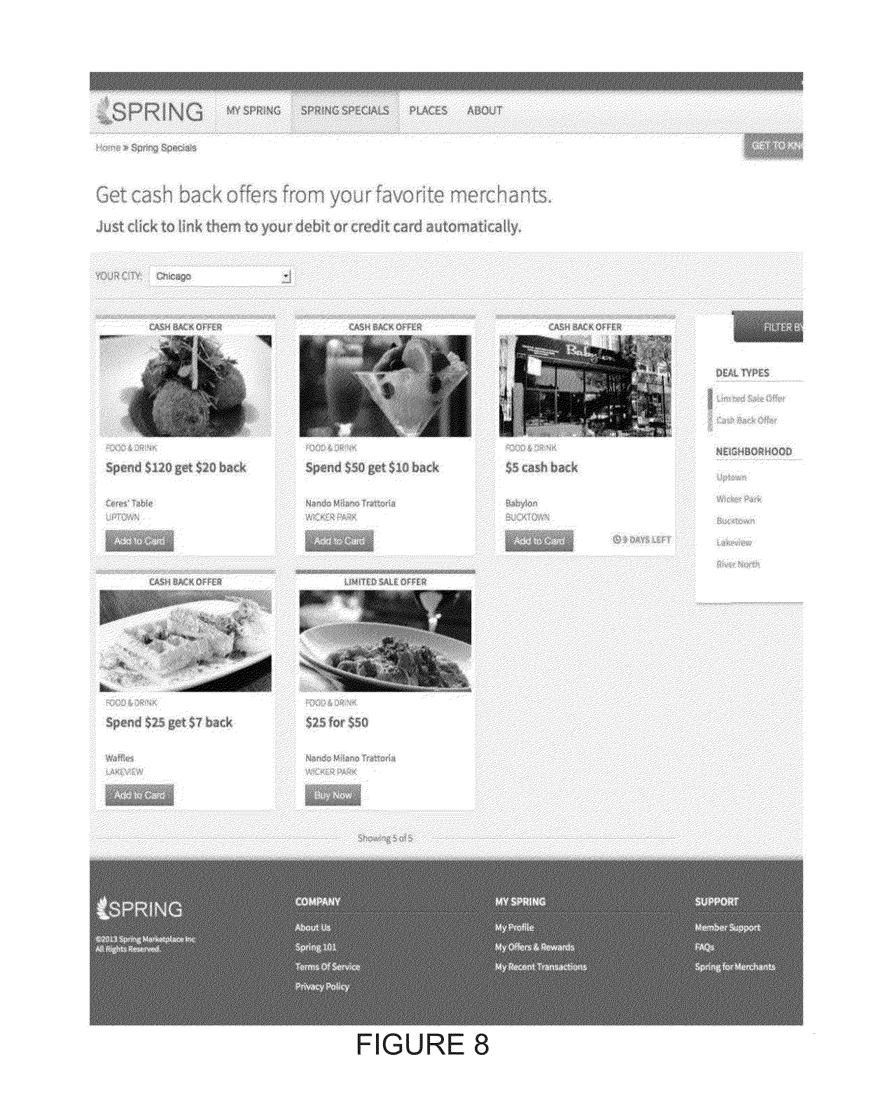

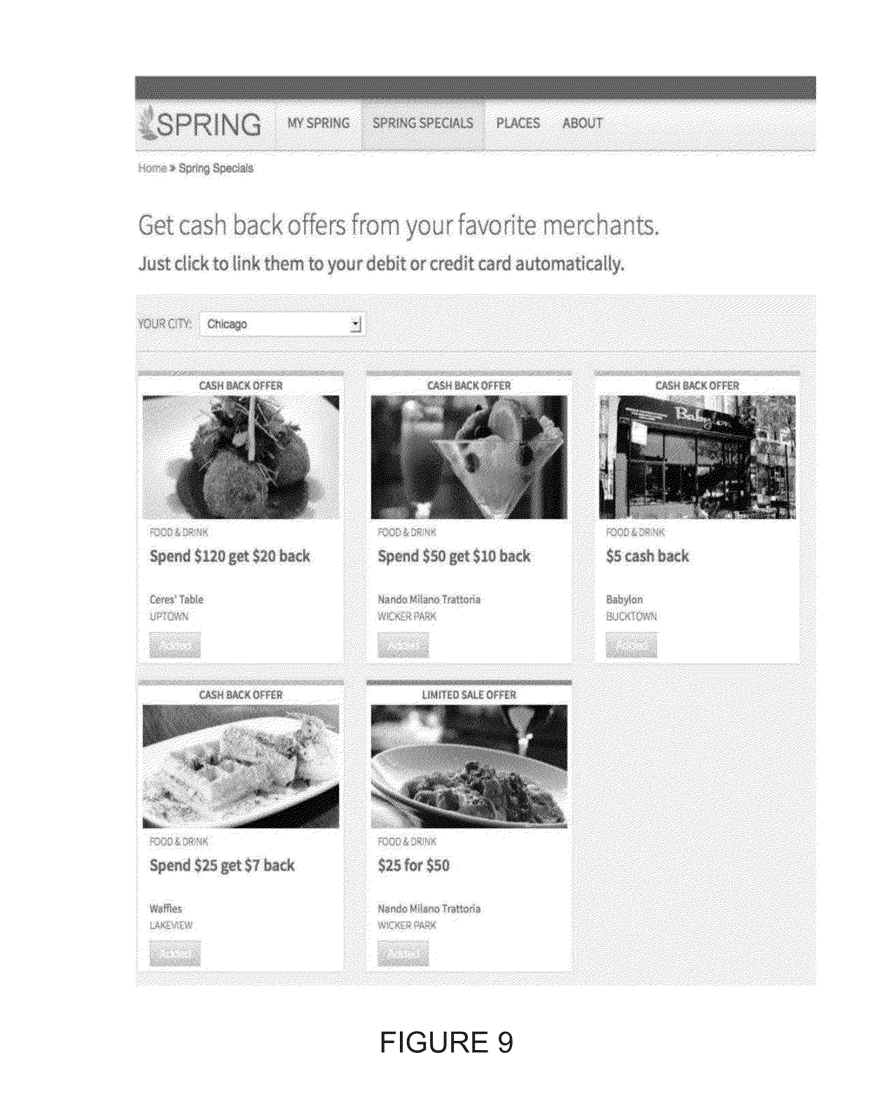

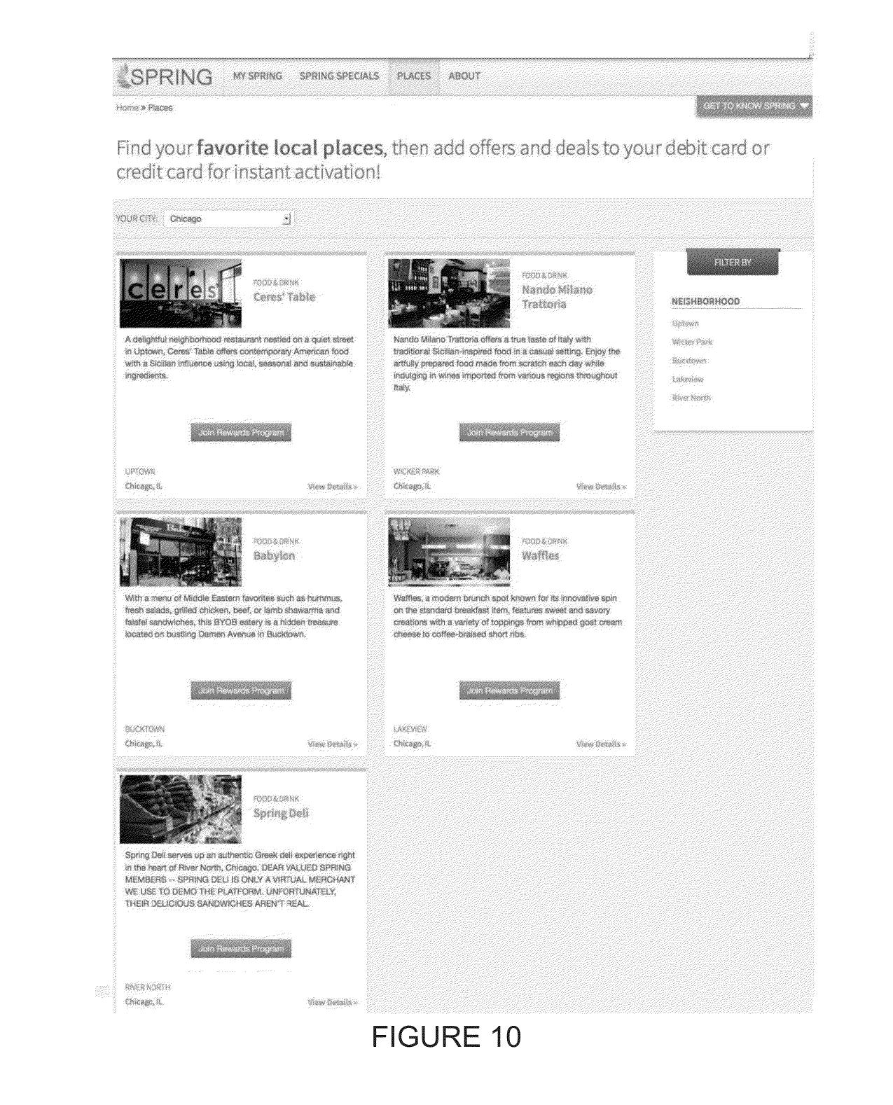

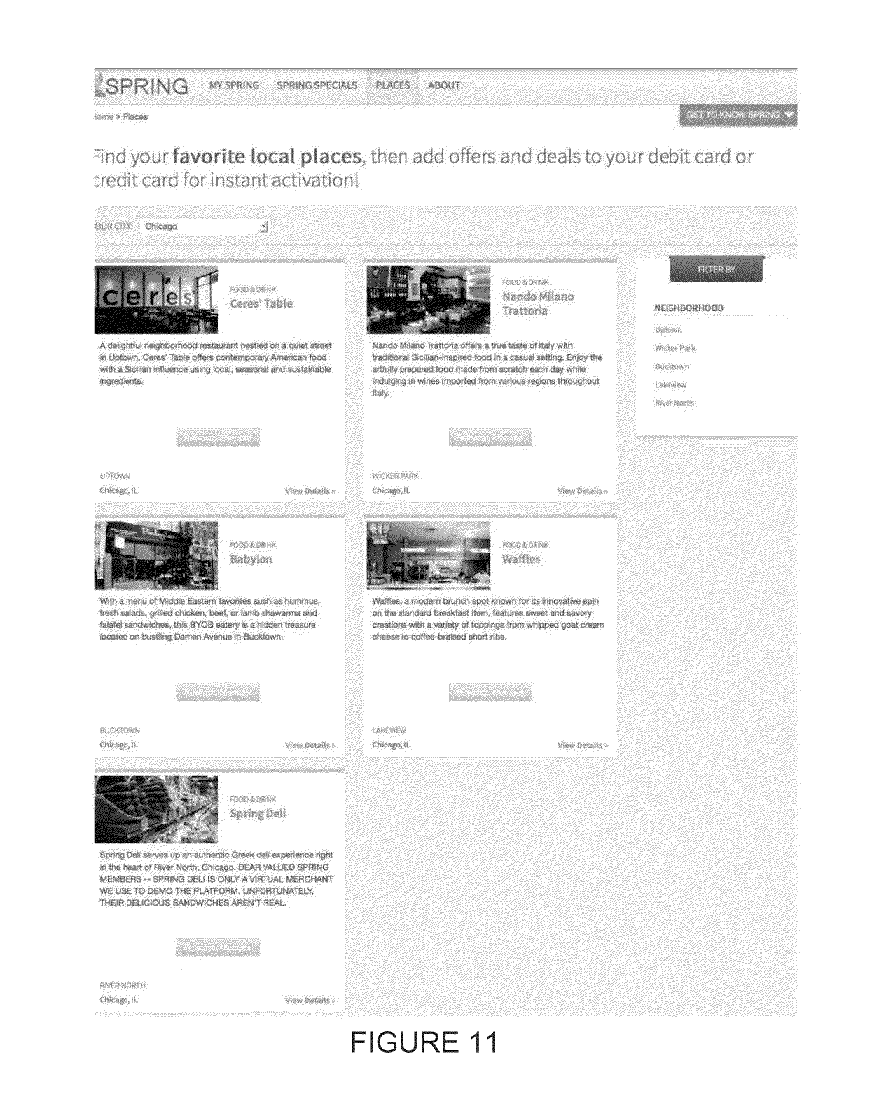

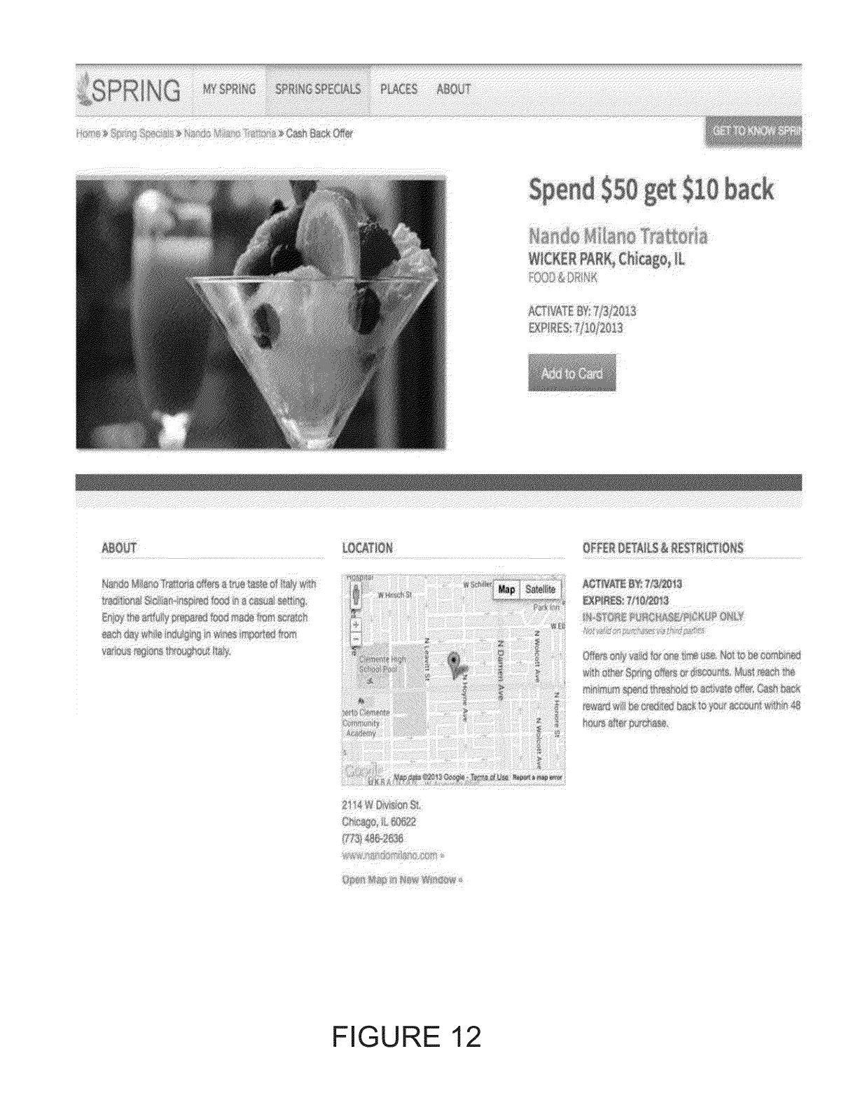

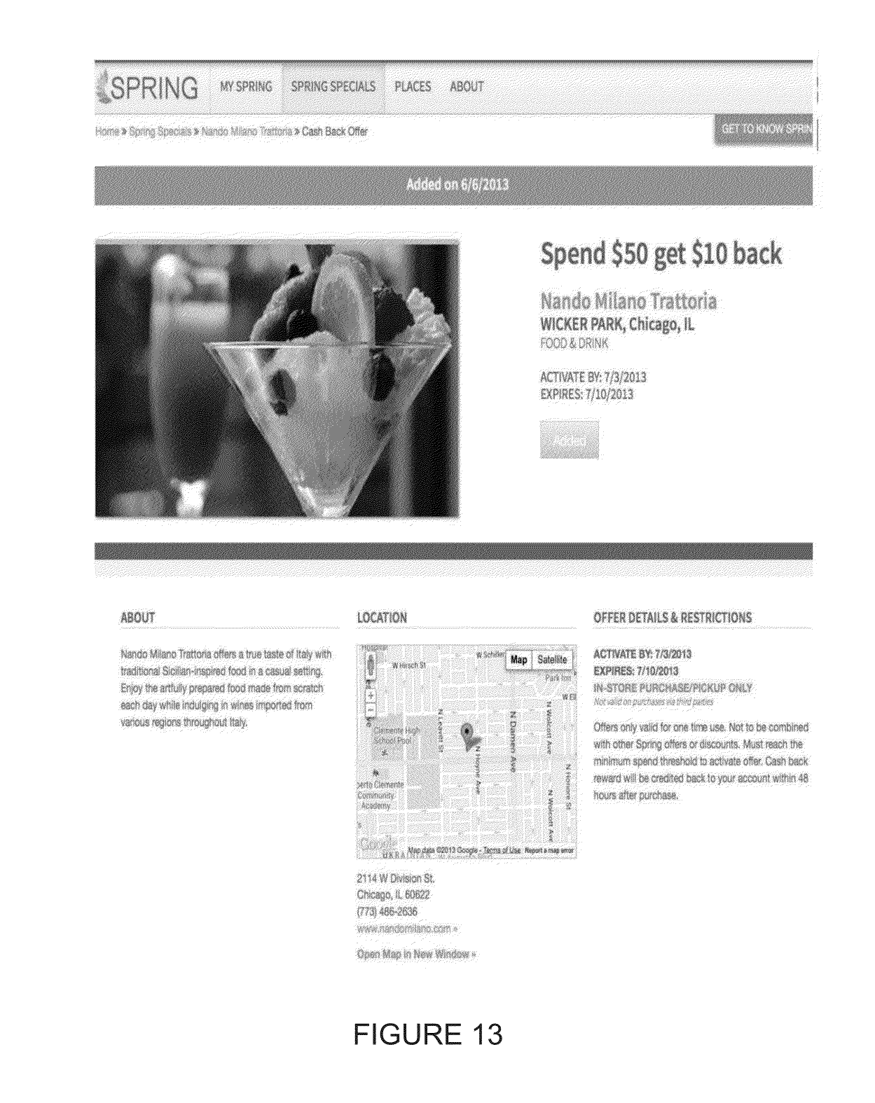

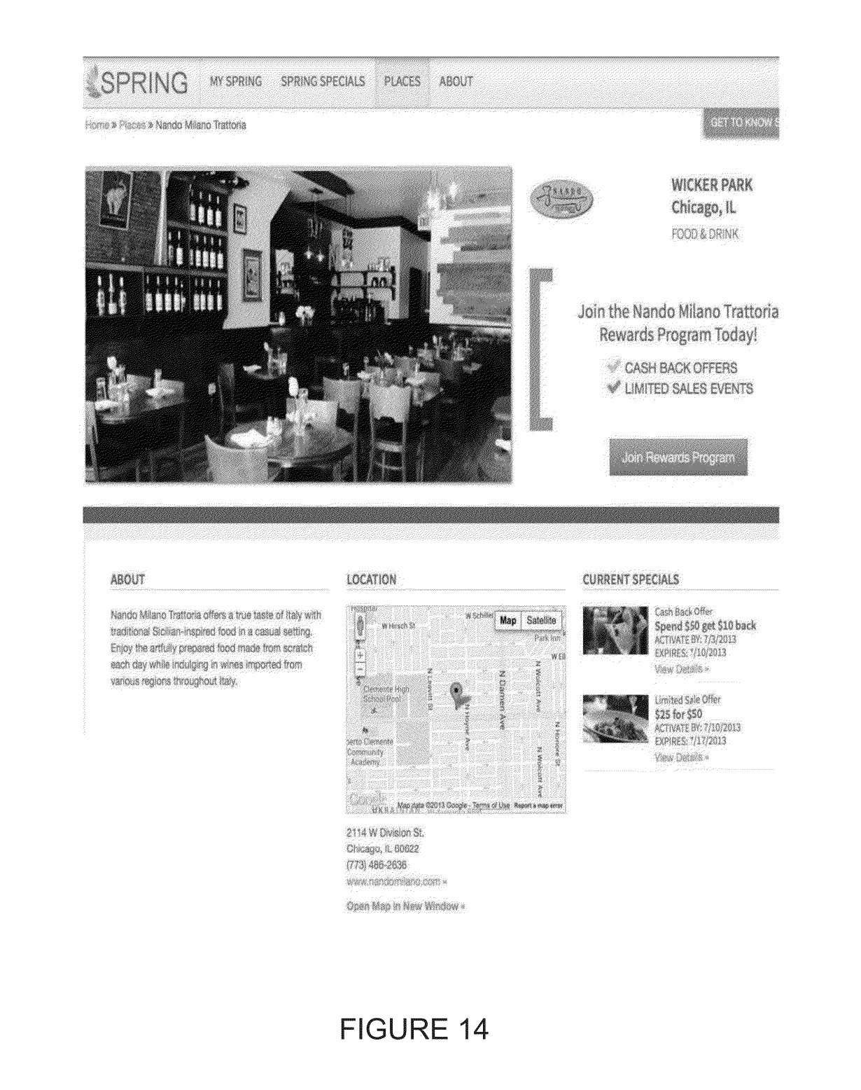

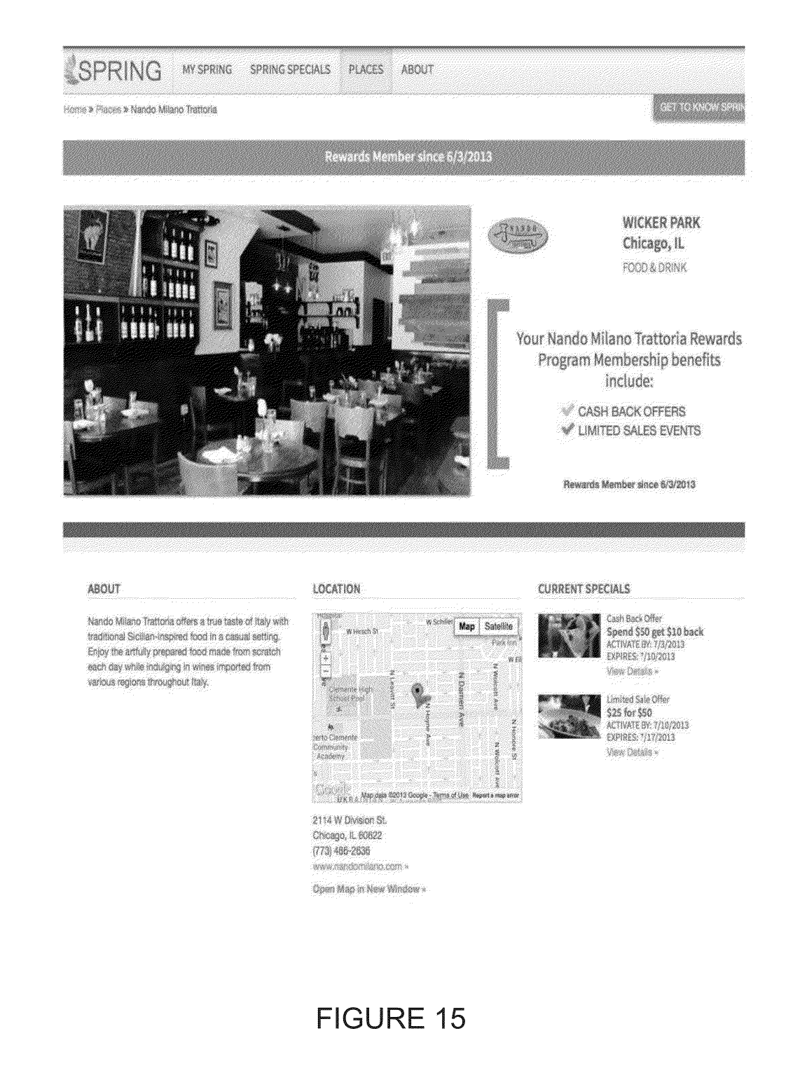

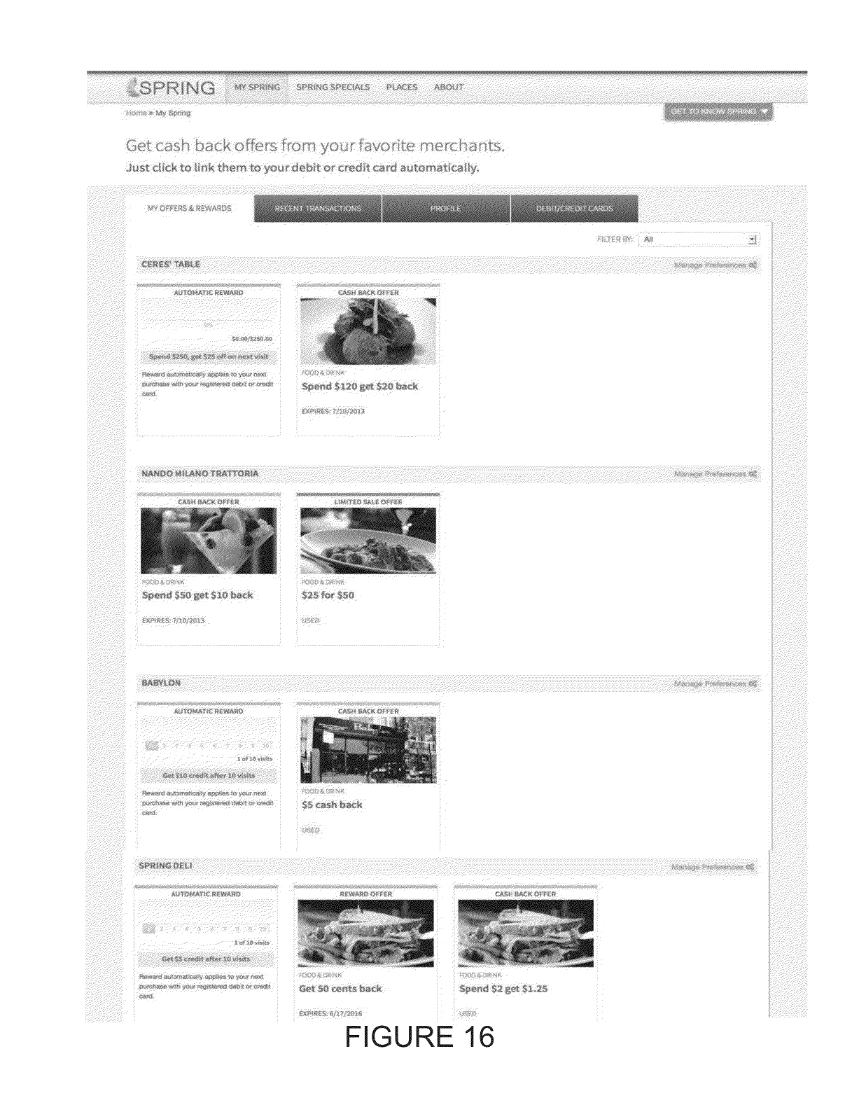

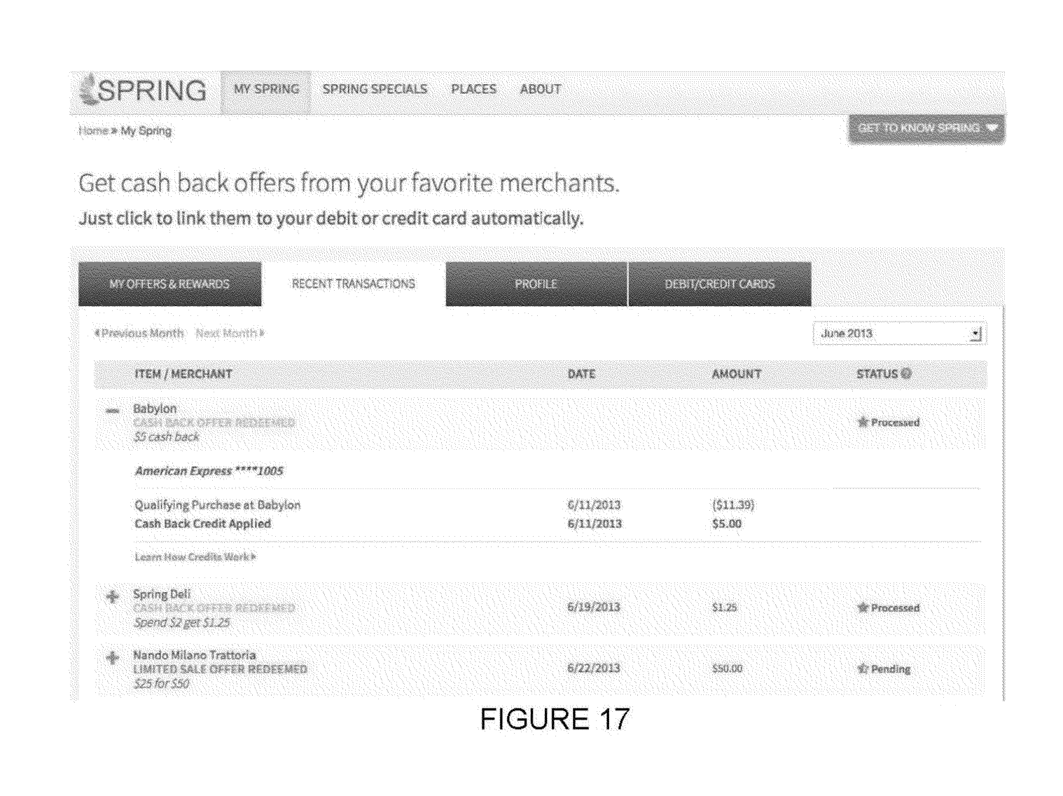

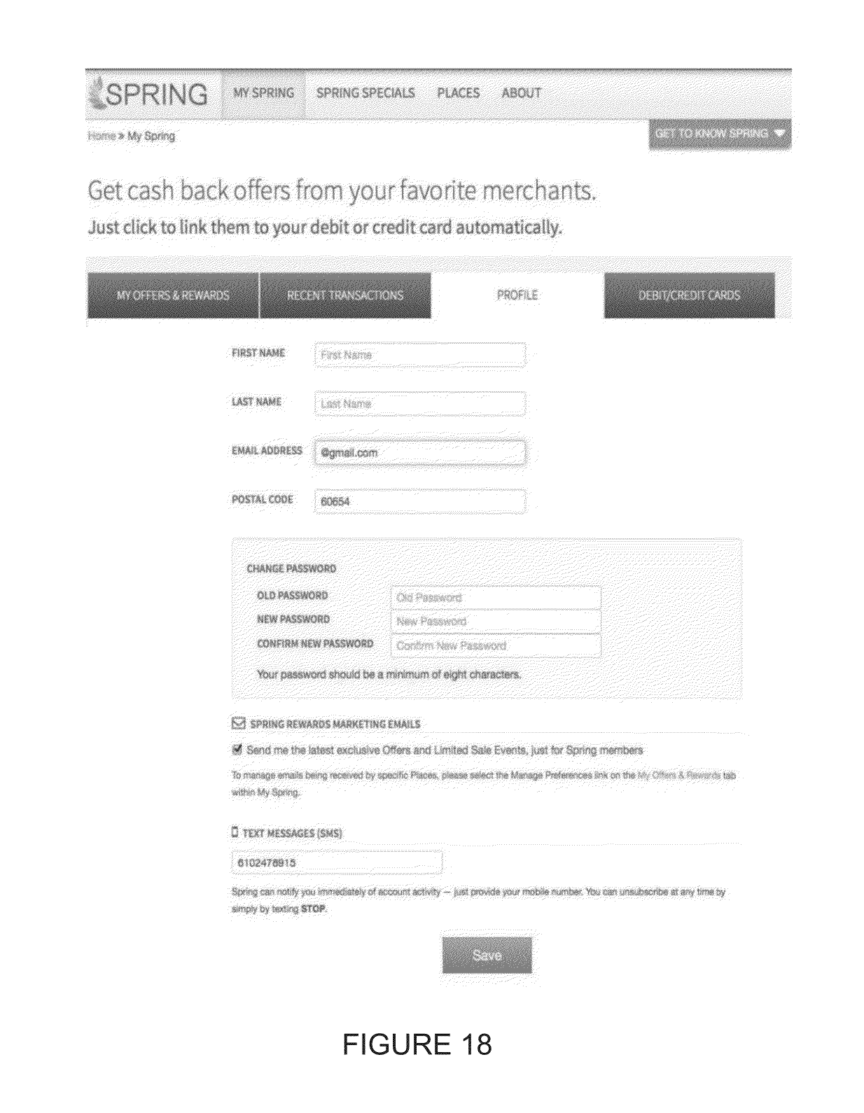

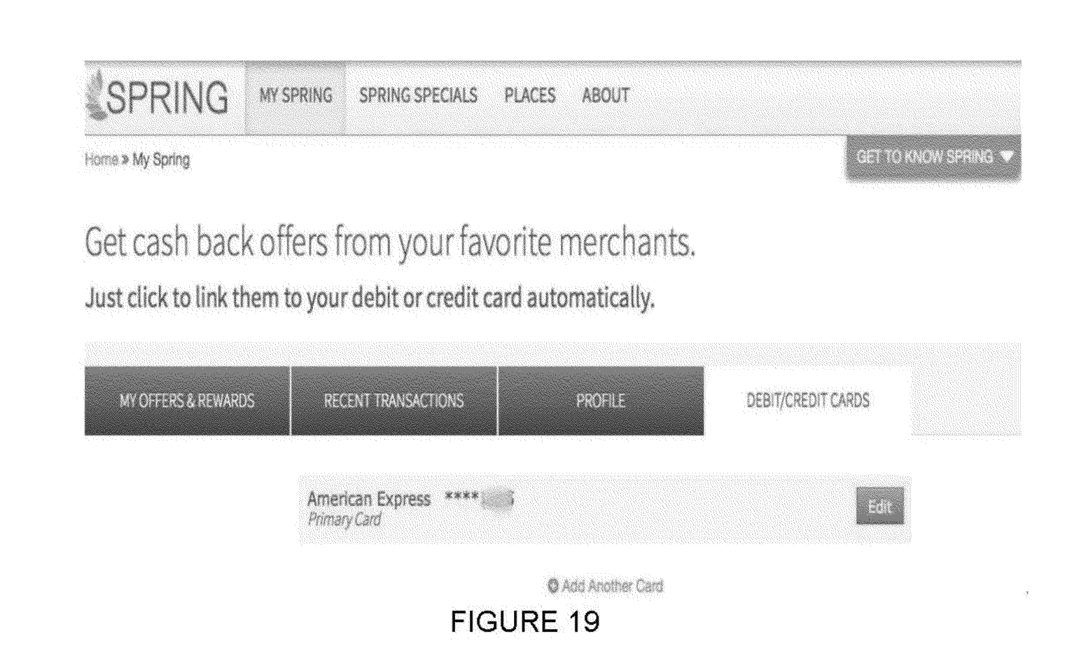

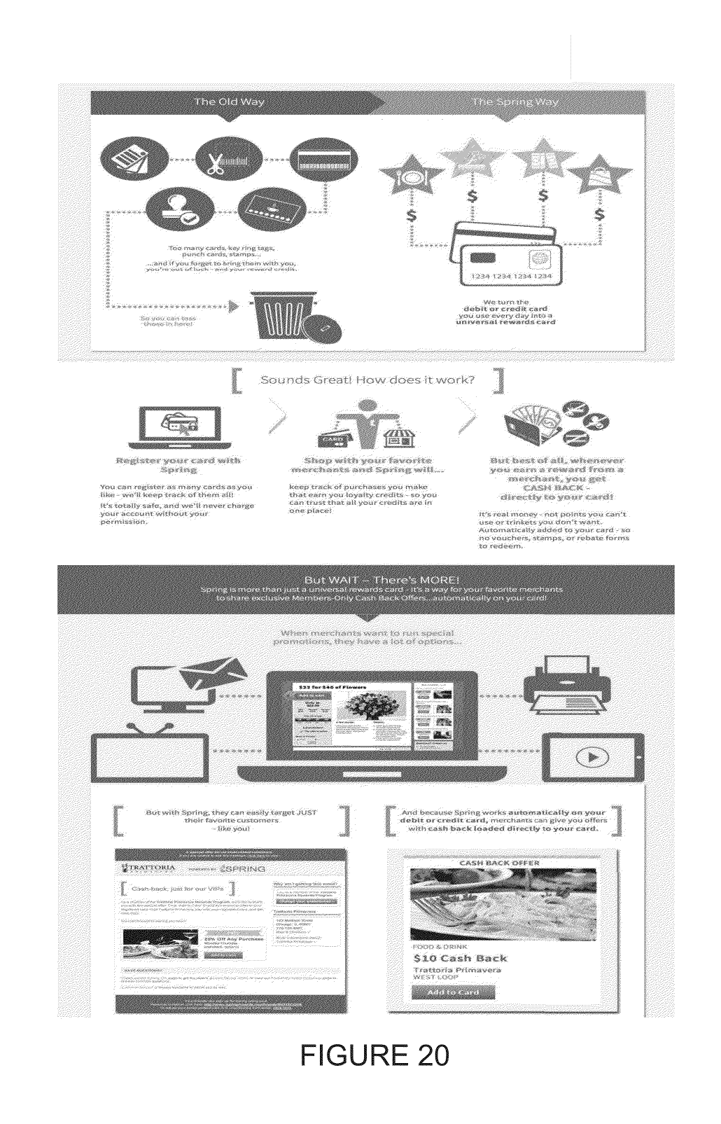

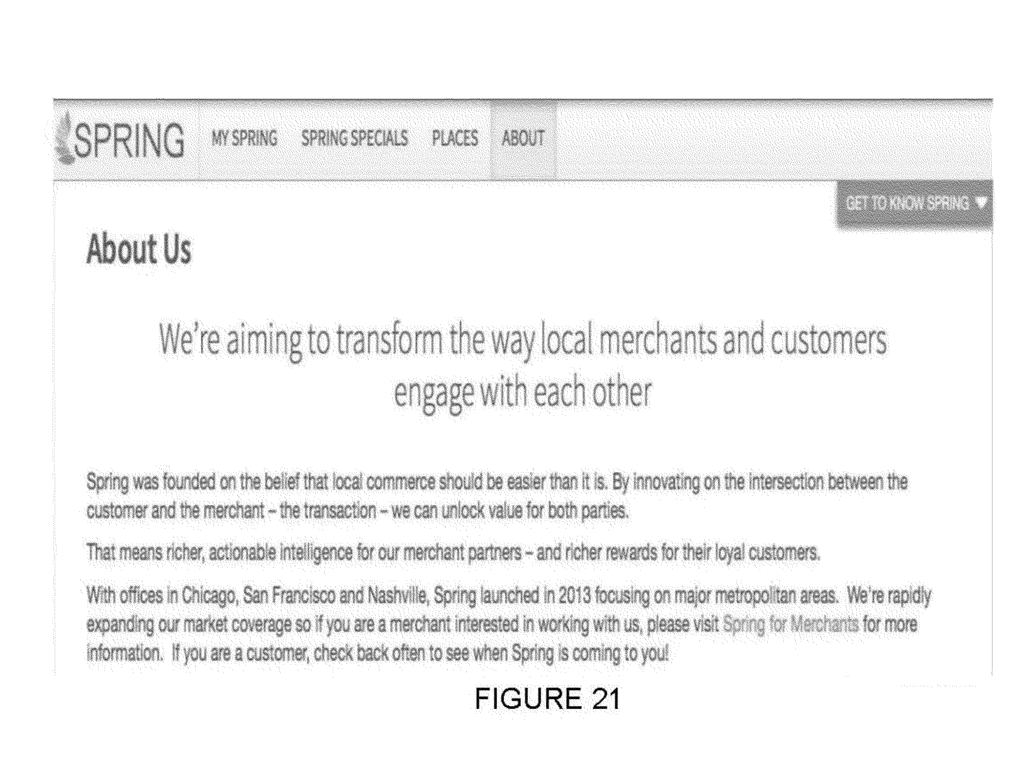

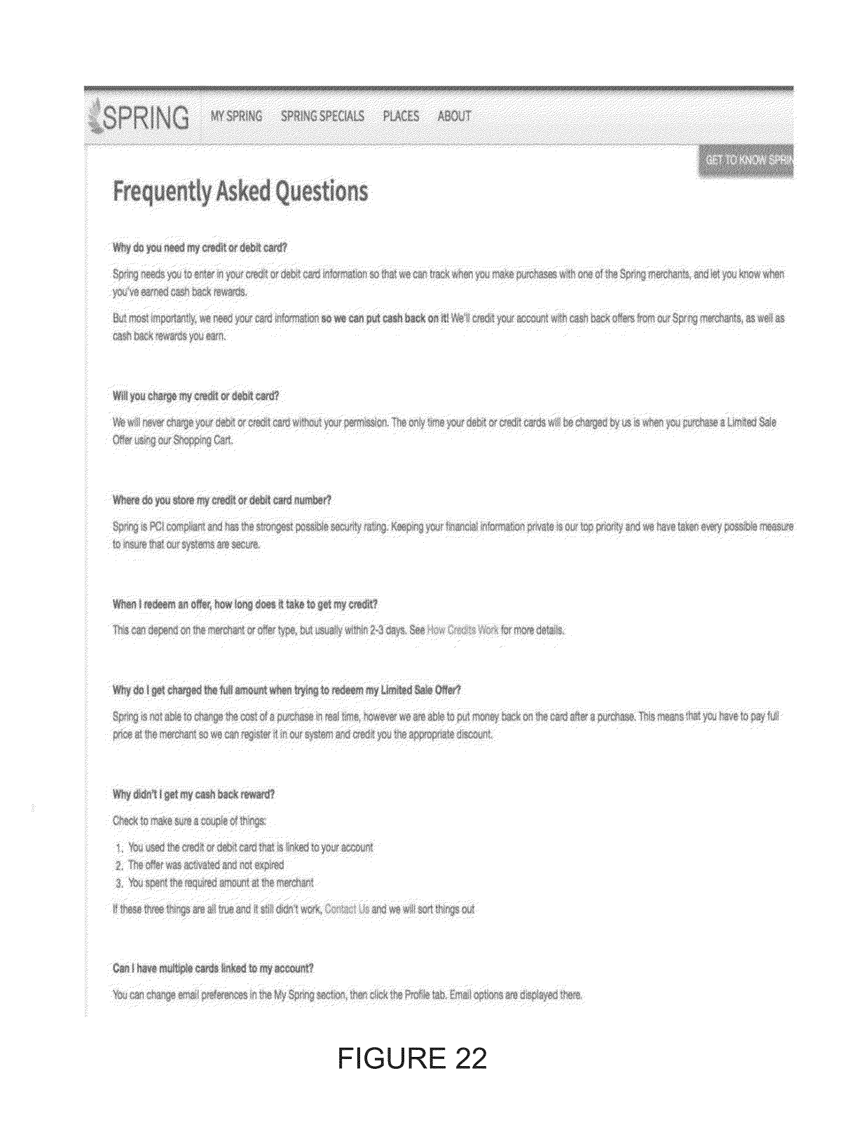

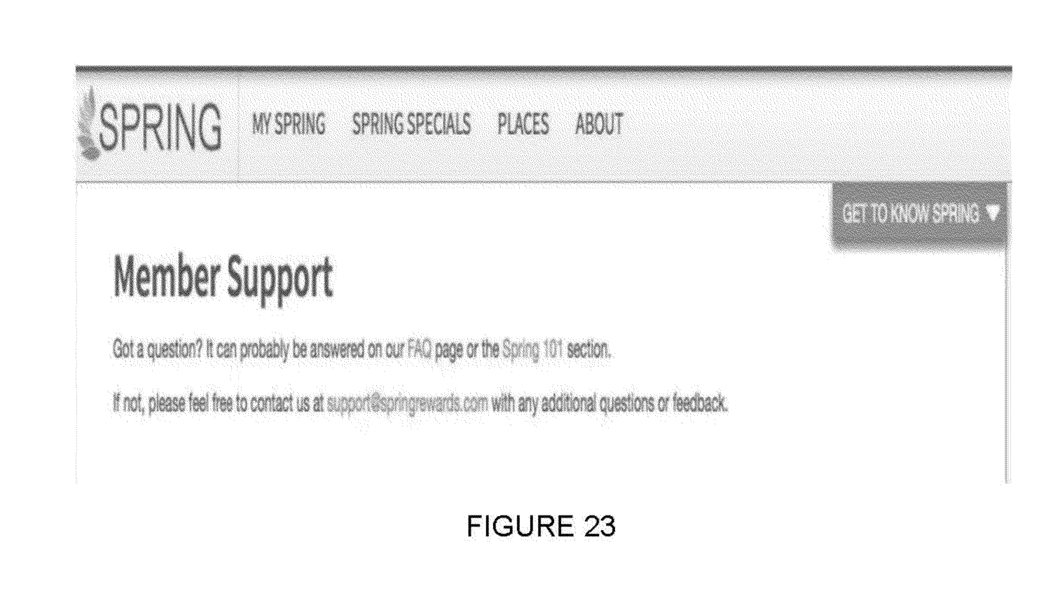

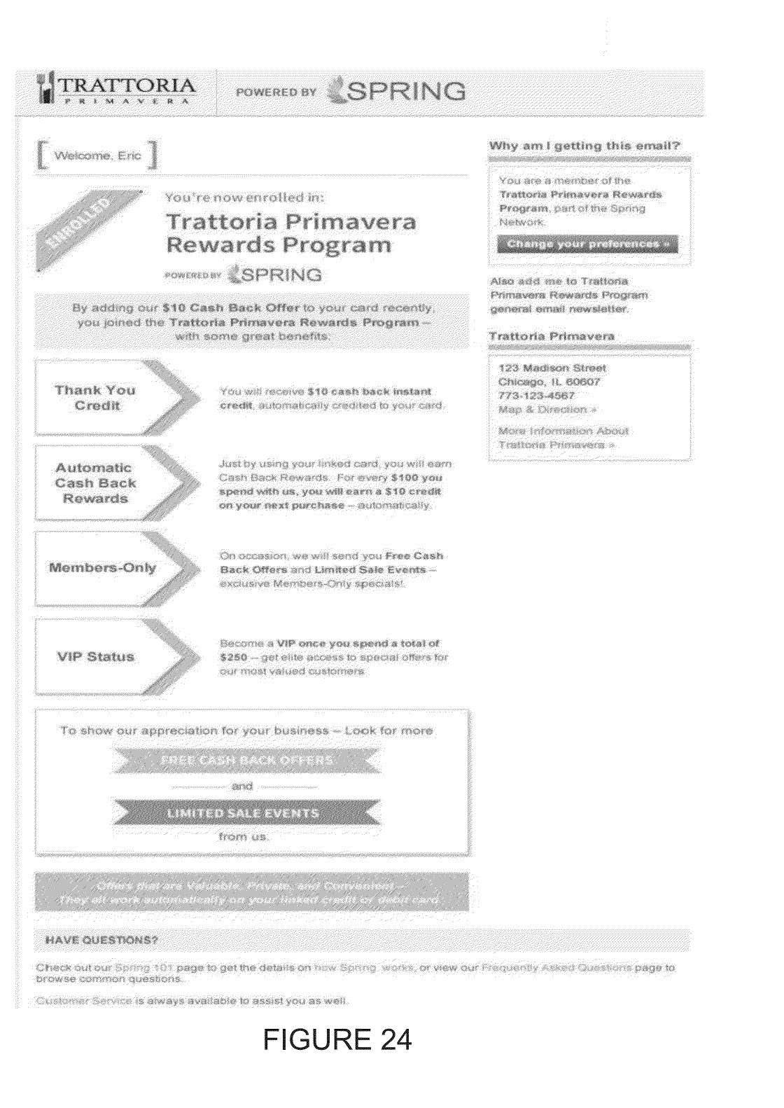

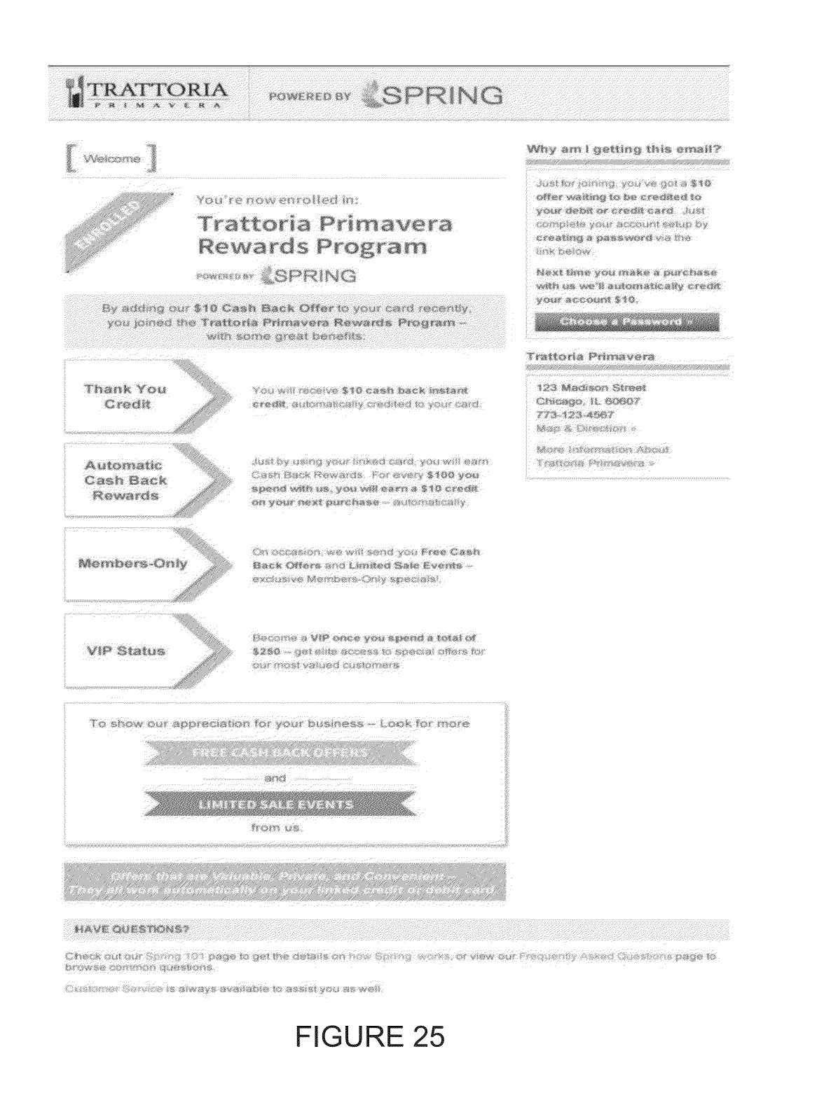

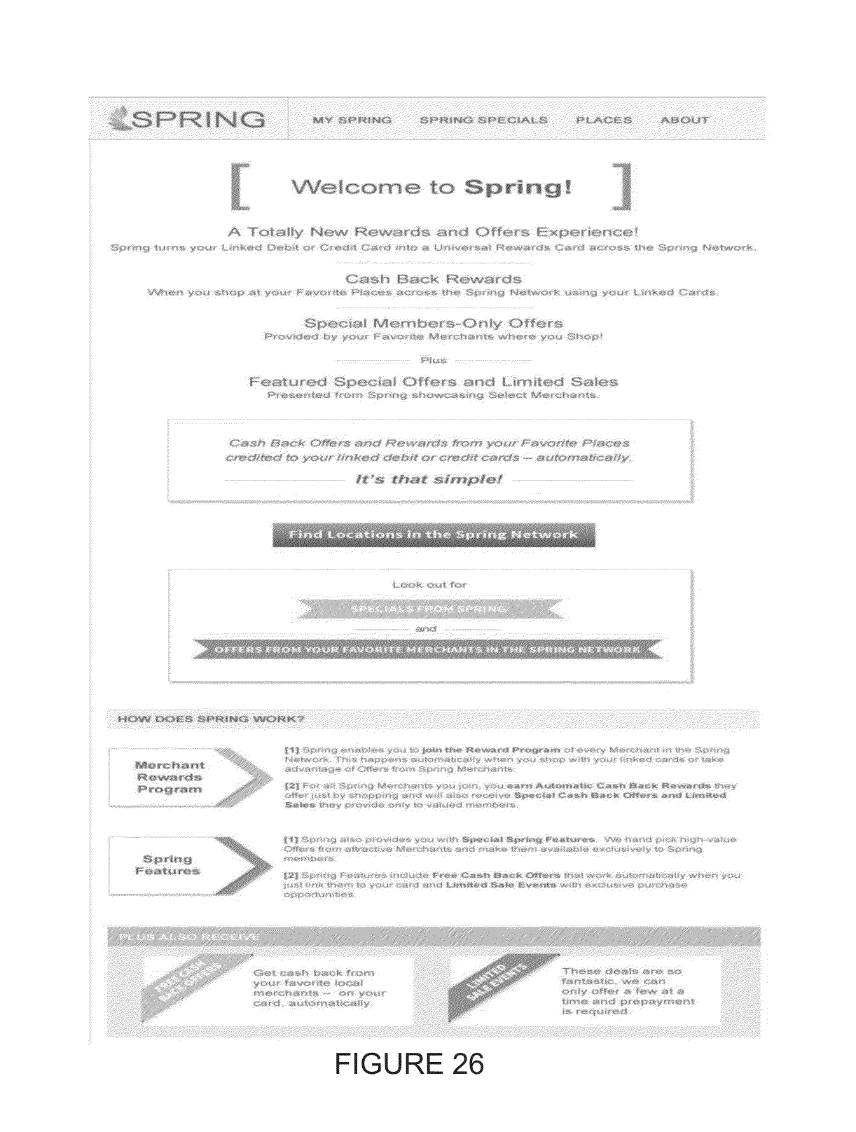

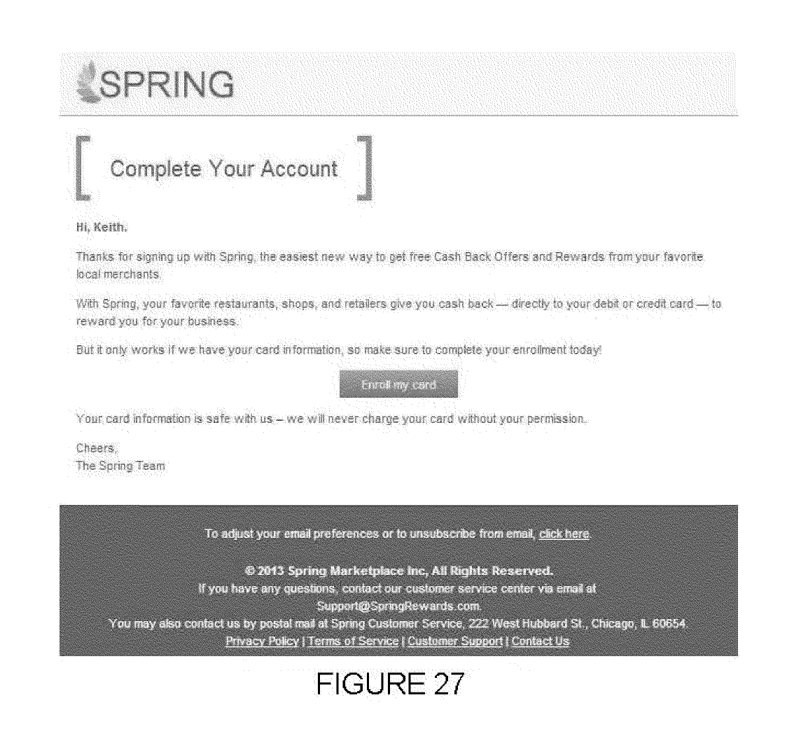

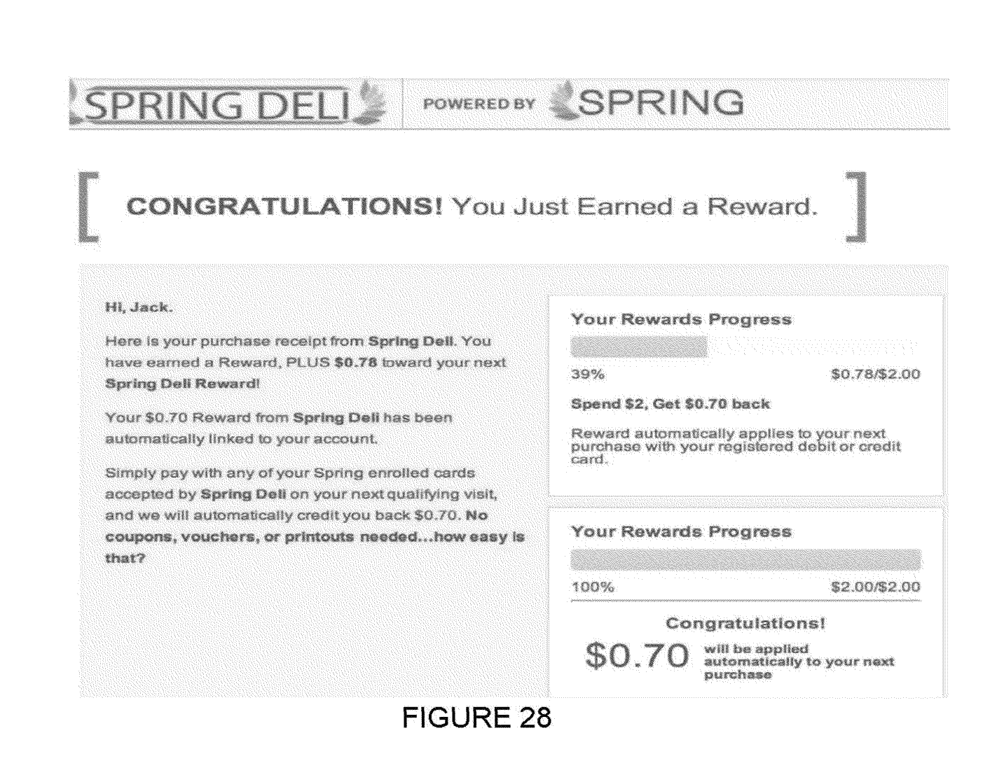

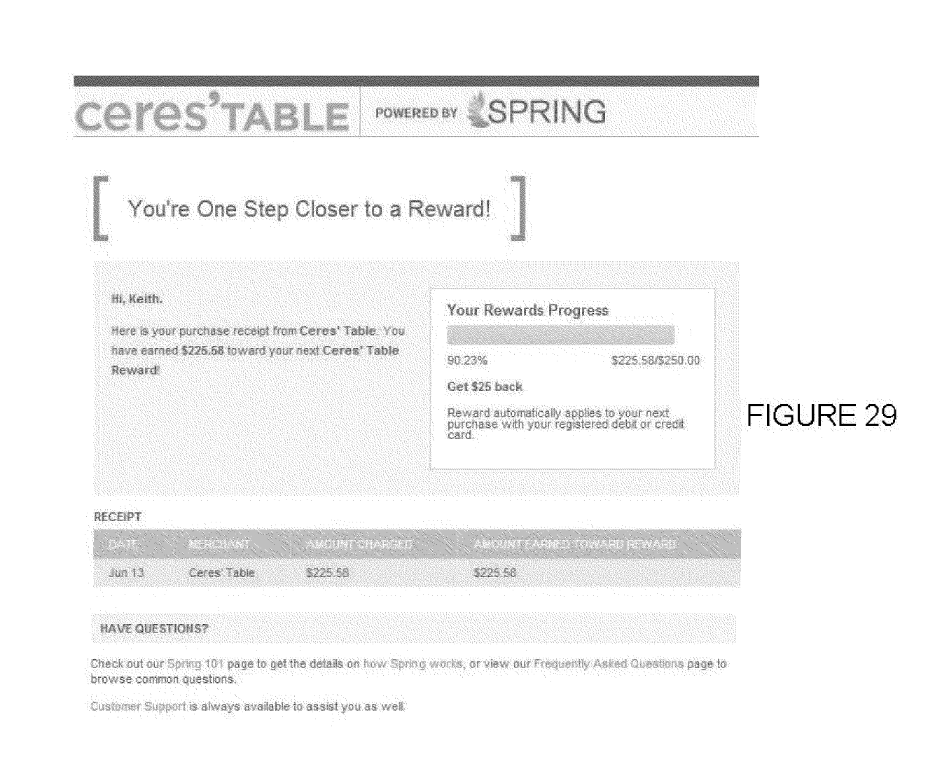

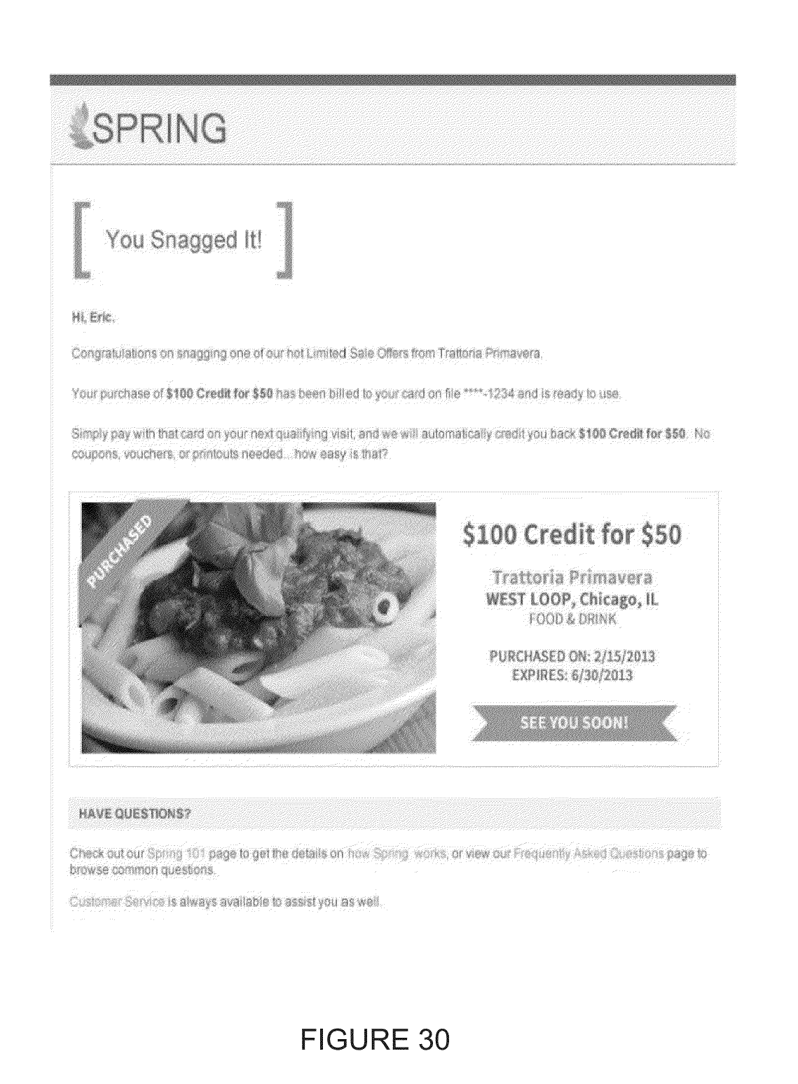

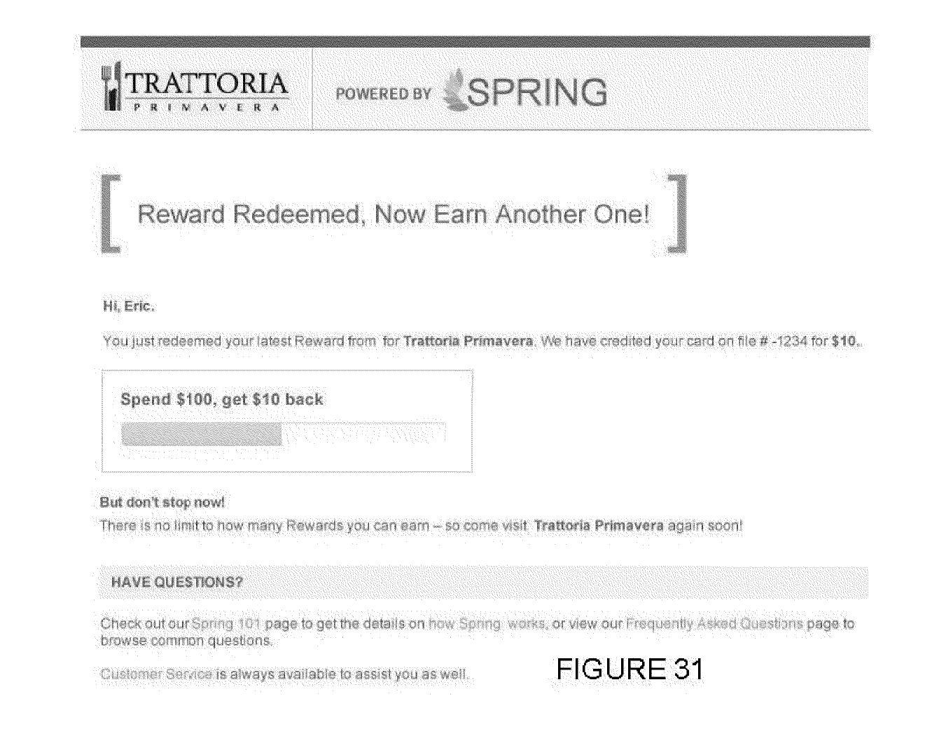

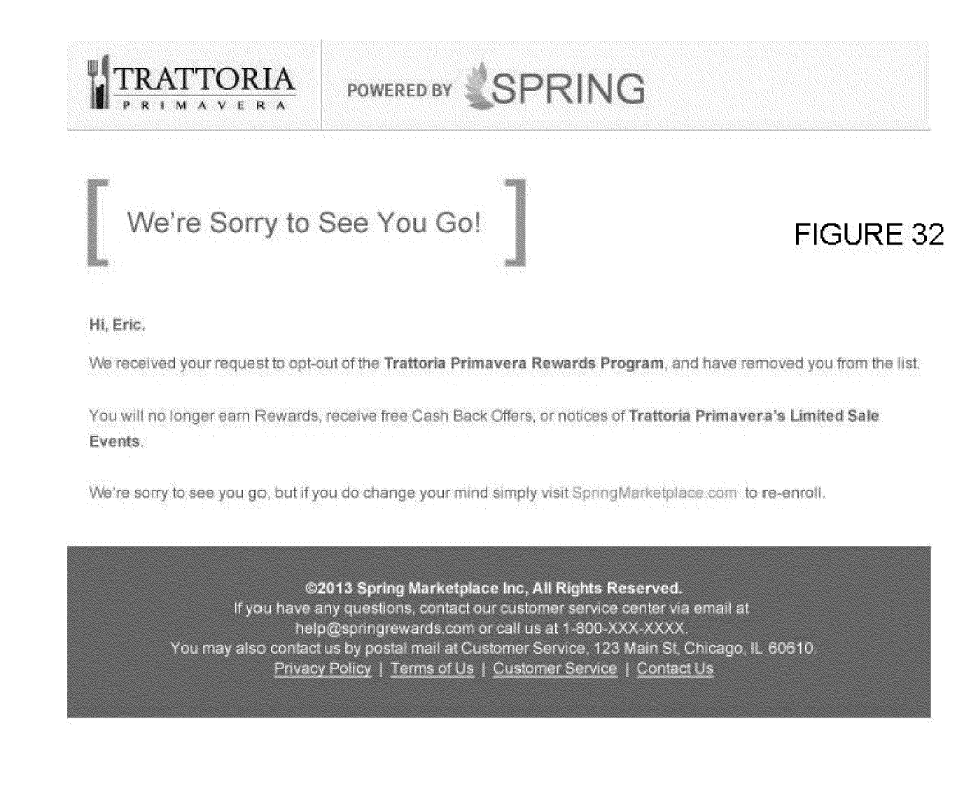

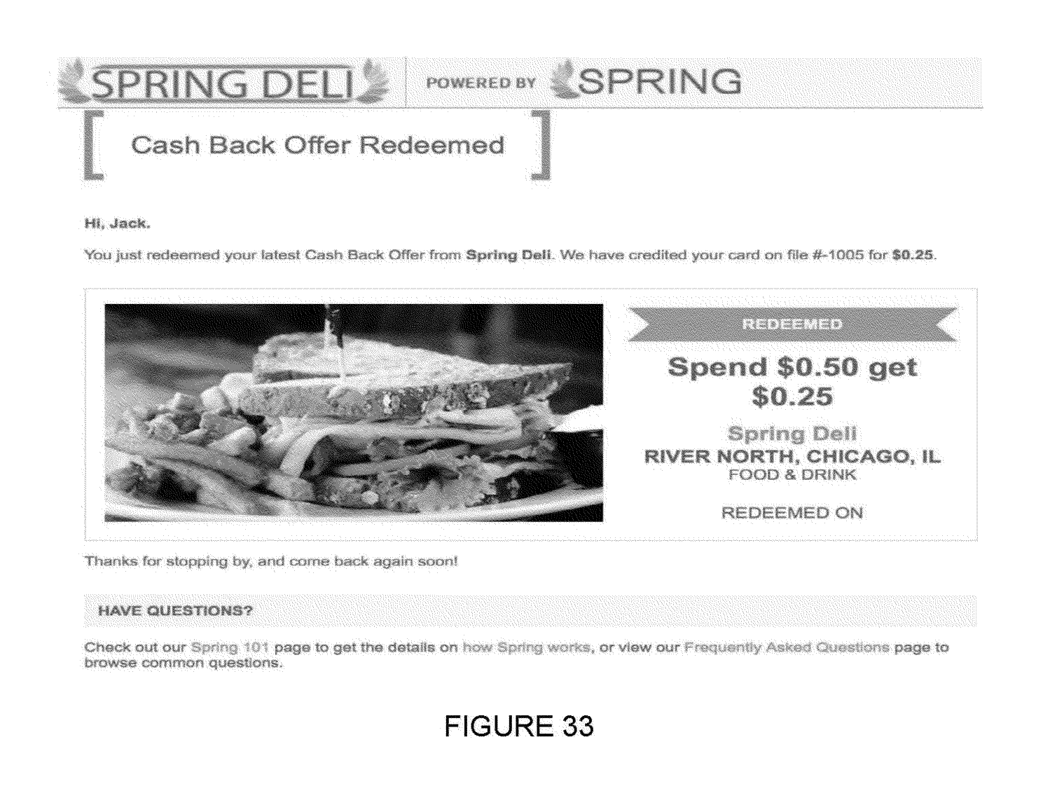

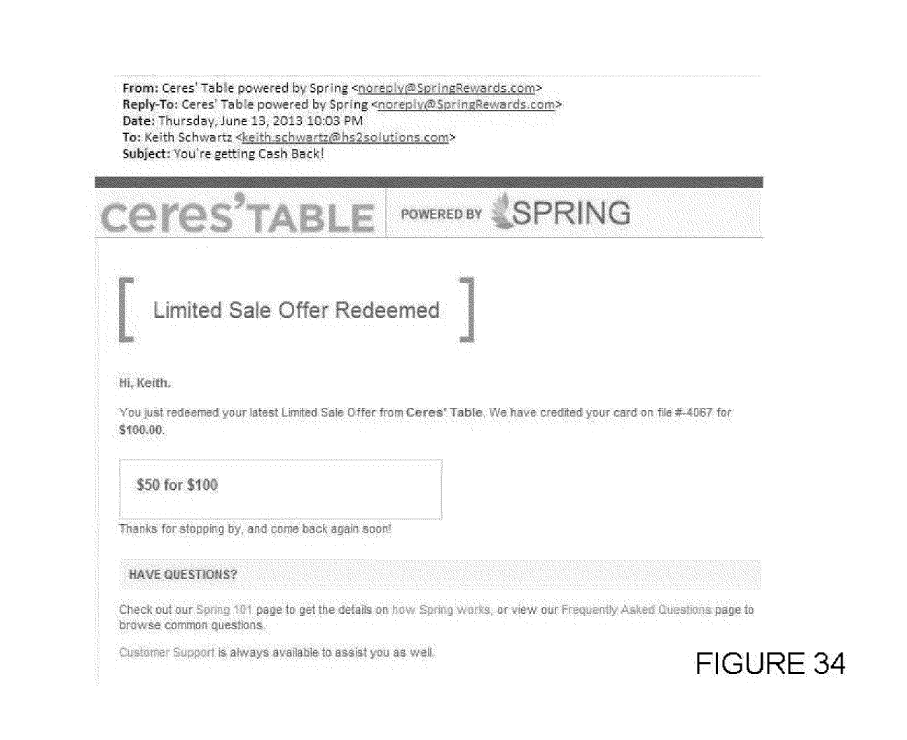

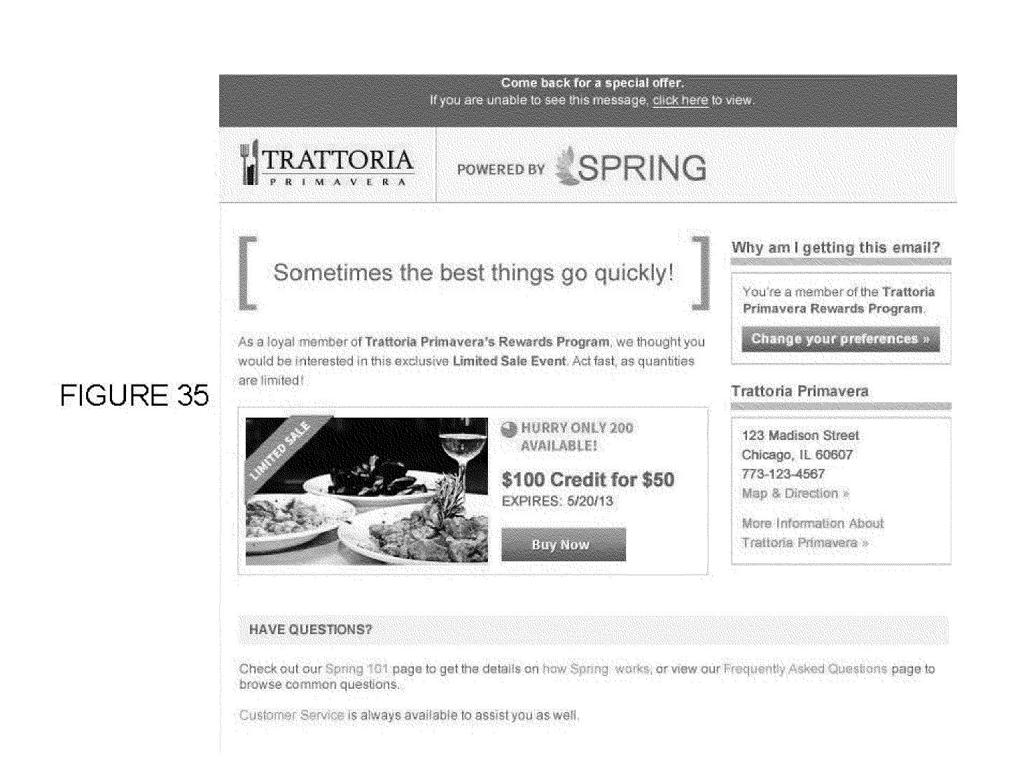

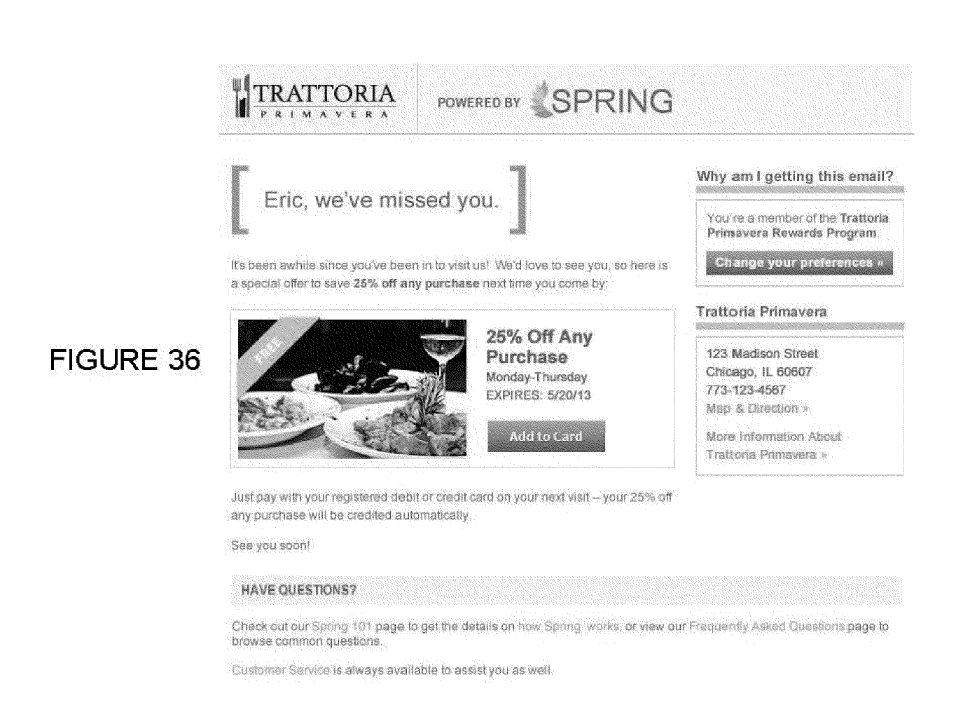

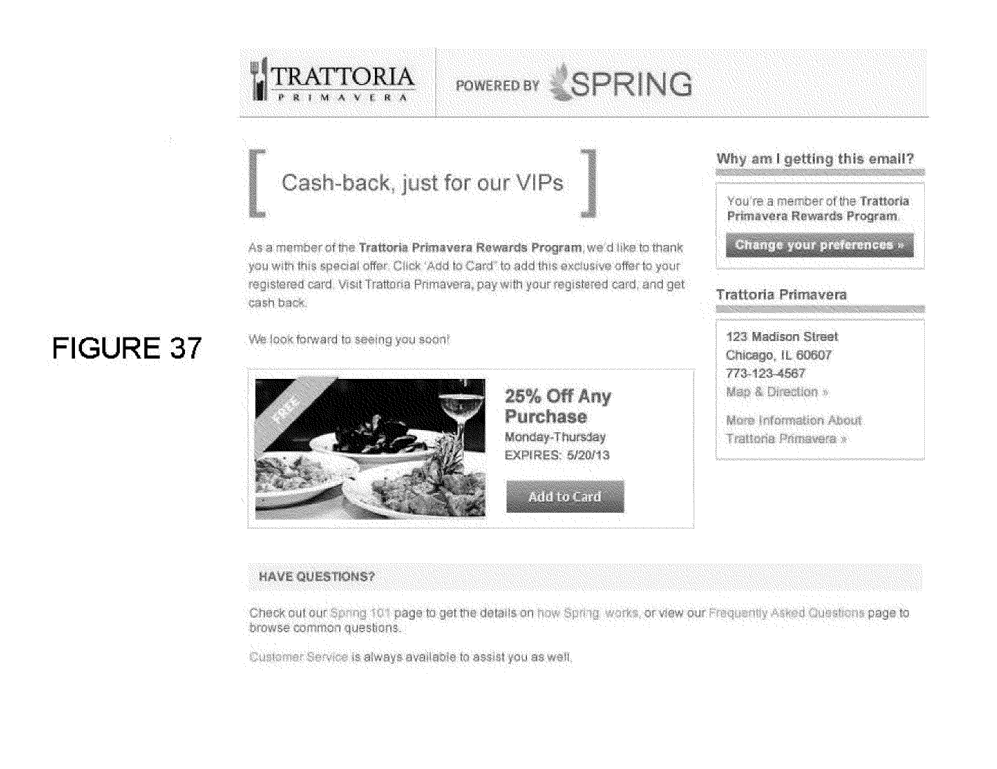

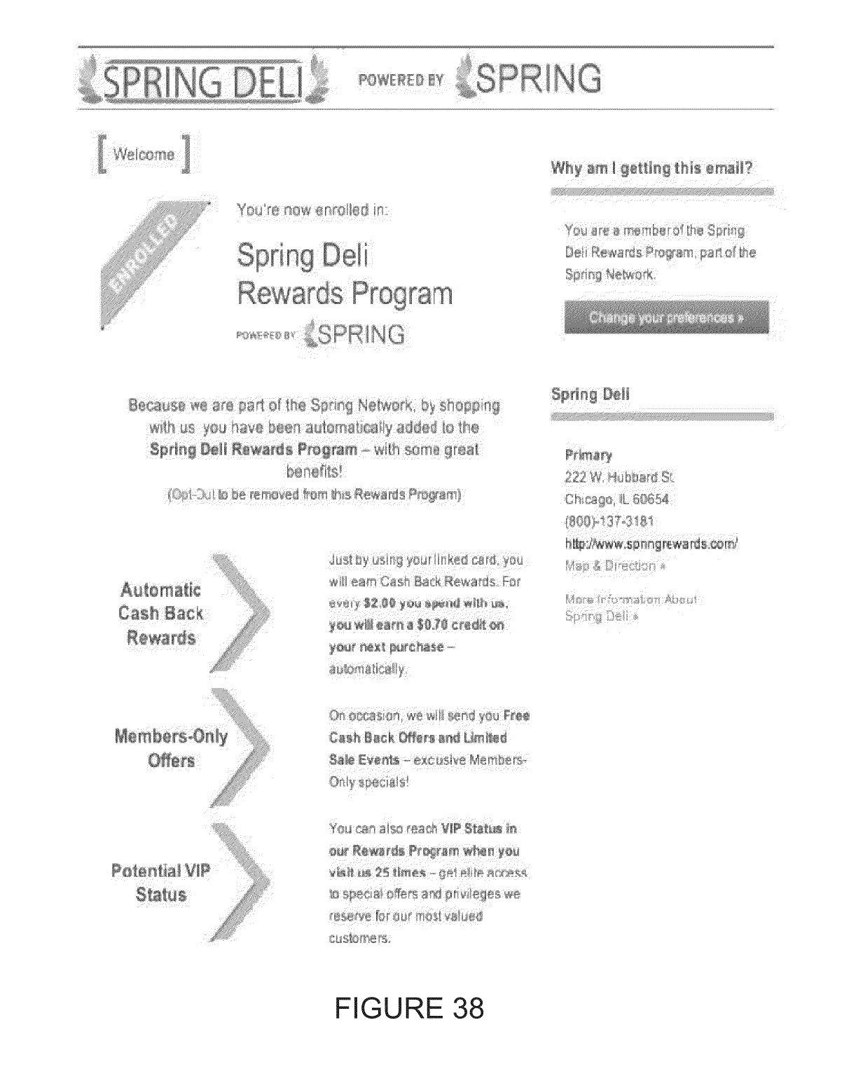

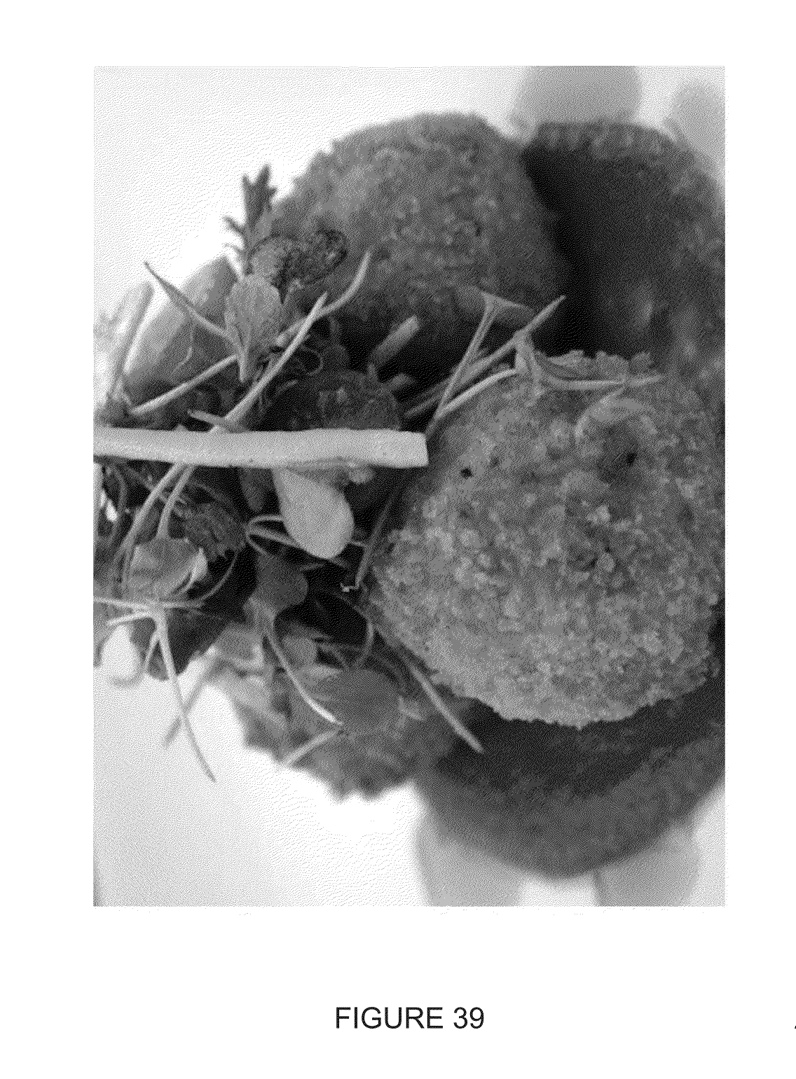

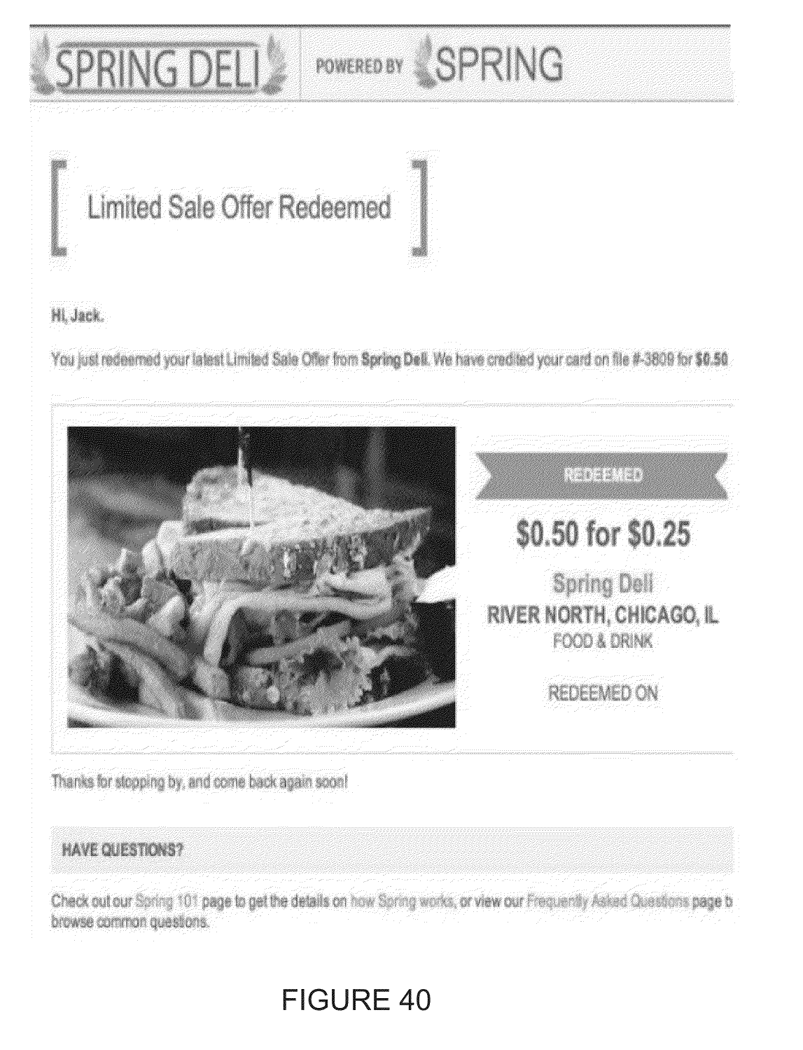

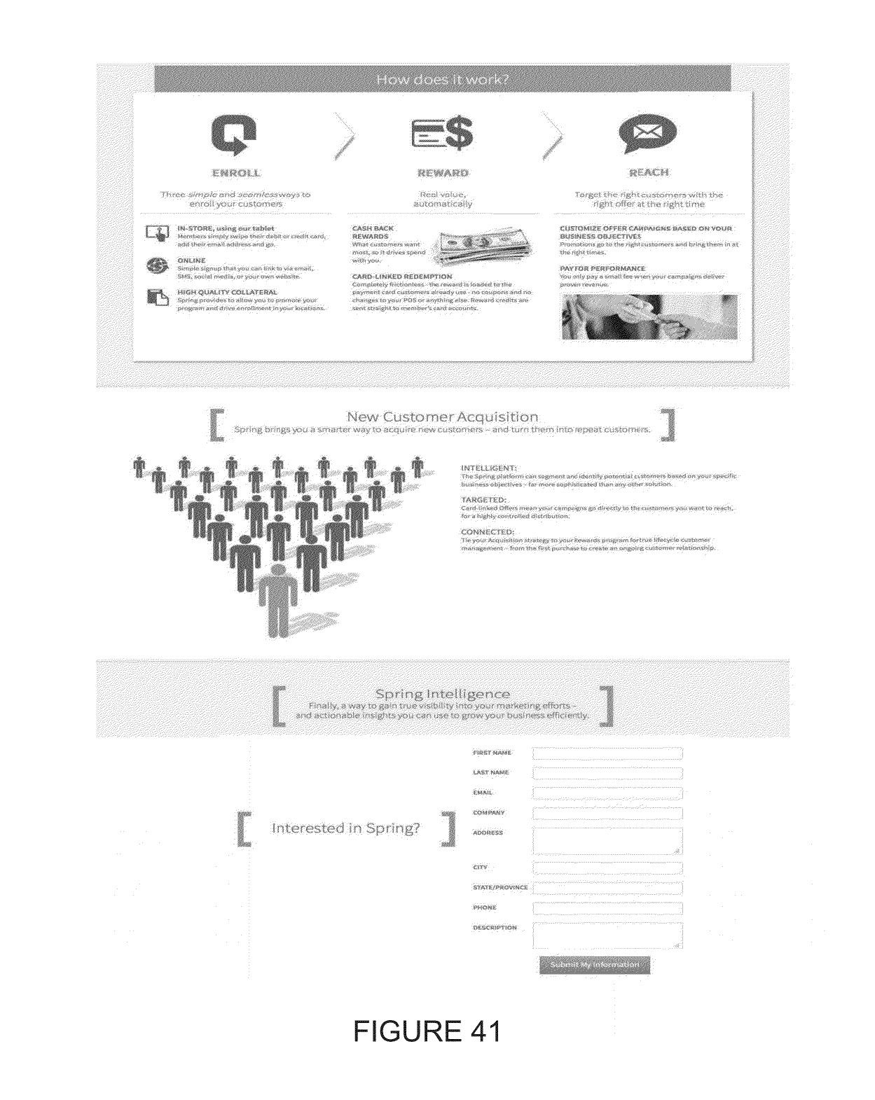

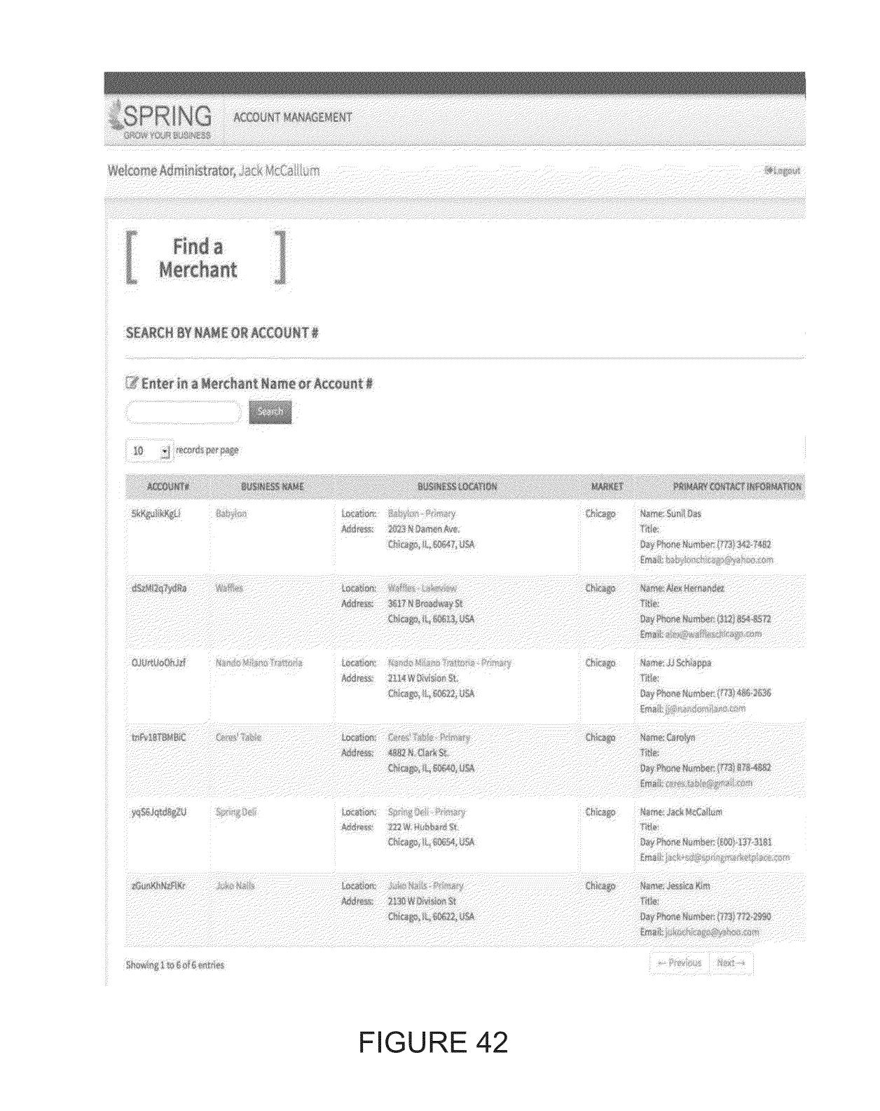

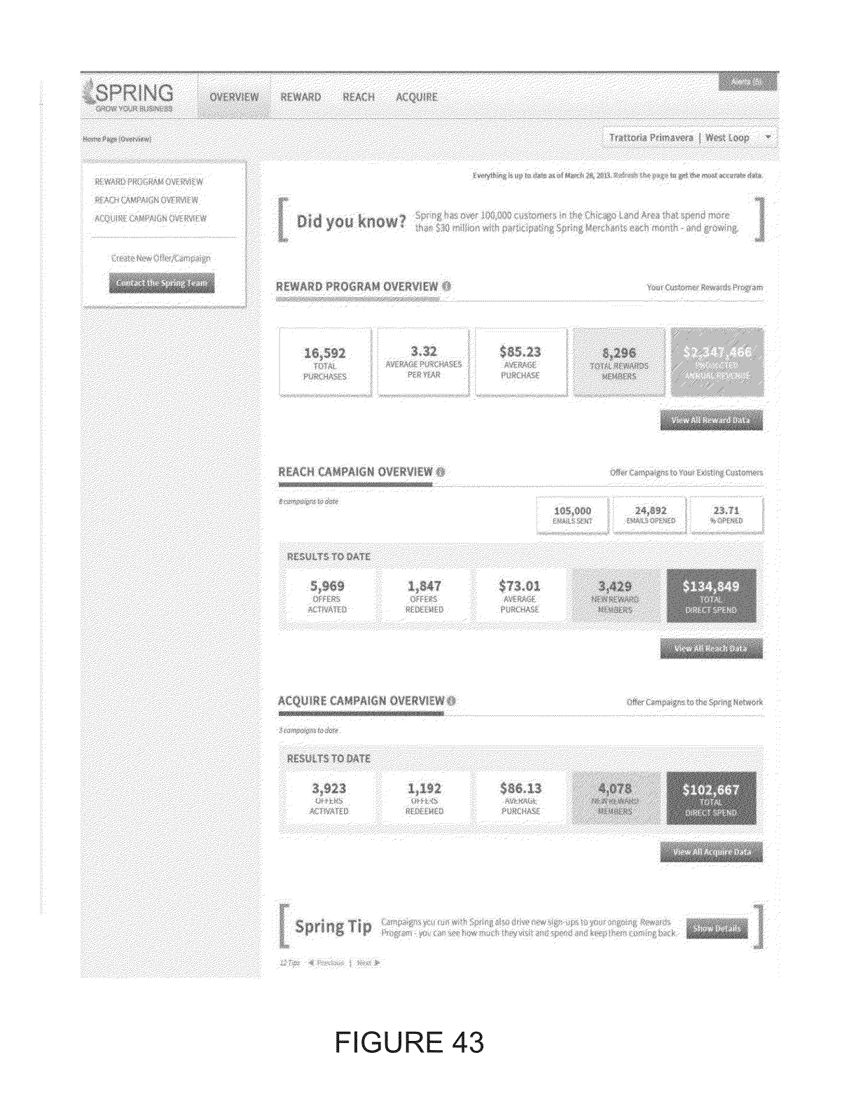

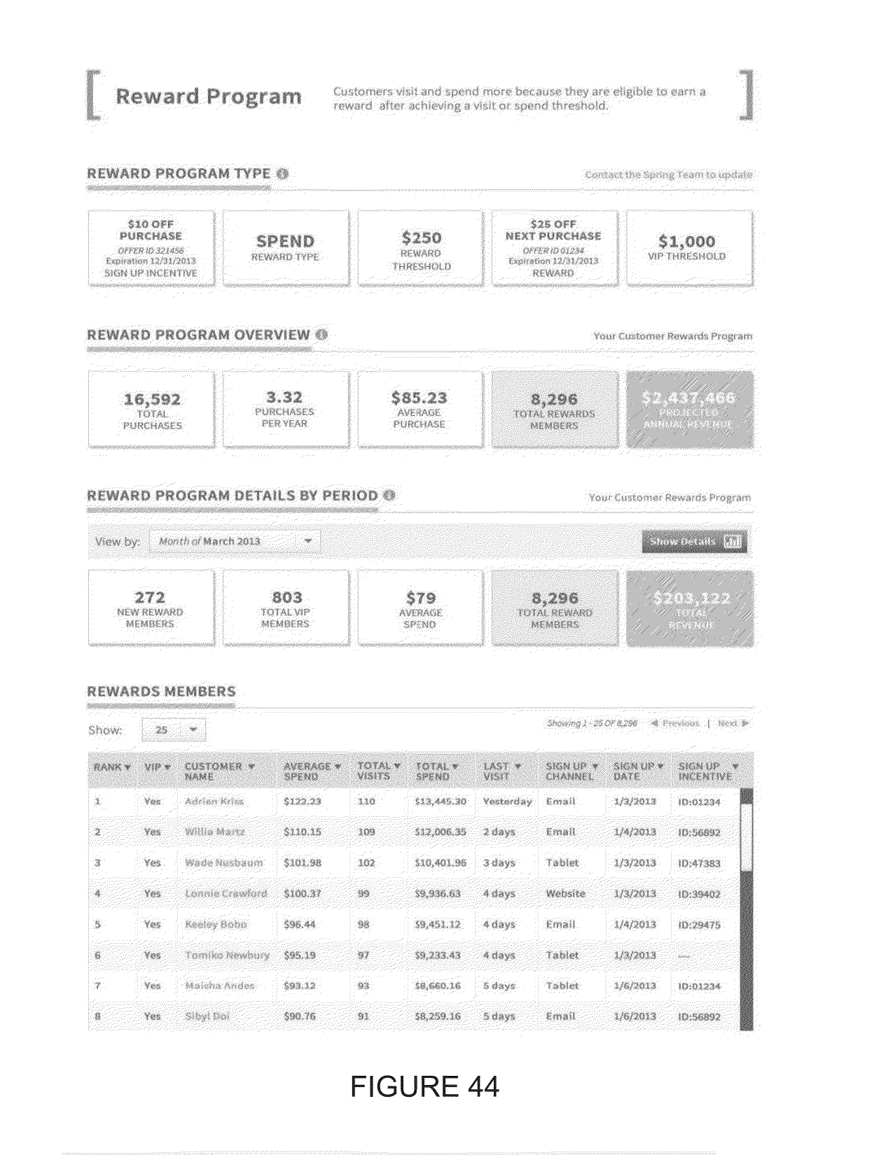

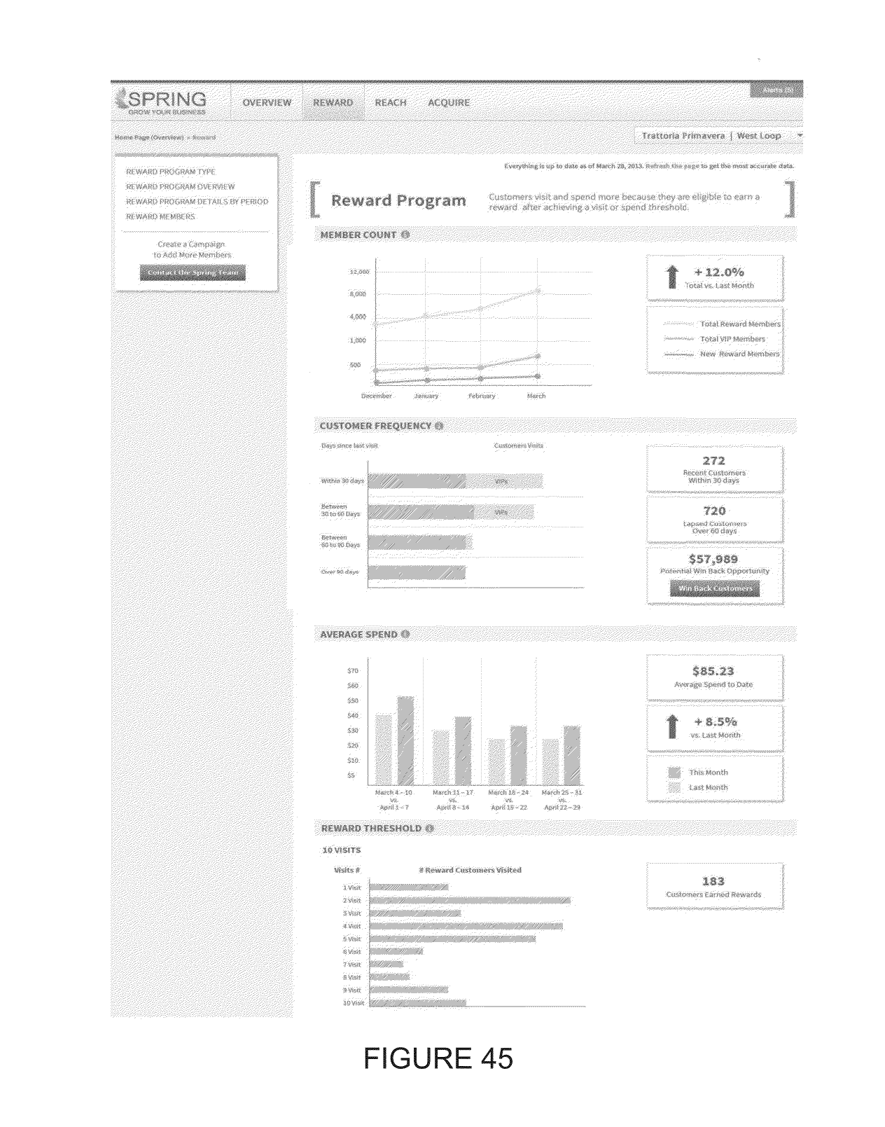

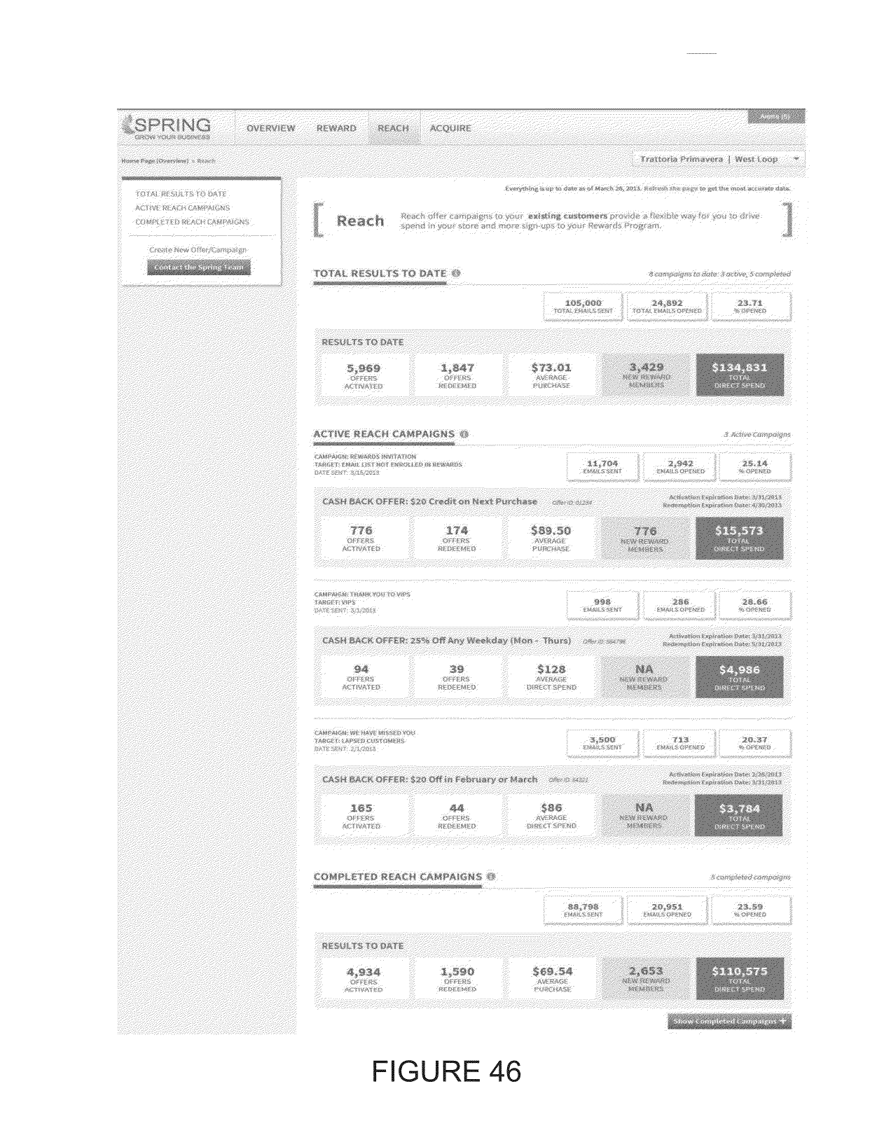

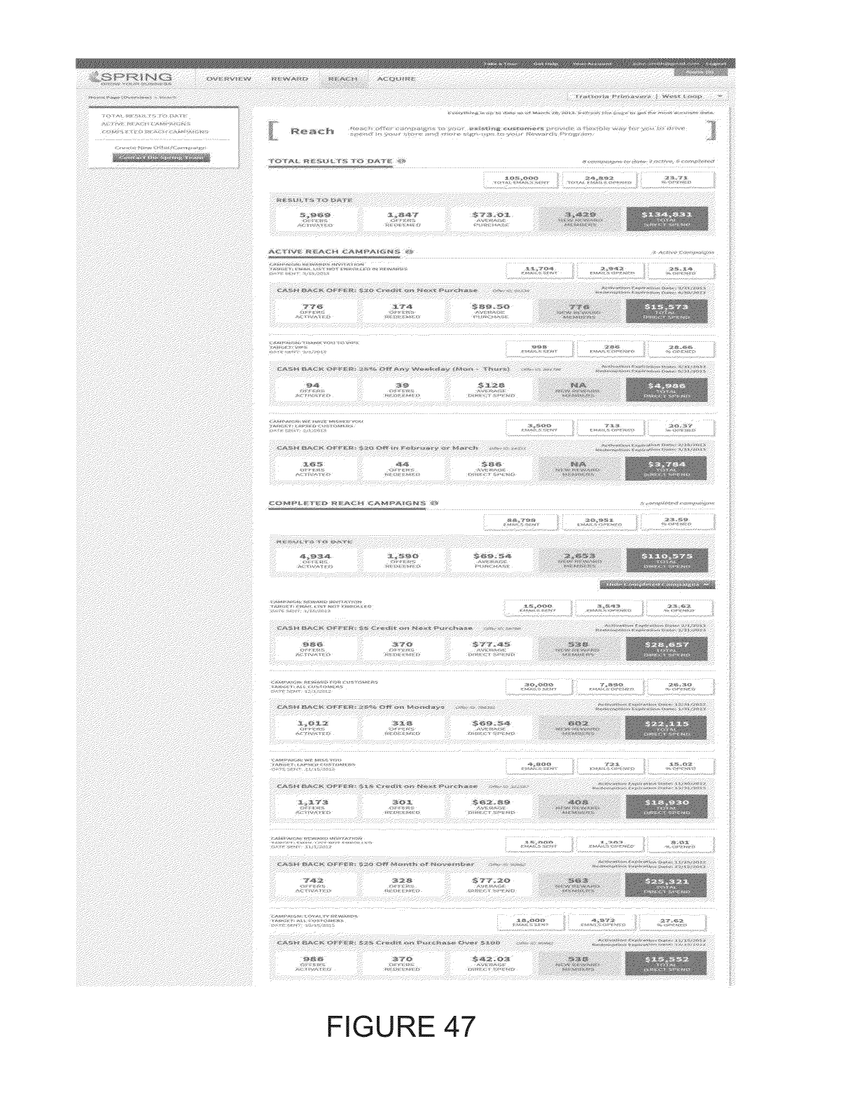

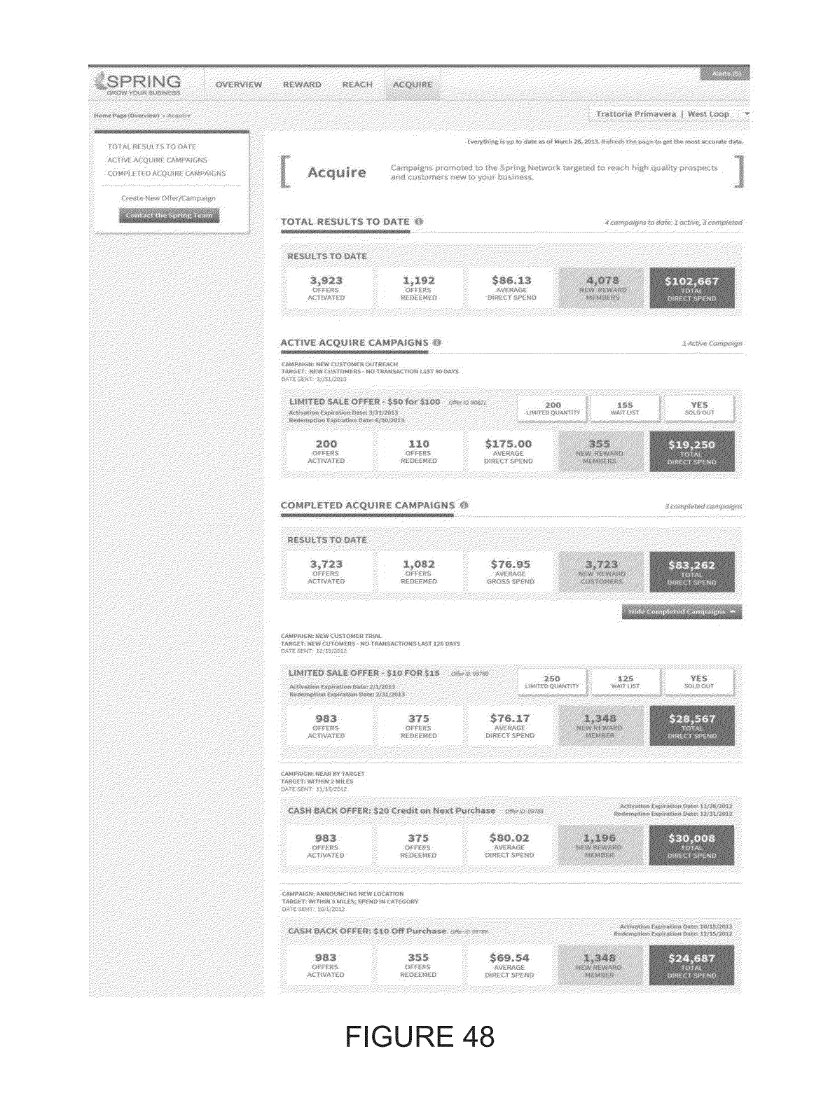

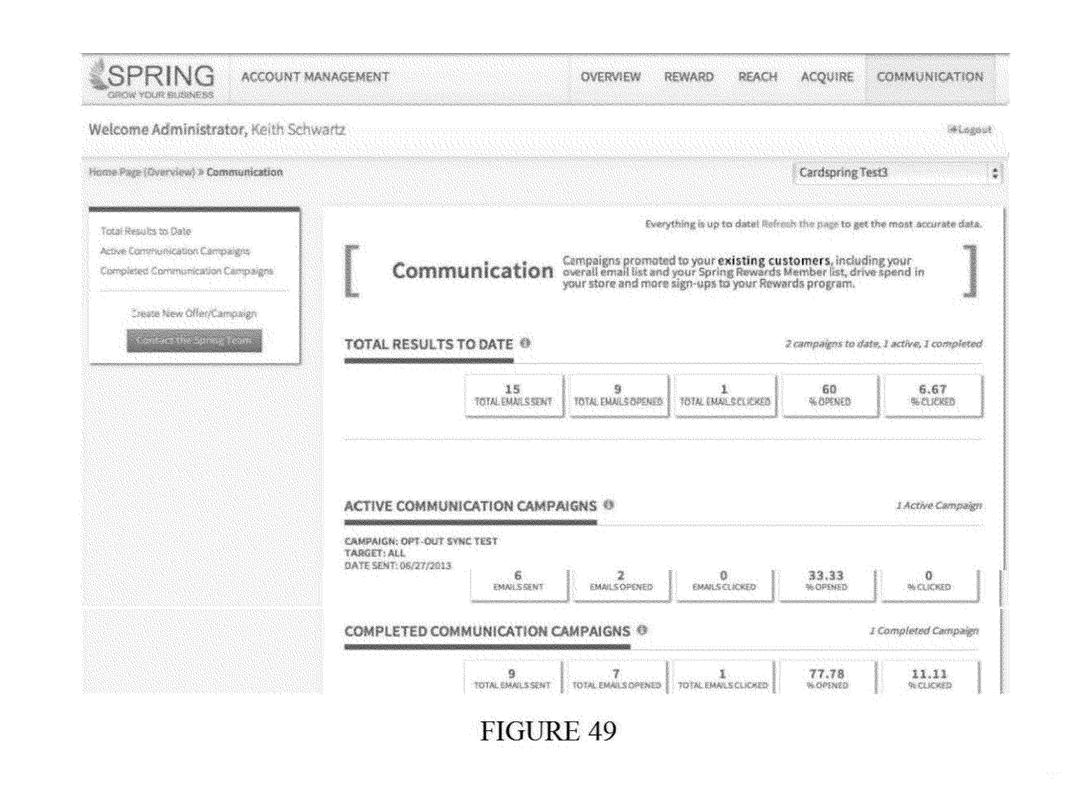

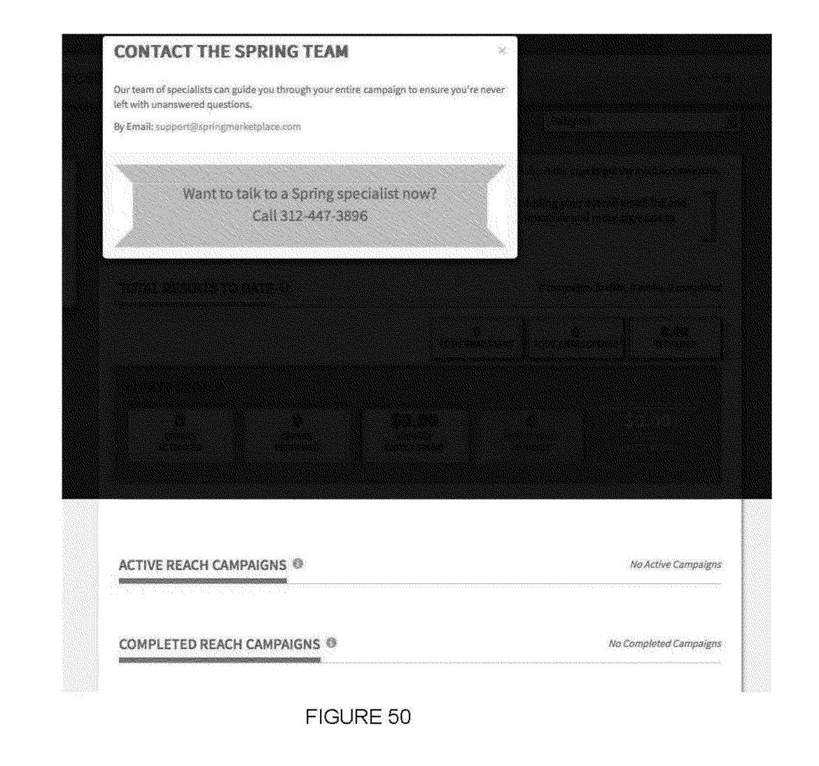

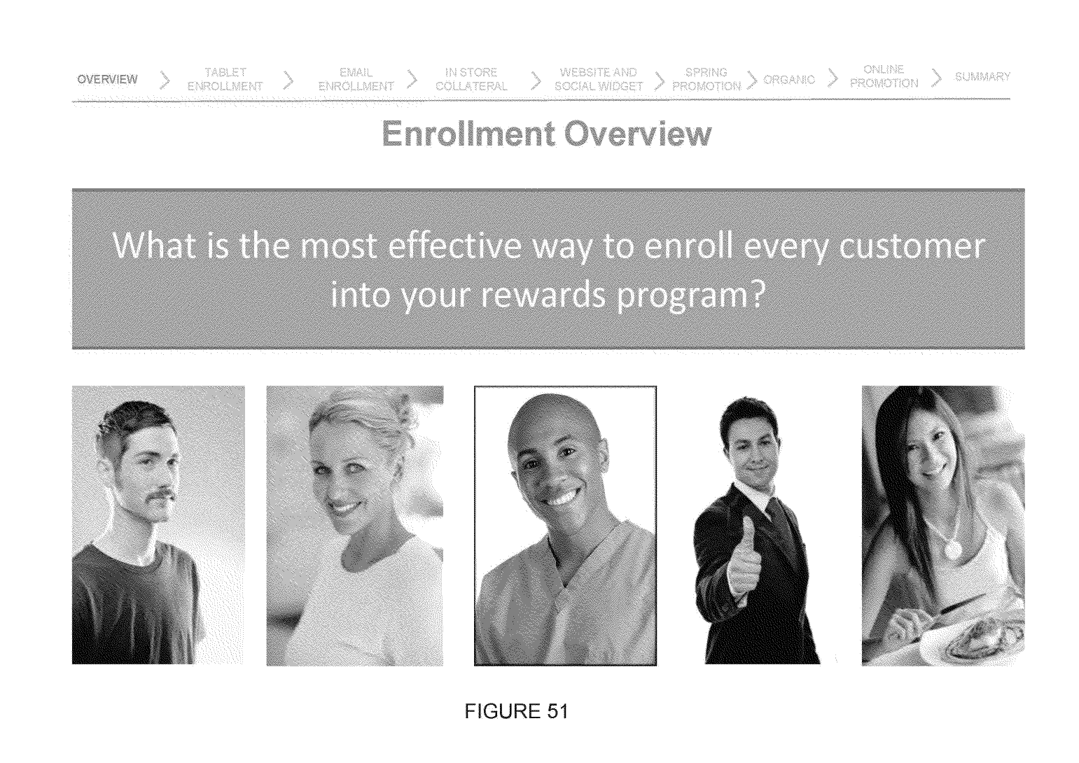

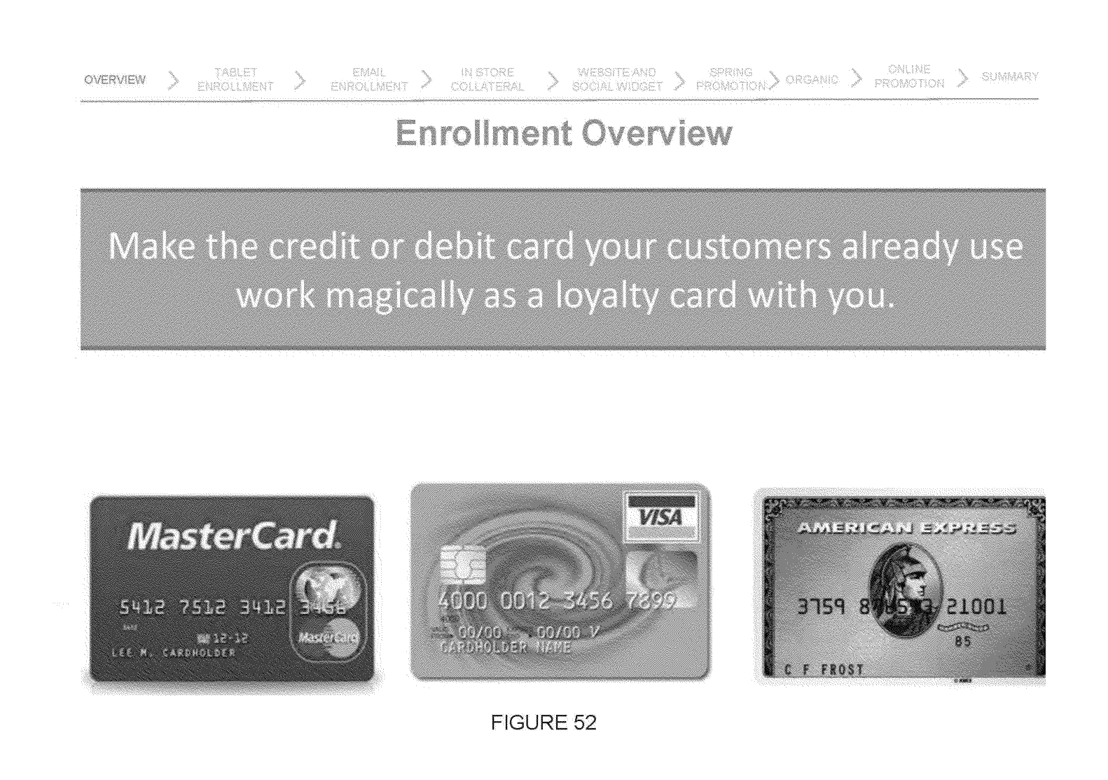

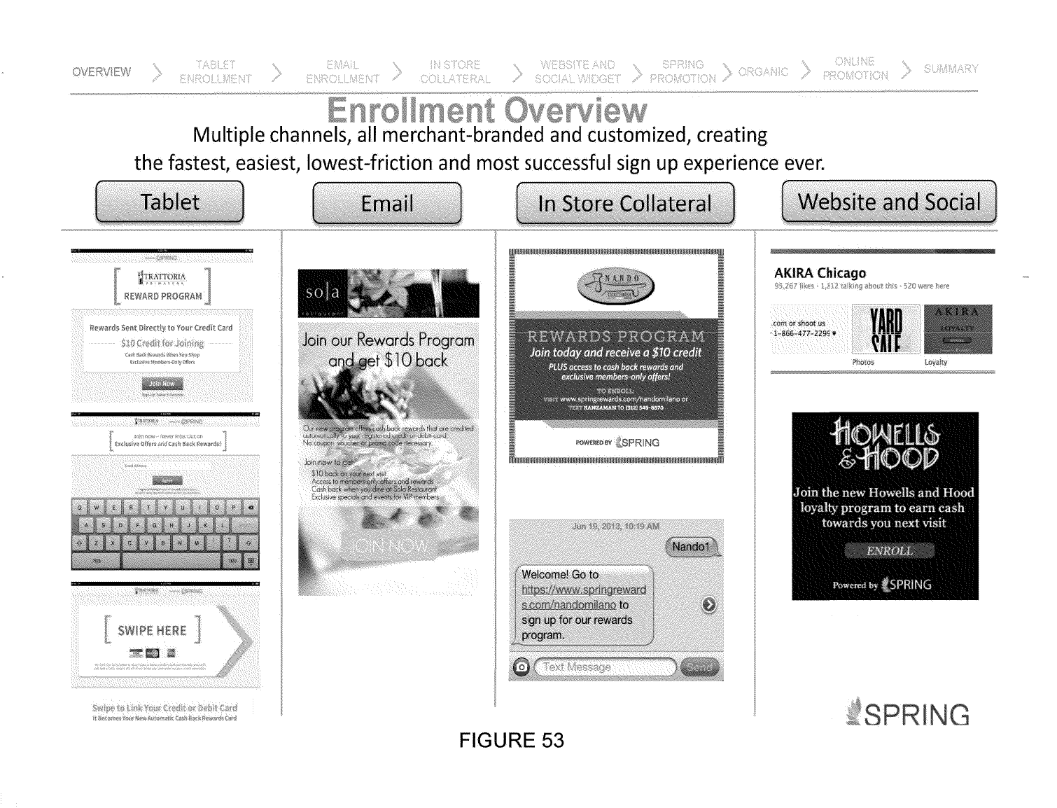

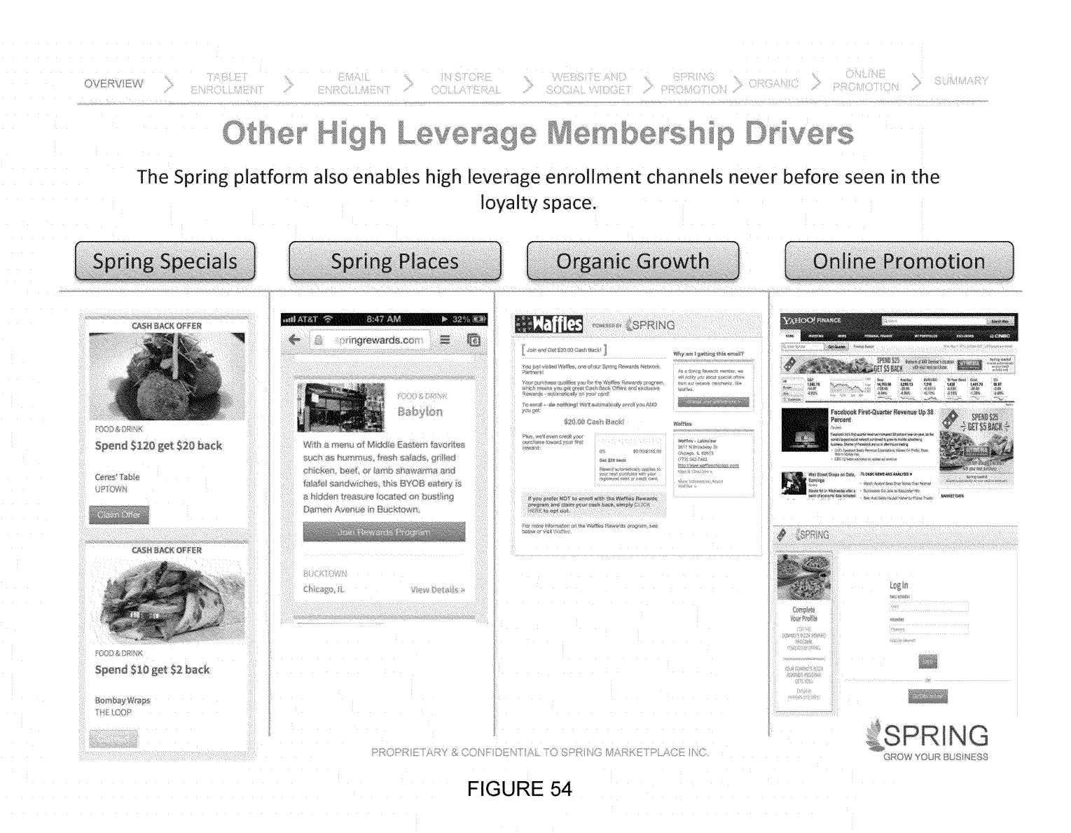

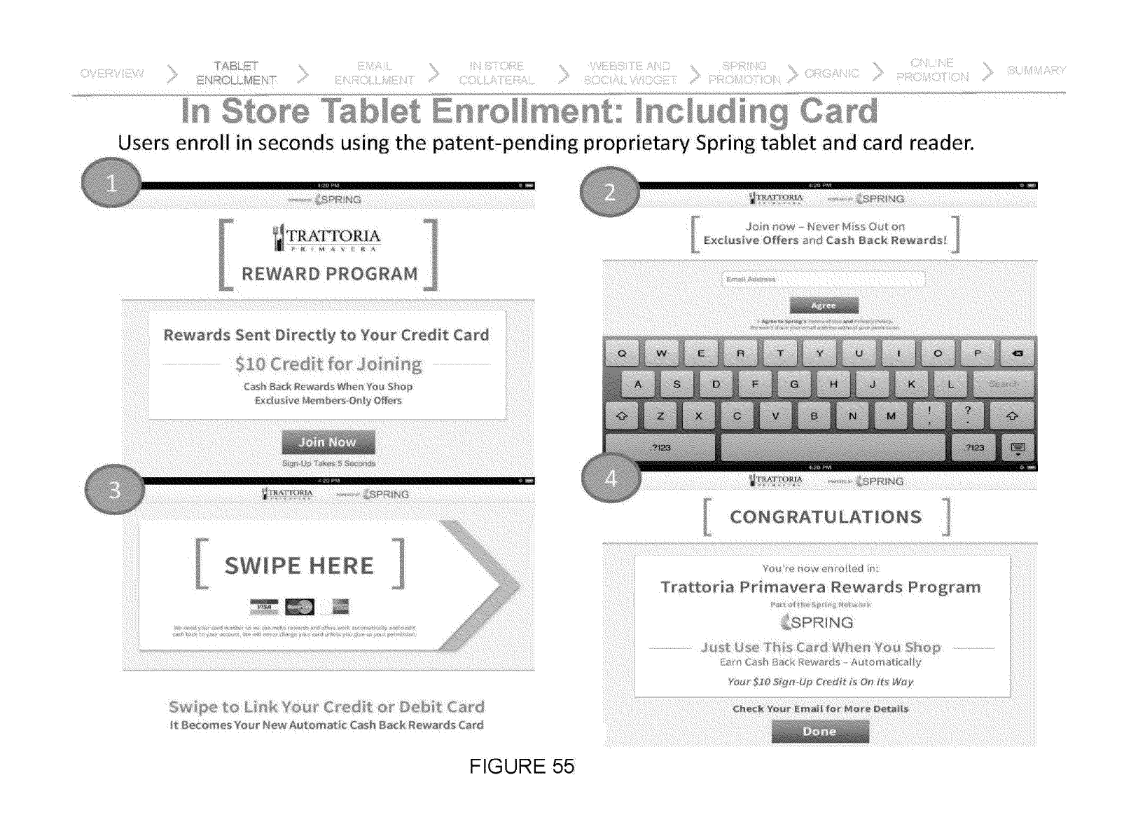

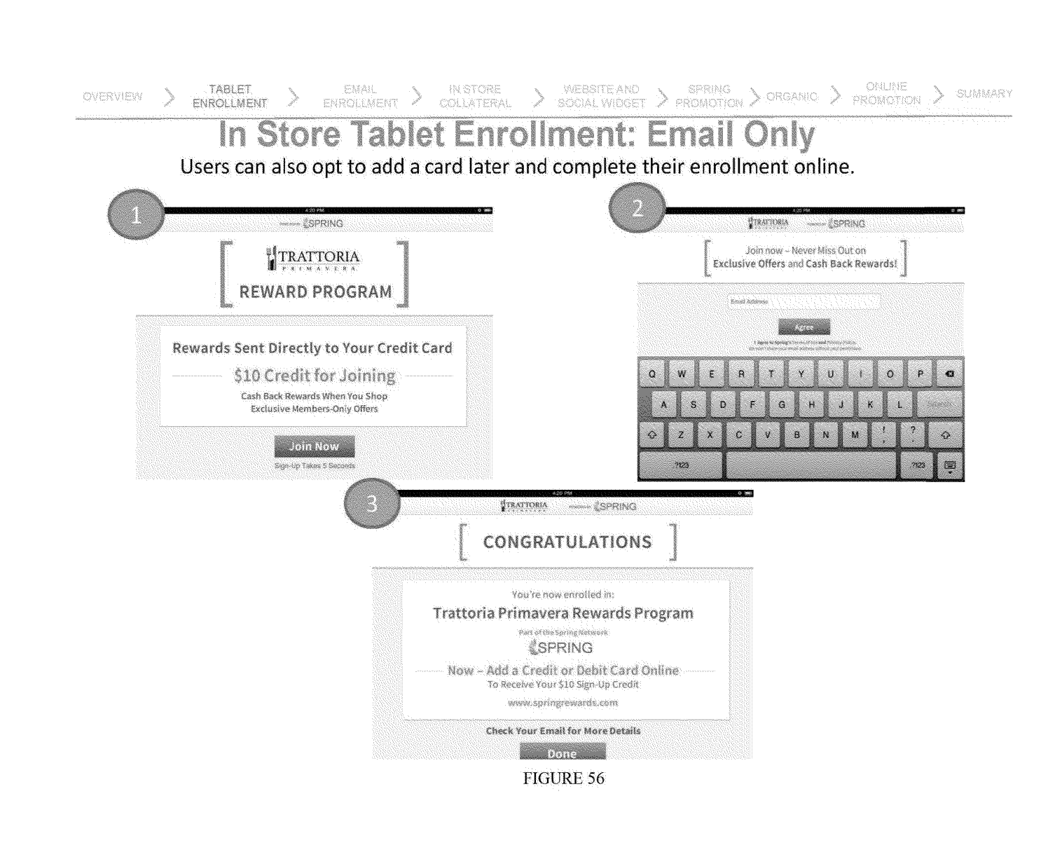

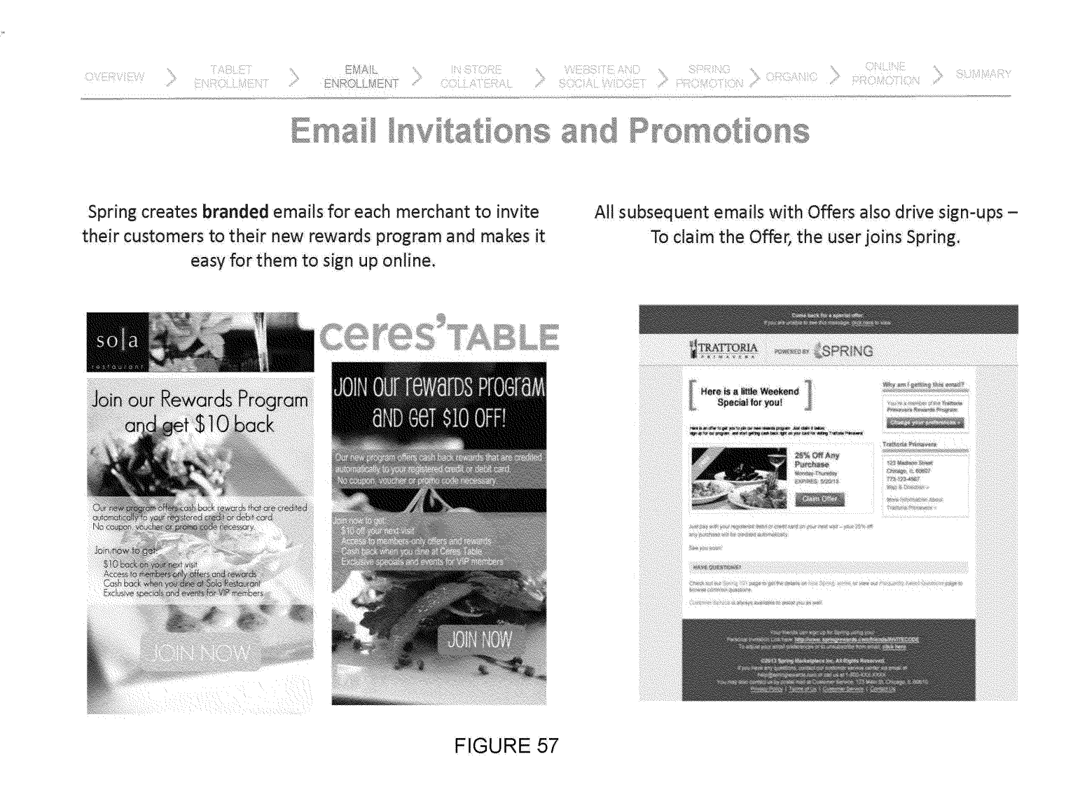

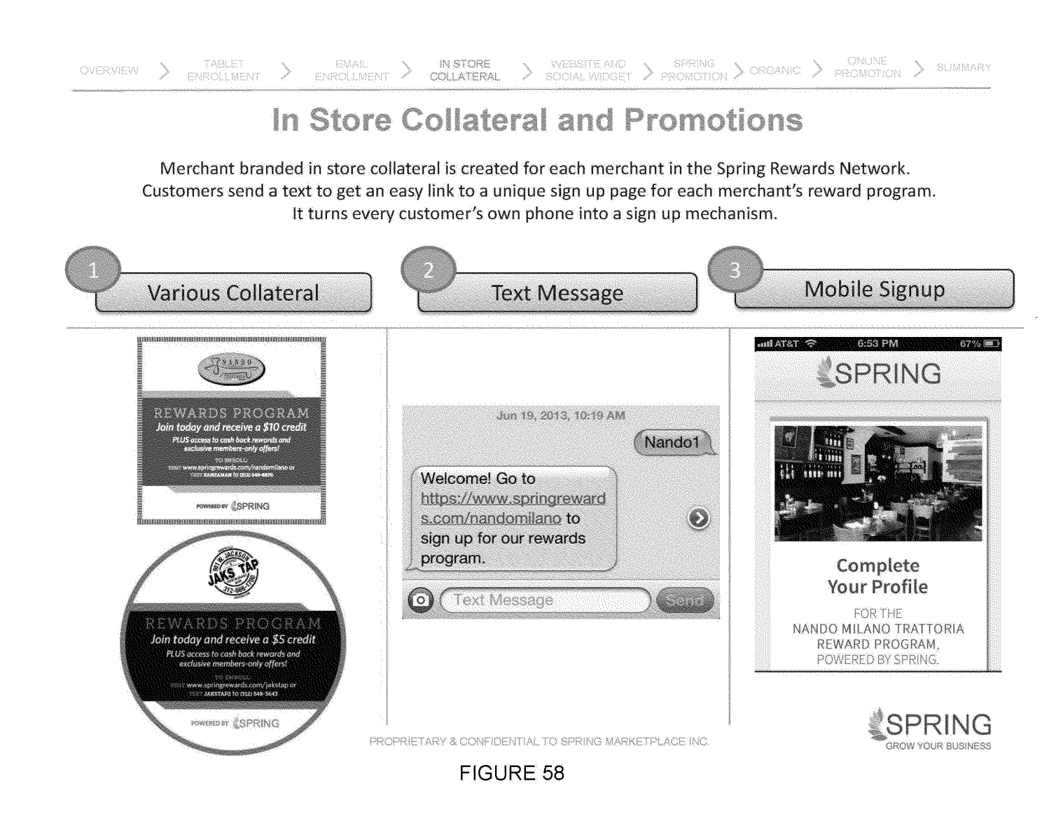

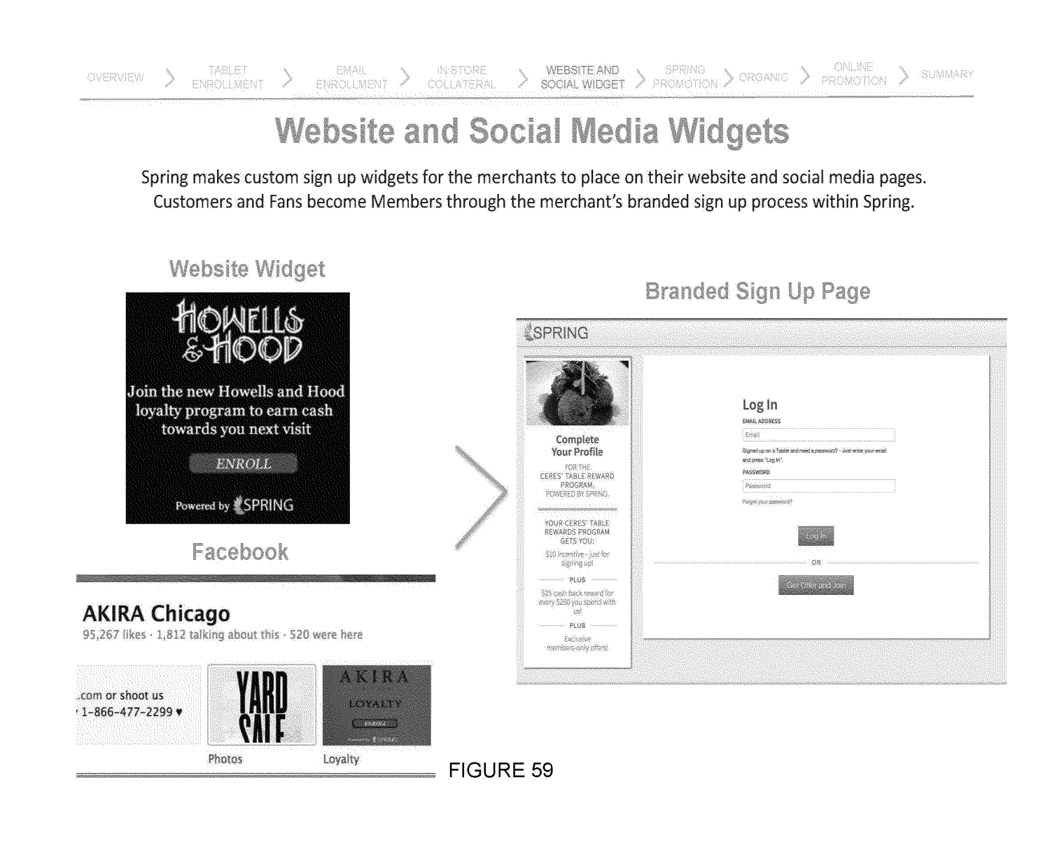

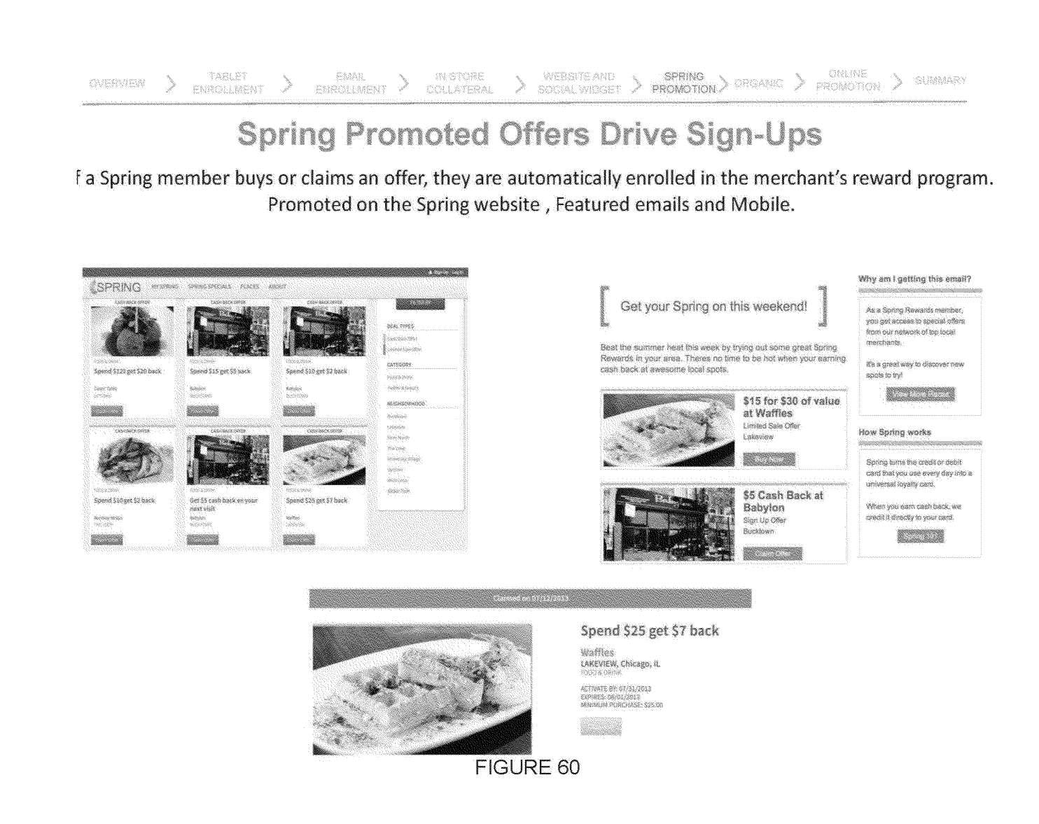

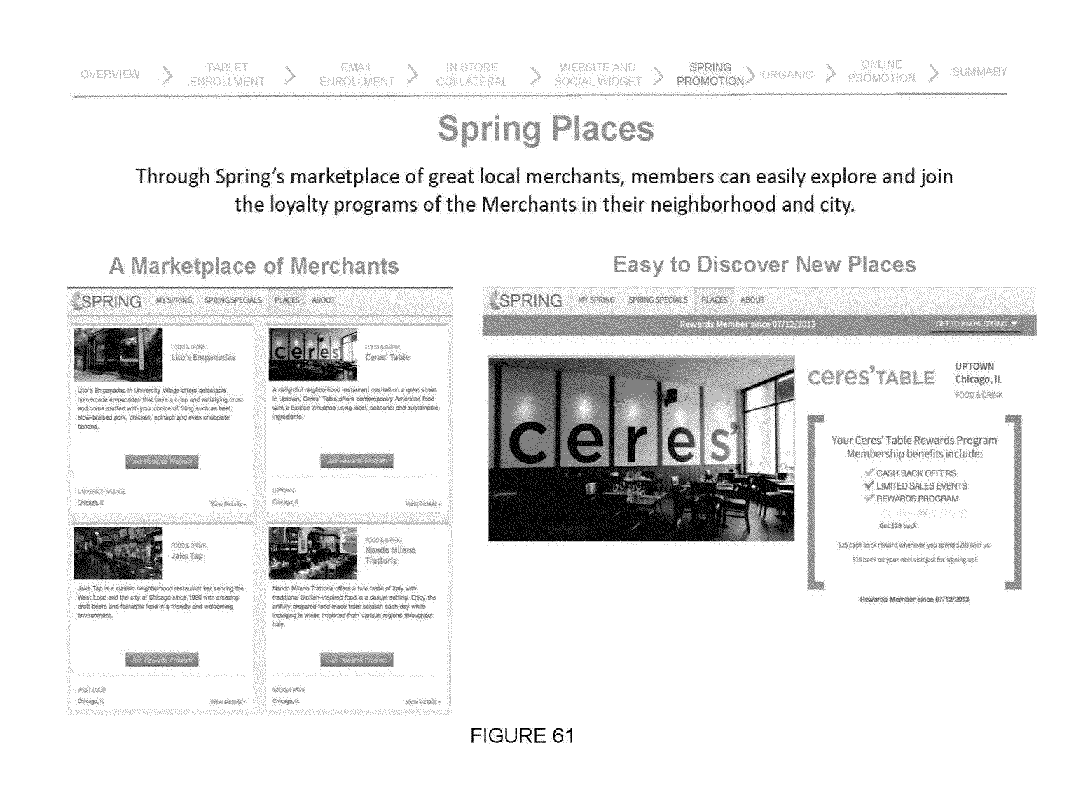

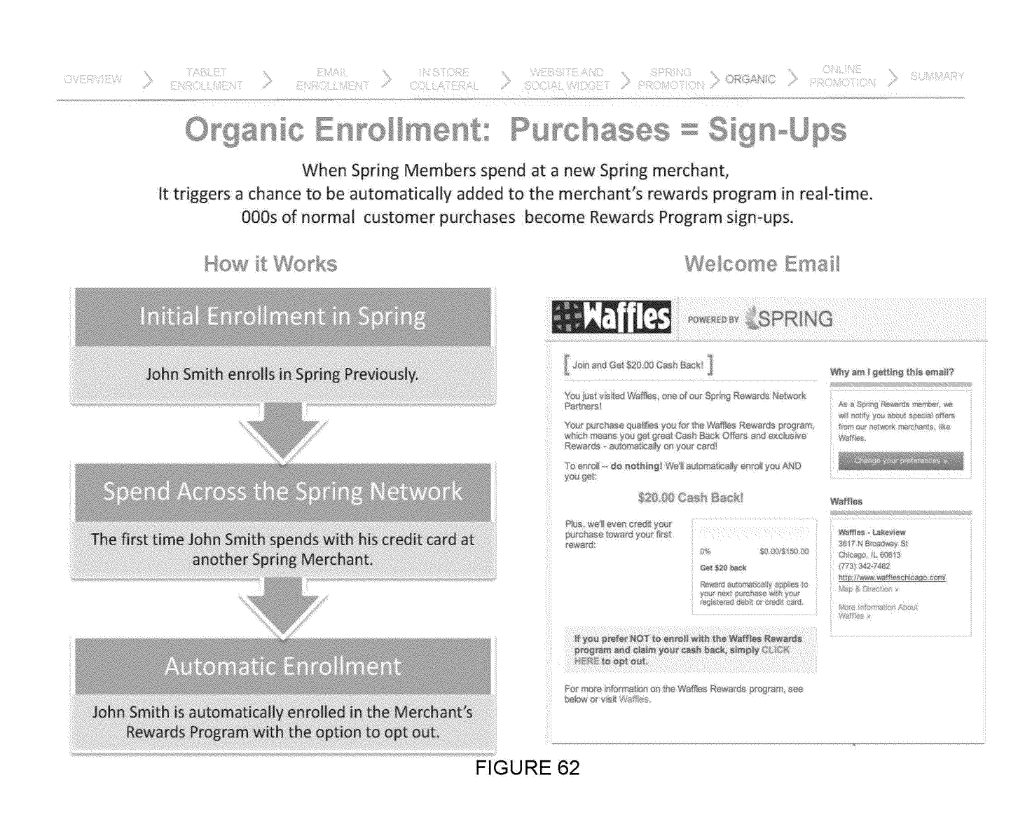

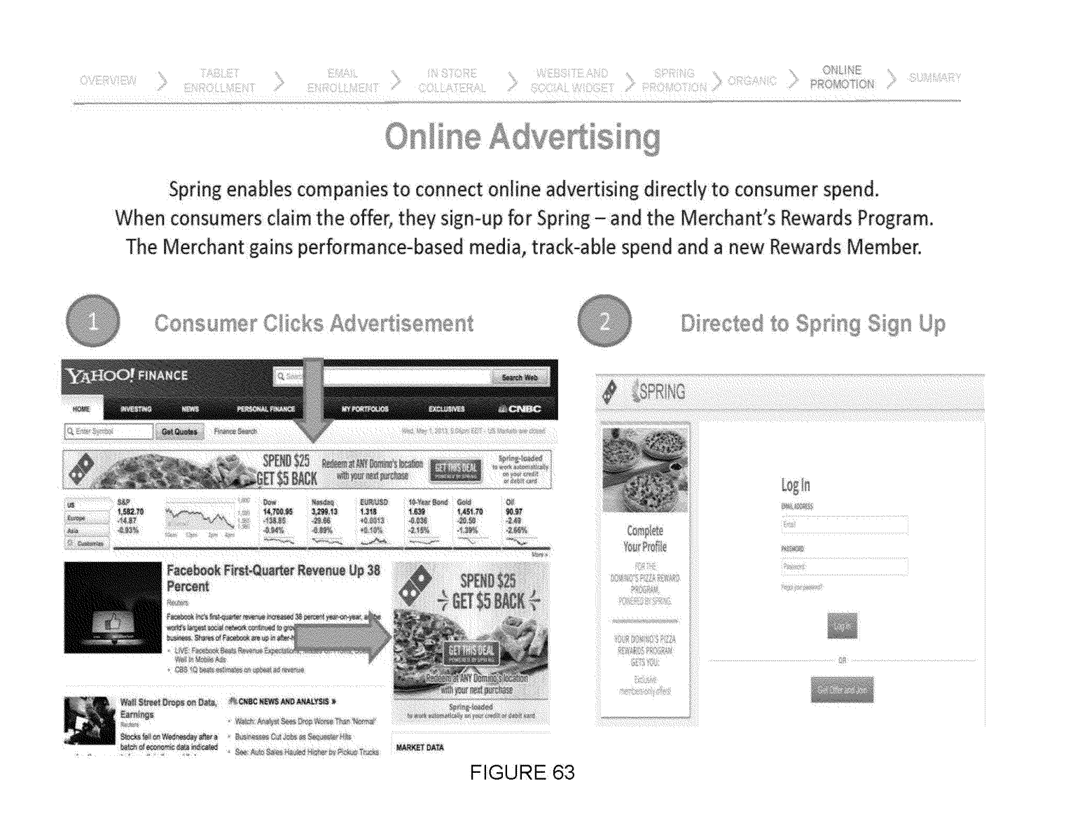

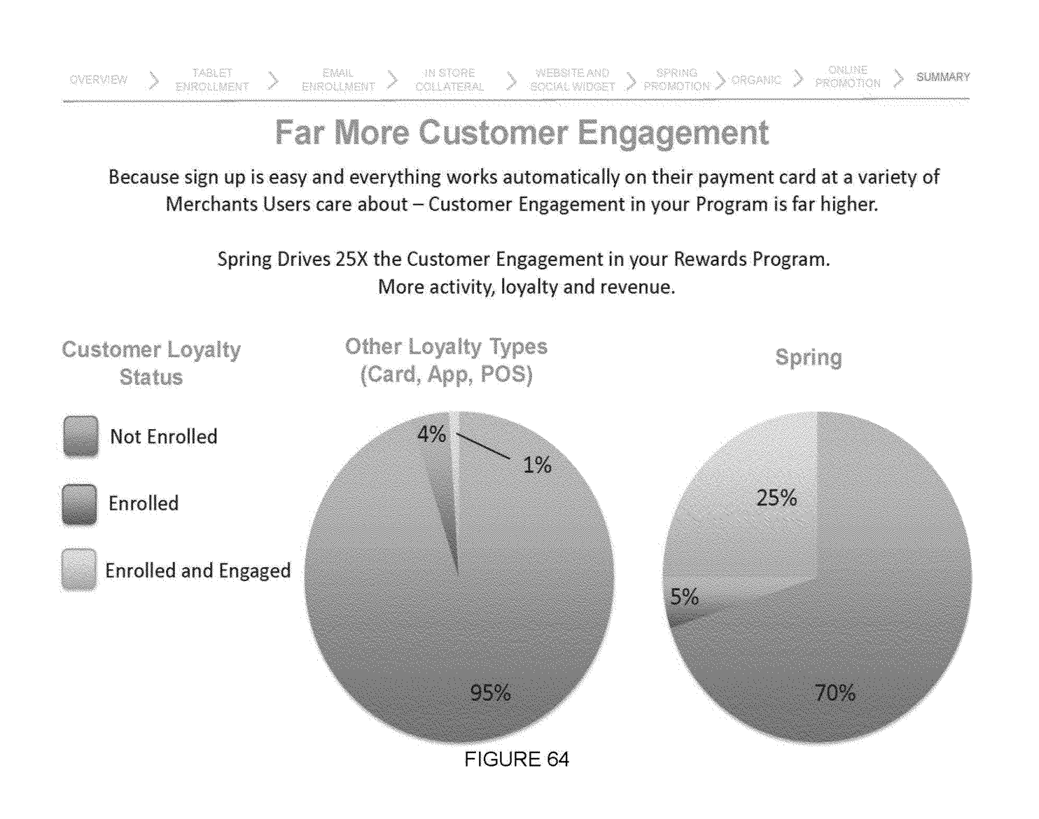

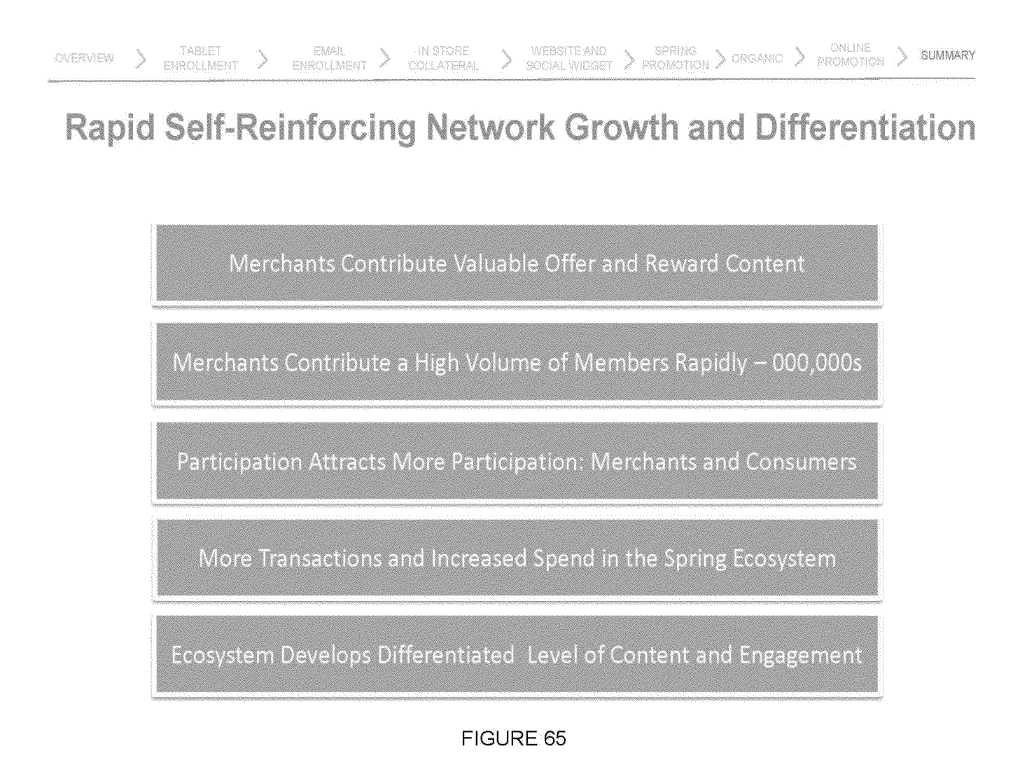

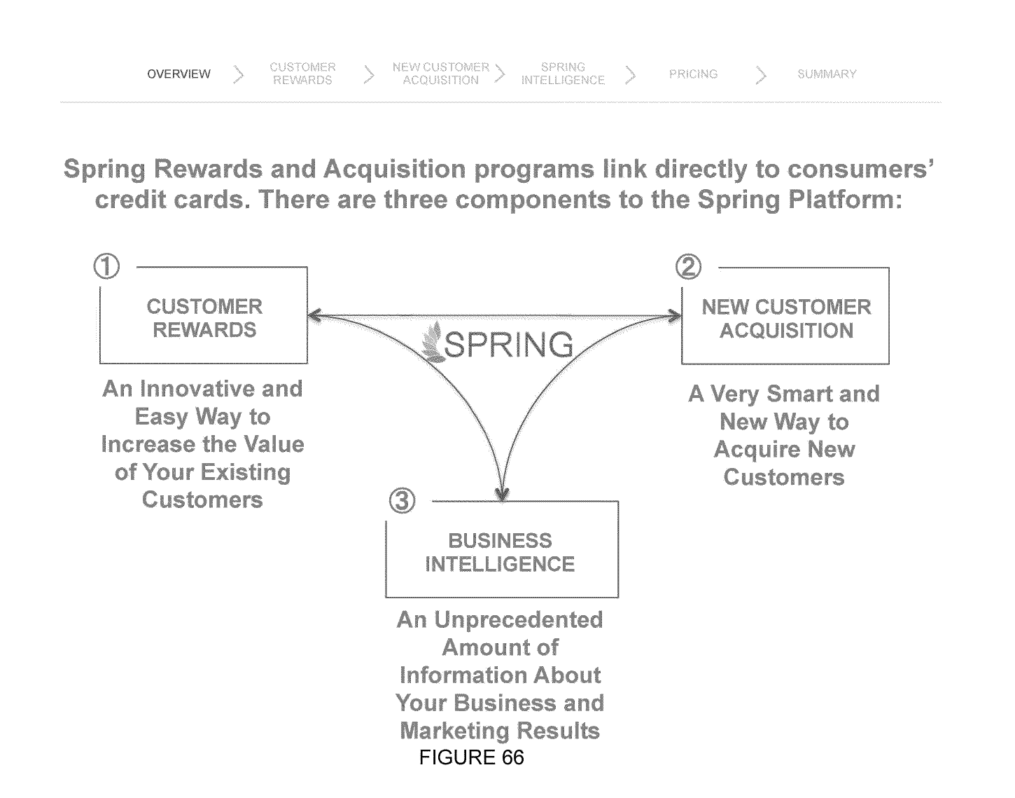

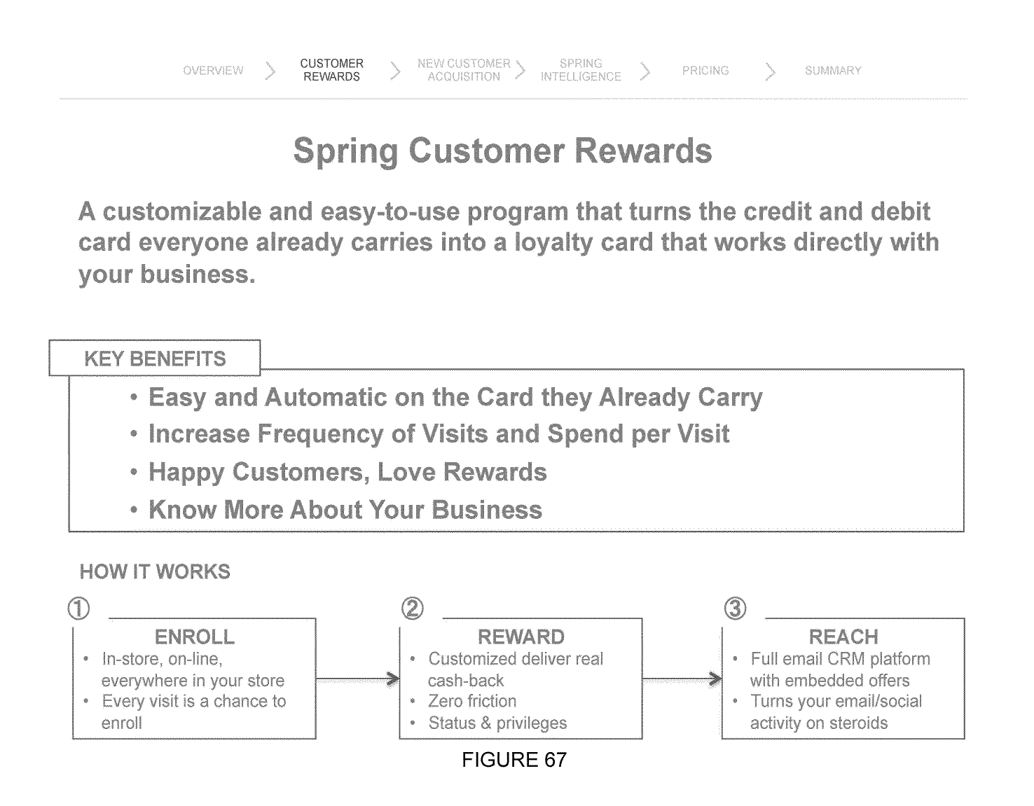

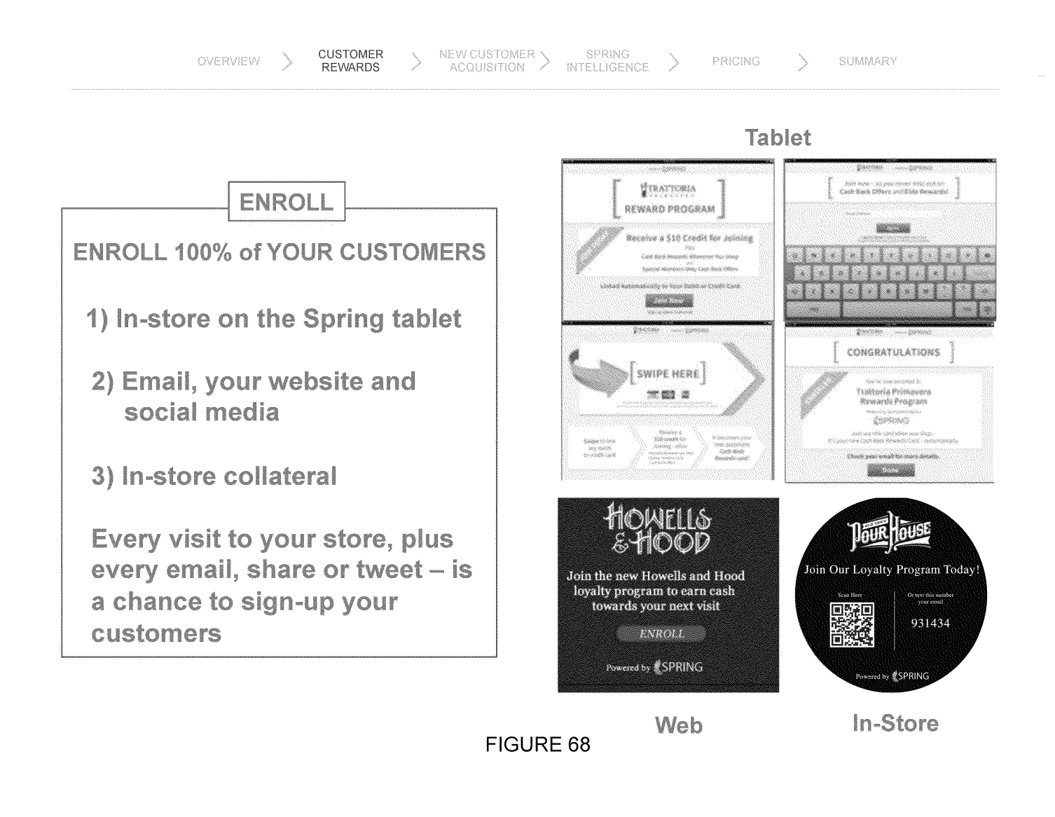

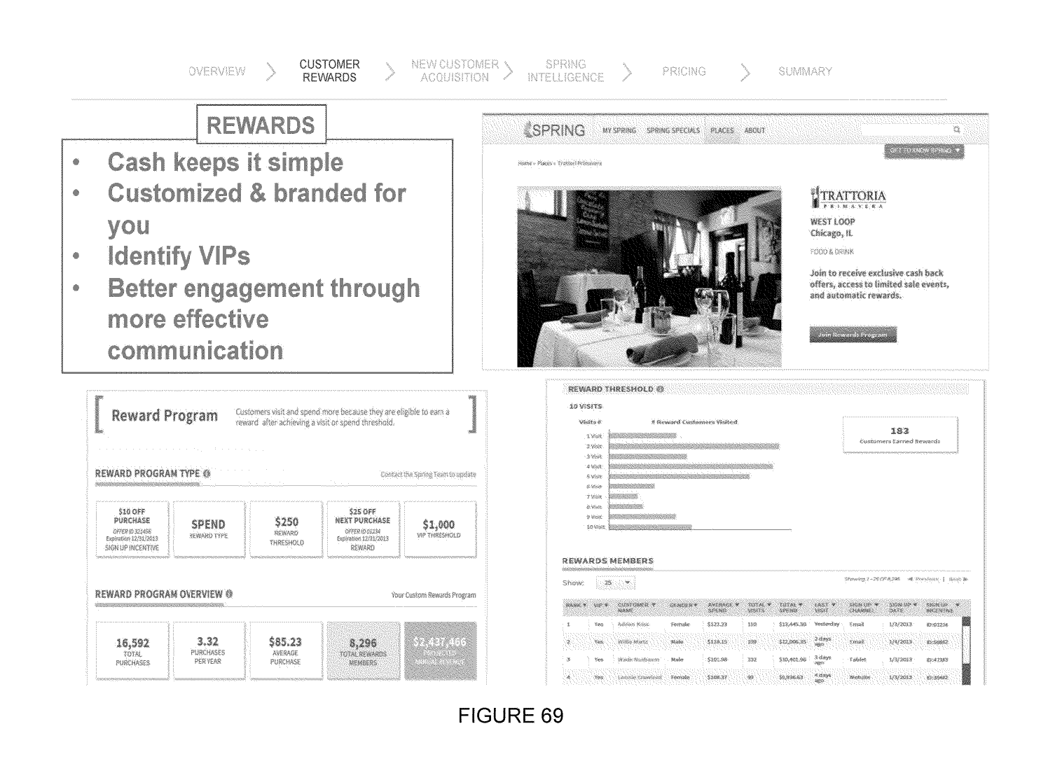

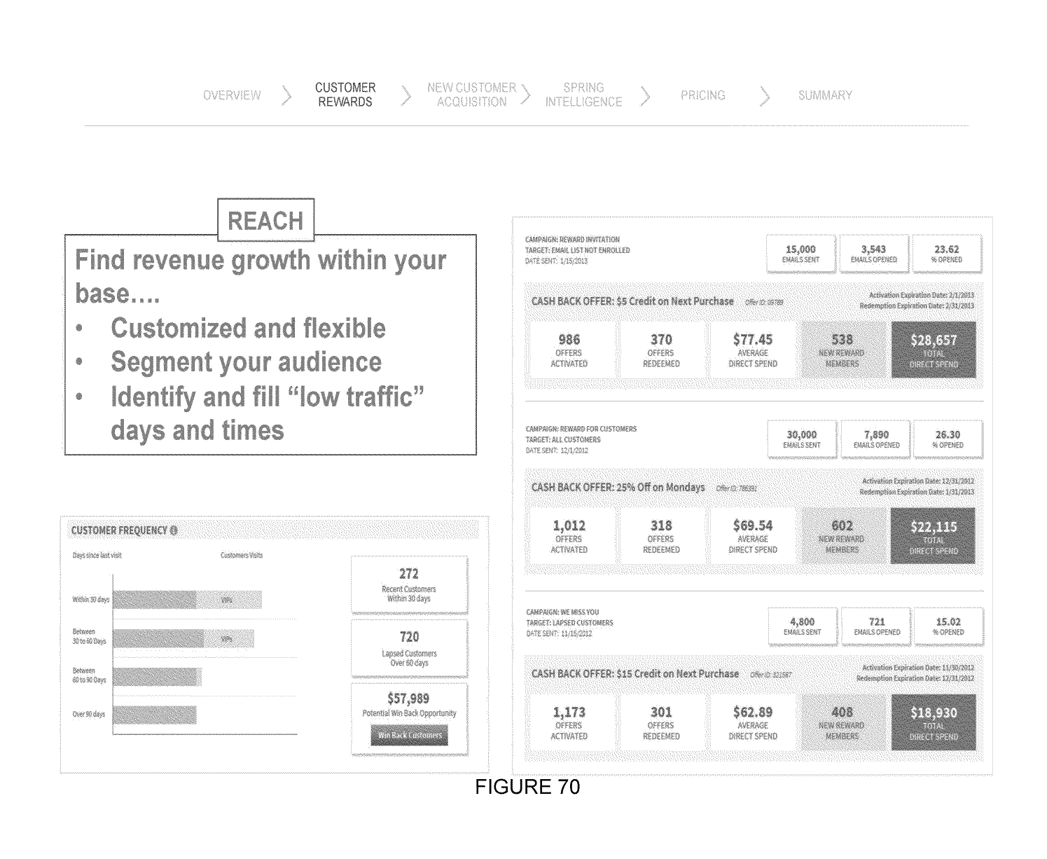

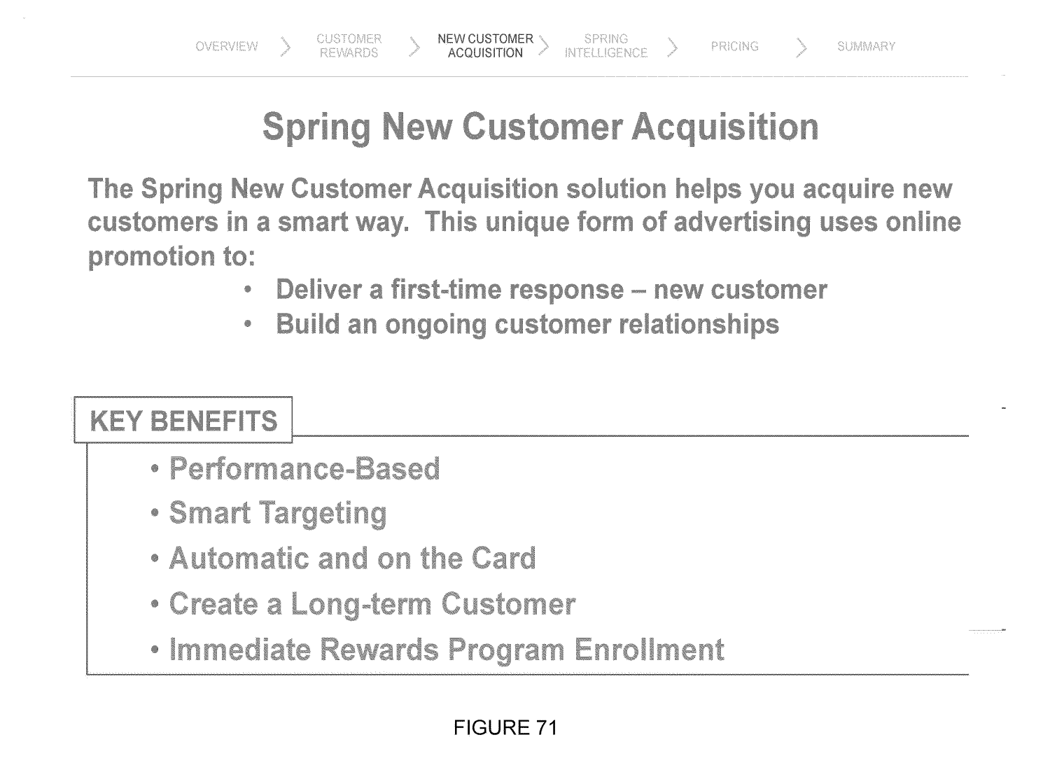

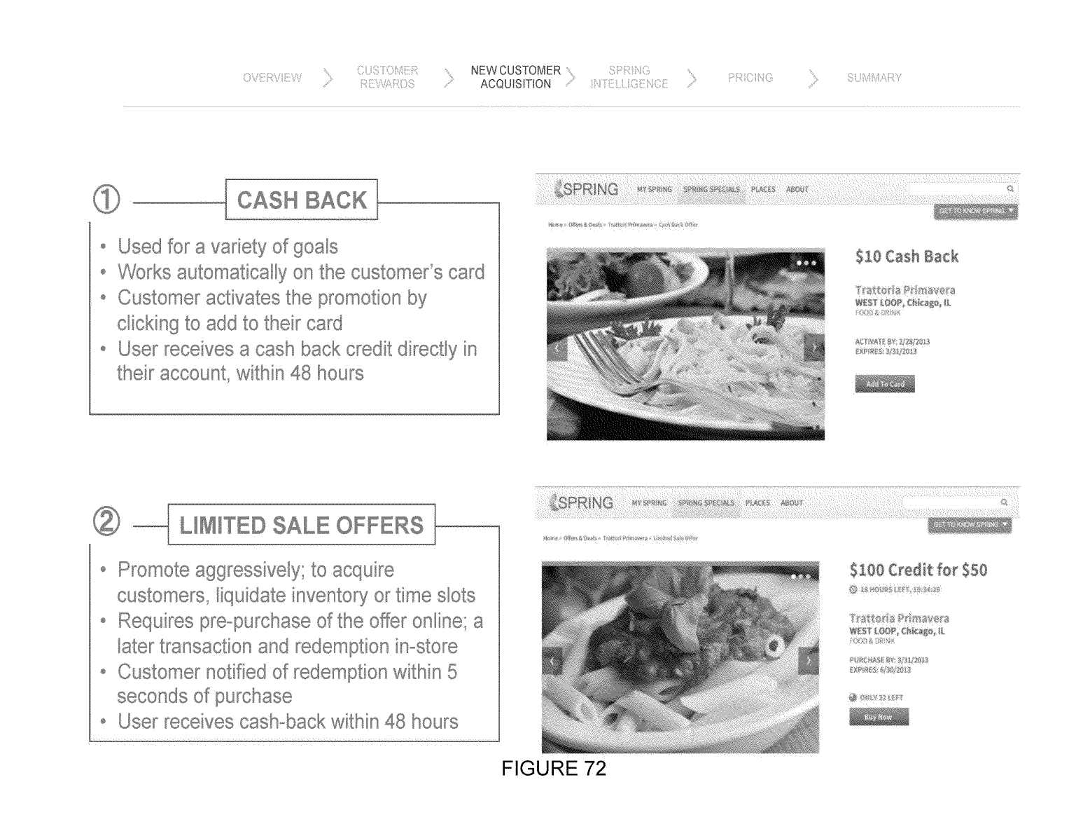

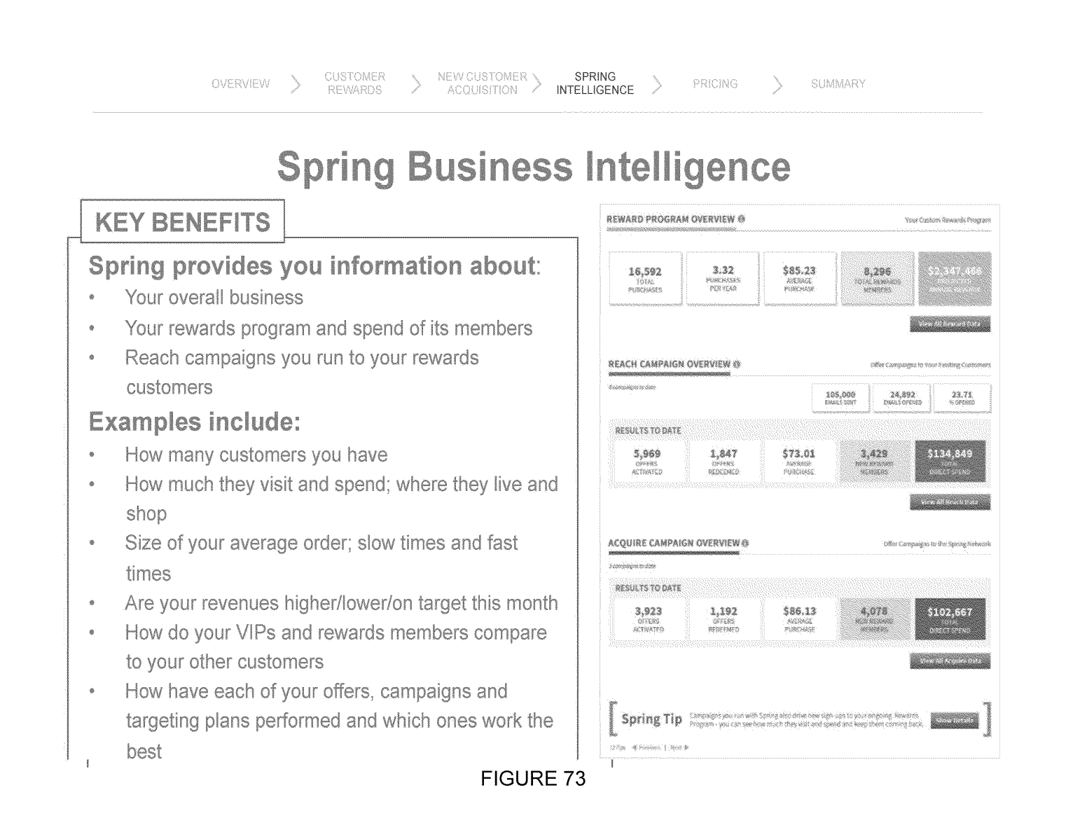

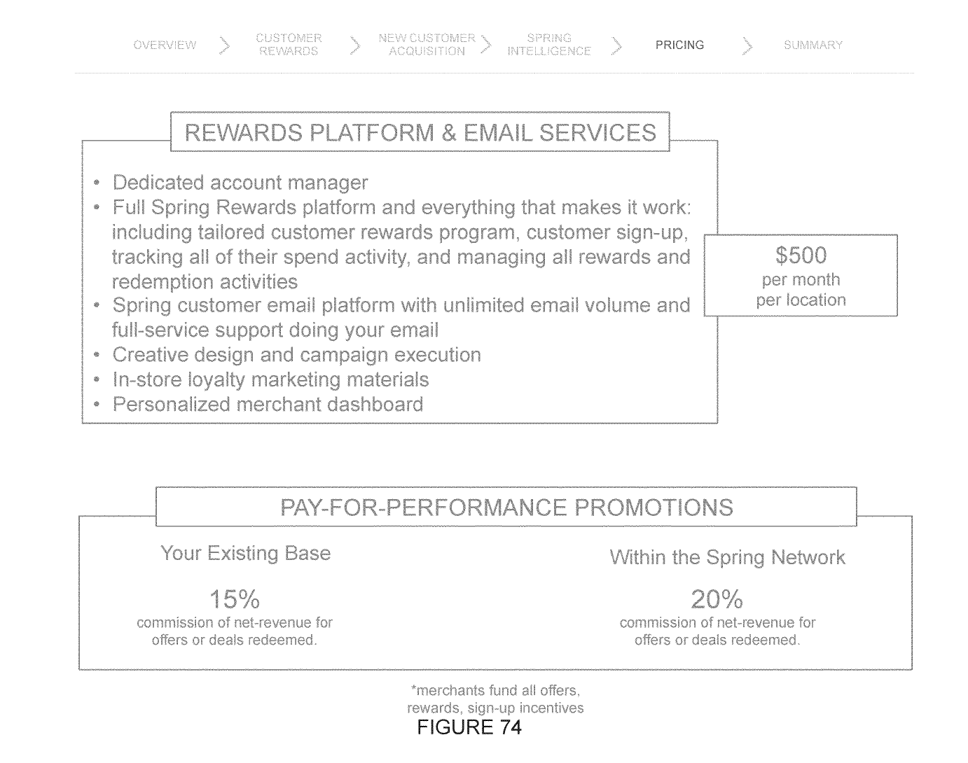

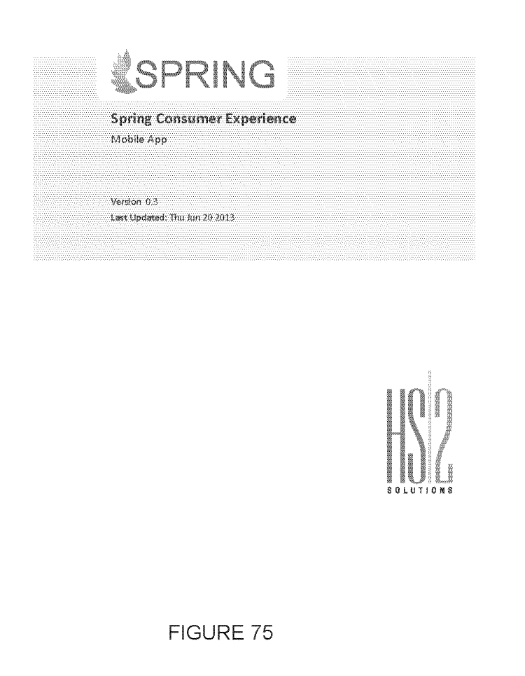

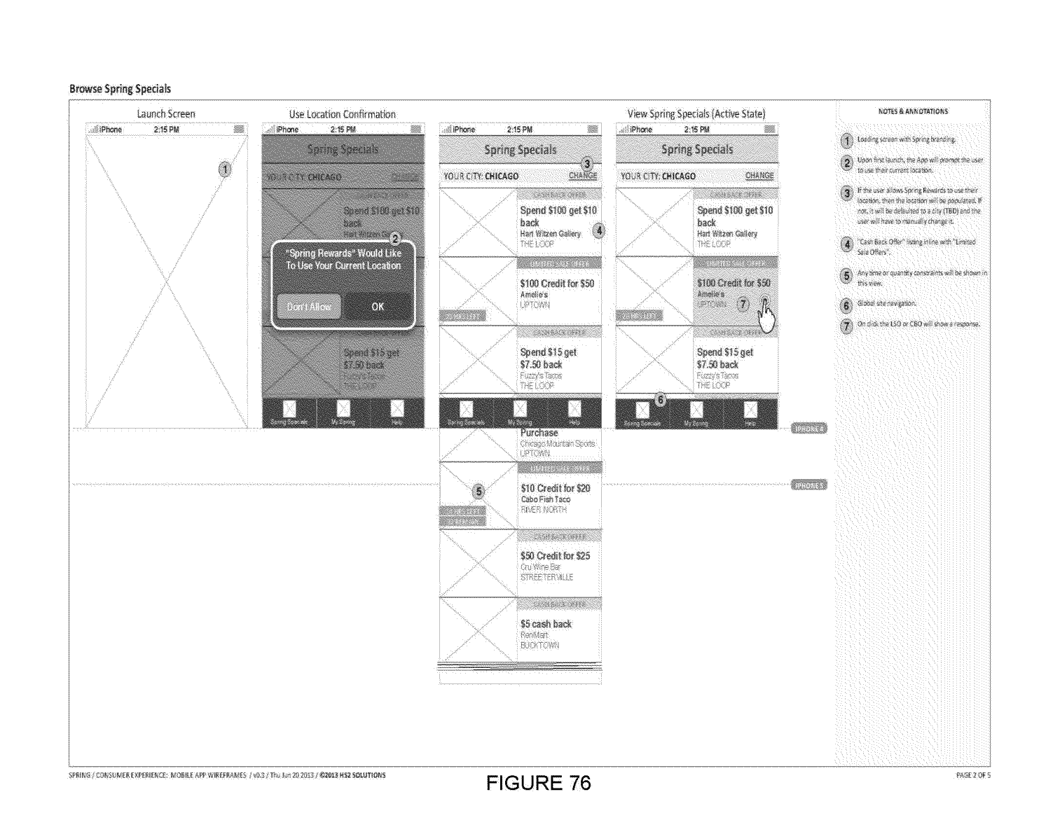

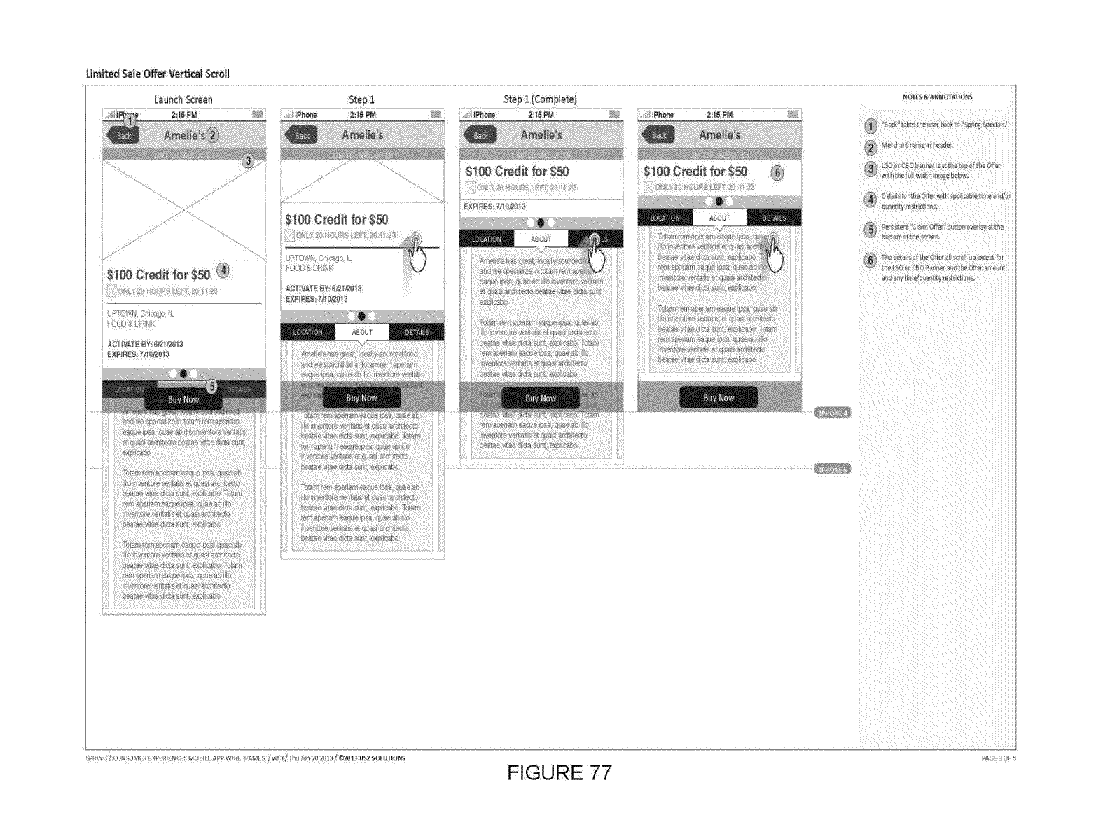

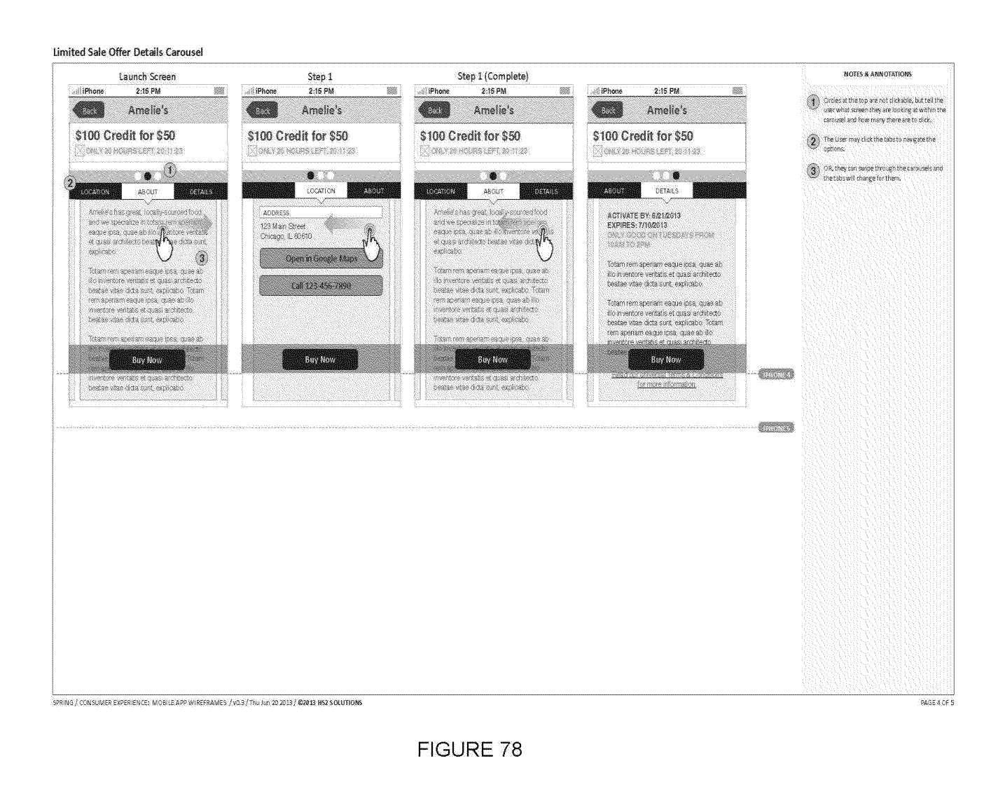

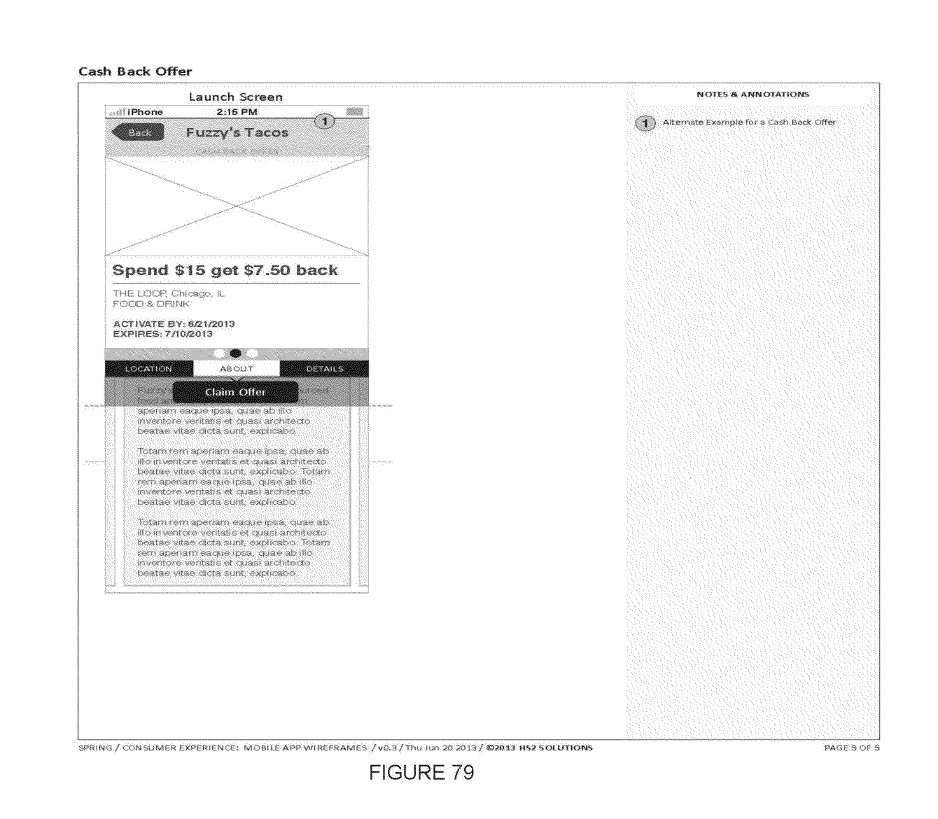

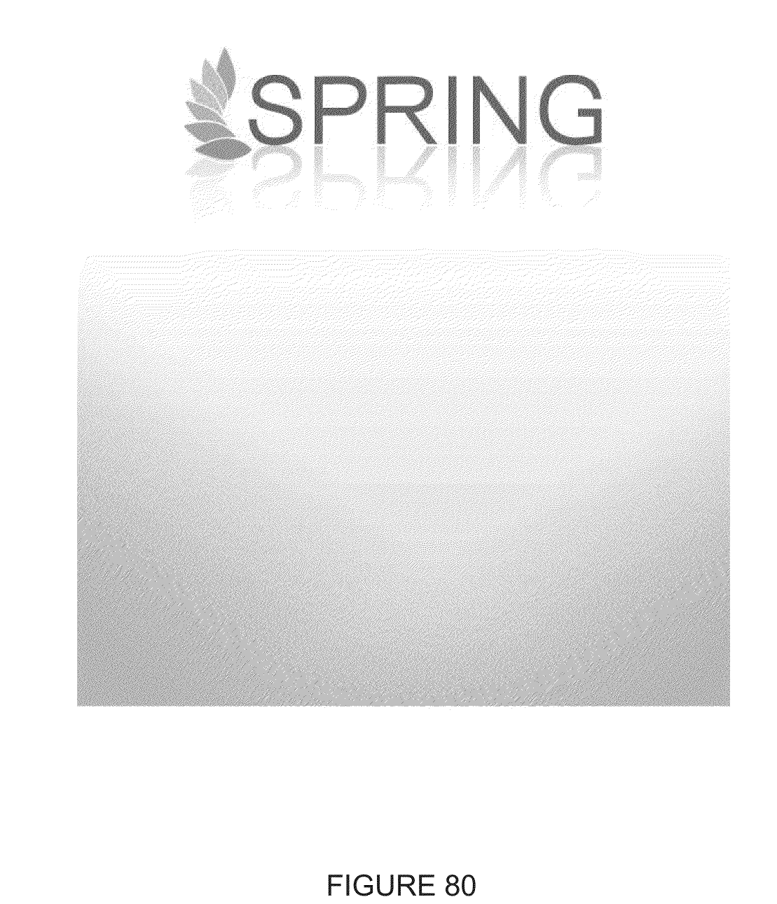

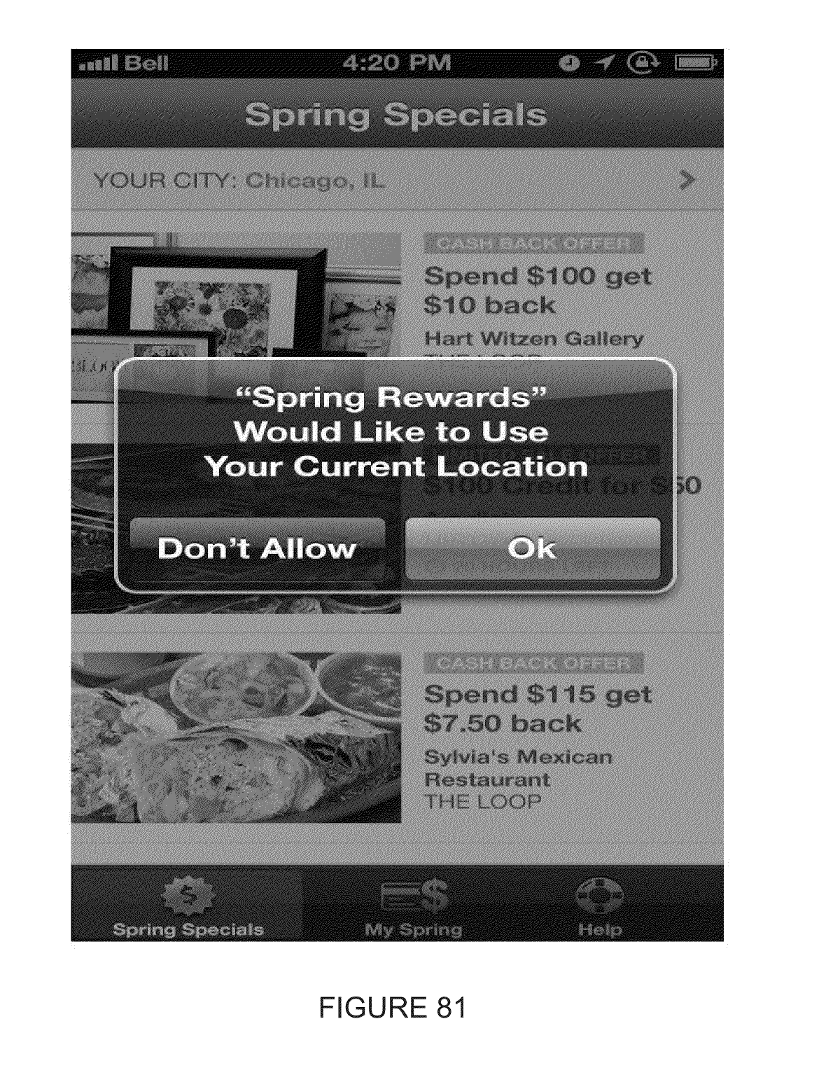

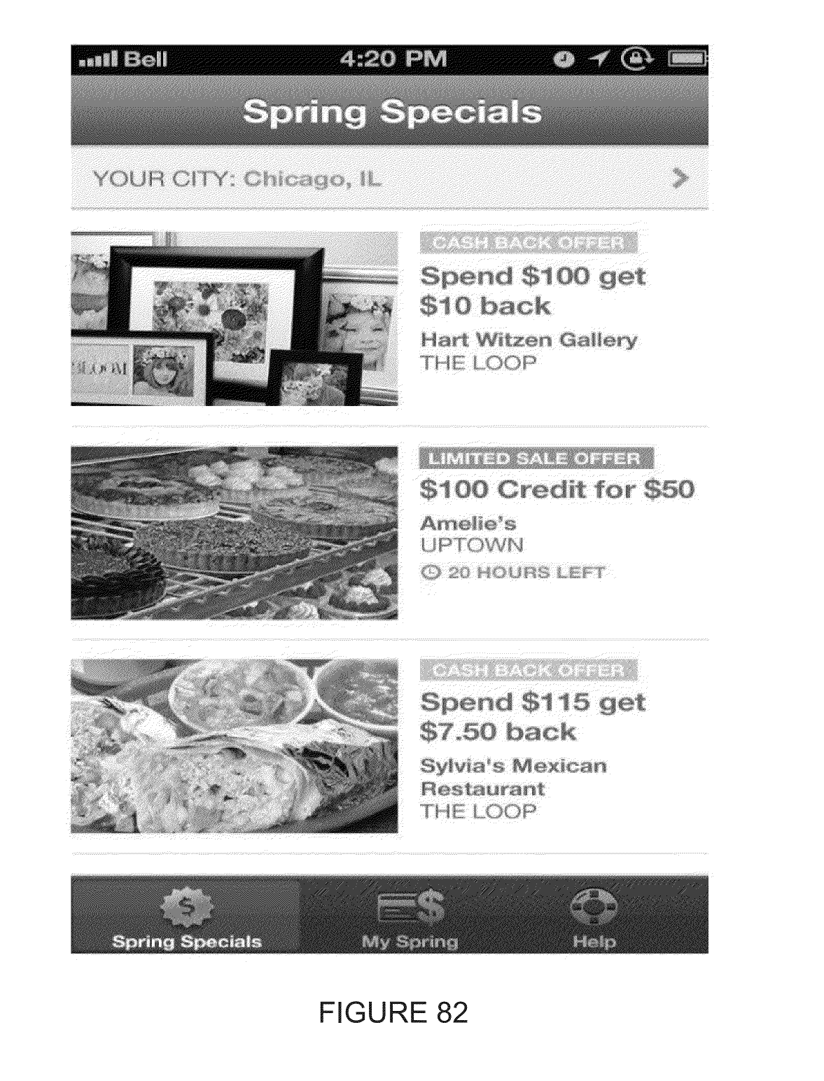

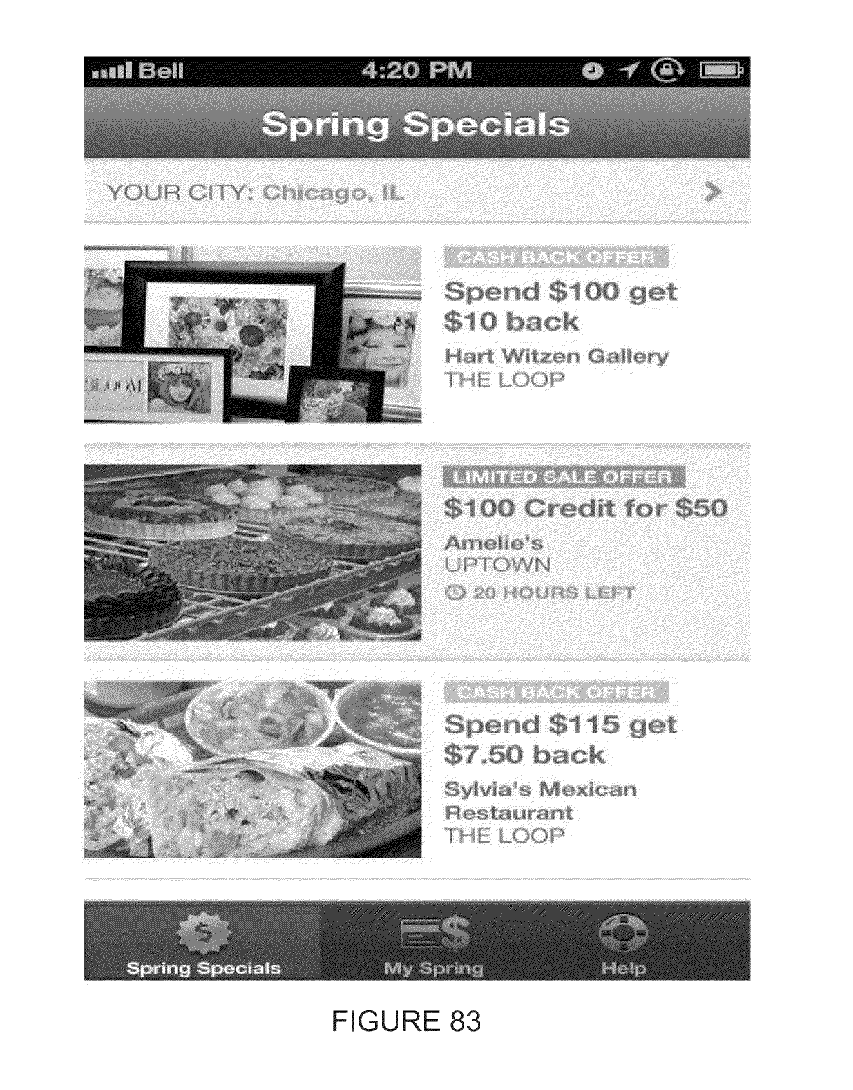

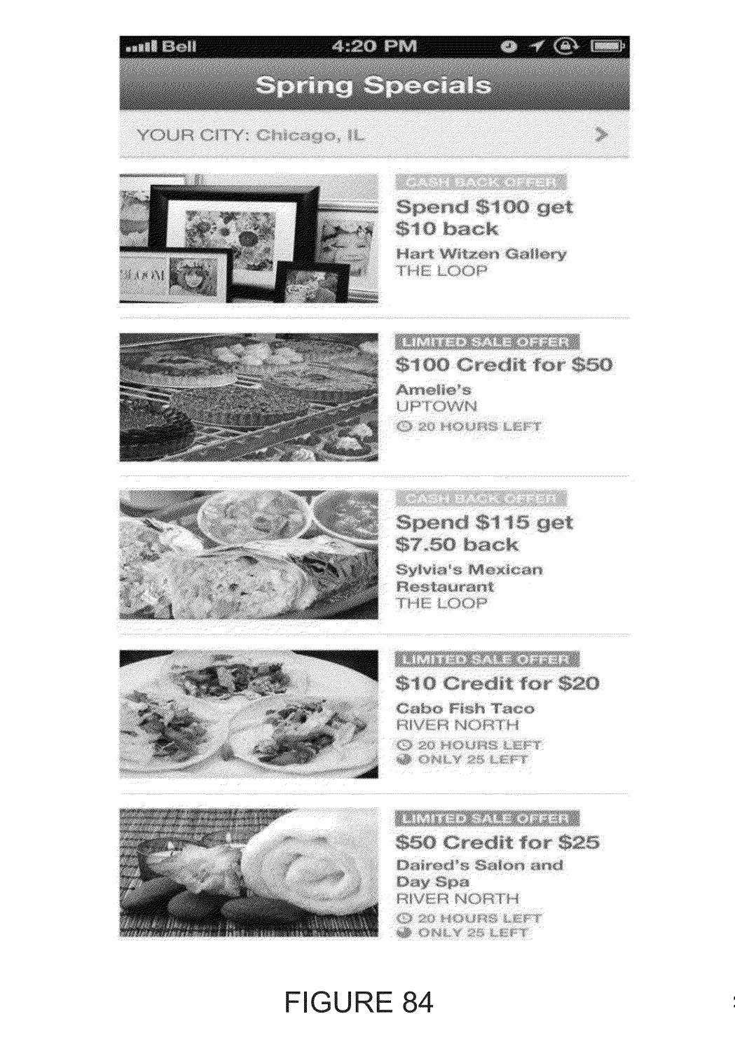

FIGS. 3-84 illustrate graphic user interface (GUI) diagrams of embodiments of the invention (corresponds to GUIs from PPA).

### DETAILED DESCRIPTION

The present invention provides systems and methods for providing and operating a customer loyalty and rewards platform including network-based and merchant-based registration and management, including mobile and electronic messaging, remote and local customer registration options, enrollment and credit, debit, and other electronic payment card account association therewith, as well as functions of providing promotional and/or discount offers, adding promotional and/or discount offer(s) to profile, adding cards, credit, debit, and other electronic payment card accounts or electronic payment accounts, redeeming promotional or discount offers, real-time automated functionality, providing data for a marketplace of vendors and customers, including account and activity data, providing a coalition network model, and combinations thereof. In describing the present invention and embodiments thereof, reference to a credit, debit, and/or payment card is directed to any suitable form factor representing the account, rather than merely a physical card per se, because the form factor may change, such as transition to, or addition of, a mobile wallet or functional medium representing the electronic payment account.

The systems and methods of the present invention provide for connecting digital network-based environments with payment data, including a rewards platform and/or a loyalty platform for customers with merchants participating in the network. The present invention systems and methods solution provide merchants with ways to acquire new customers as well as a rewards program for existing customers. In one embodiment, any digital media provided over a network, e.g., online media provided over the Internet, is functional and operable to automatically load or input customer loyalty and rewards information to at least one electronic payment media, including incentives or promotions to encourage consumer action with the predetermined merchants for goods and/or services to be automatically electronically associated with at least one credit or debit card account, and/or electronic payment account of a corresponding consumer user.

Loyalty and Rewards Platform.

In contrast to prior art systems and methods for loyalty and rewards programs wherein each merchant has its own closed loyalty and rewards program, and wherein customers must take specific actions to enroll, the present invention provides for a loyalty and rewards platform including a multiplicity of otherwise unrelated merchants, wherein customers automatically enroll in a single loyalty and rewards platform that provides rewards across the multiplicity of merchants in the platform. In prior art examples, users earn points or a currency that is redeemable not at the merchant where the spend triggered the earn; by contrast to the prior art, the present invention provides systems and methods wherein users earn both a points currency redeemable outside that merchant and earn towards a cash back reward with the merchant at which the user spends. Thus, the present invention systems and methods provide an interactive “ecosystem” that leverages existing financial systems, networks, and infrastructure related to electronic payment, in particular (but not limited to) electronic payment cards, and existing customer behavior (making electronic payment by swiping a magnetic stripe containing digital representation of customer account data and other customer data associated with at least one electronic payment card, for wide scale implementation of a multi-merchant loyalty and rewards, discounts, incentives, benefits, and combinations of these programs. Notably, mobile payments, electronic wallets, etc., or any other form of electronic payment, may be used as well.

Advantageously, the present invention business methods transform customer payment information into marketing functionality information that enable automated performance-based digital promotions tracking and analysis. By way of example, the present invention systems and methods provide automated performance-based digital promotions by tracking customer activity compared with revenue delivered as a result of the promotions, as evidenced by customer electronic payments with merchants within the loyalty and rewards platform (member merchants), including factors such as payment amount, time, and location with respect to the customer spend with the member merchants. Furthermore, the present invention systems and methods include at least one database of customer electronic payment account and corresponding payment information, which is advantageously received from existing card networks, including authorization and settlement data, directly in real time or near real time, thus creating customer spend behavior information and patterns relating to them, including upstream pre-existing, which are transformed to target marketing opportunities with those customers. Merchant friendly targeting of customers to incentivize specific spend behavior includes all promotional media available to deliver targeted advertising, promotions, discounts, incentives and combinations thereof, to existing or past customers and to potential new customers in a plurality of formats and structures that are dynamic and that are customized to satisfy the merchant requirements for results that meet business goals or expectations. For example, a merchant typically does not know if a target customer is an existing customer unless upstream data on that customer is available. Incentive-based discounting by merchants is effective, but only for new customers or to reactivate stale customers. So upstream customer spend behavior and patterns are important and useful in structuring a targeting marketing project with the present invention because they include customer geography, spend behavior information, and provide self-reported automatic information (including zip code and time of business transaction with a given merchant, electronic payment card swipe location and time) that is transformed into a scatterplot or other visual or graphical representation with respect to up to about the past 90 days or less. The targeted marketing or advertising is also customer friendly inasmuch as the incentives extended to the customers are directly relevant to the customer based upon past customer spend behavior, so they provide incentives or promotions that are consistent or related to the customer interests, based upon comparison with the recent past spend behavior, and based upon relationship (active, stale and/or past but inactive, new and/or no relationship yet) with the merchant members of the loyalty and rewards platform.

The present invention further provides smart offer structures that are based on customer spend behavior and that align the business goals or objectives of the member merchants for stimulating and/or increasing customer activities in specific ways. For example, predetermined triggers are established for extending automated offers to the target customers that provide discount-based incentives that deliver yield management in patterns that improve the revenue of the member merchants according to predetermined times, days of the week, days of the month, etc., e.g., restaurant merchant members establish triggers to stimulate business on weekdays without existing high traffic, like Tuesdays. Alternatively or additionally, the present invention provides Smart Offer Structures that provide support for triggers that are selected from: time conditions, spend-level for a transaction conditions (i.e. above $X), transaction/visit frequency conditions, and combinations thereof.

Significantly advantageously, the loyalty and rewards platform of the present invention uses existing infrastructure for electronic payment and does not require any change in customer payment types or methods, which leverage existing customer payments without conscious steps or actions by the customers (no merchant codes or coupons need to be provided by the customers participating or enrolled in the platform at the time of purchase to engage the loyalty and rewards platform and member merchants incentives). So the customer unconsciously engages the loyalty and rewards platform each time an electronic payment transaction is provided at member merchants within the systems and methods of the present invention; the customer experience is essentially effortless and requires no additional steps other than purchase and electronic payment with merchant members. Furthermore, discrete interactions between customers and merchant members of the loyalty and rewards platform of the present invention are automatically transformed into continuous interactions without steps that are in addition to or extraneous to the purchase transaction by the customer. Merchant members have customer permission-based visibility into customer spend activities, behaviors, and therefore potential interests, which is essentially helpful for successful targeted advertising to generate more business with new and existing customers in predetermined ways. Therefore, customers' interests and merchant members' marketing goals are aligned to provide seamless, effortless interaction within the loyalty and rewards platform of the present invention.

Customer Enrollment.

The present invention provides for a customer to enroll multiple electronic payment cards or devices, including but not limited to credit cards, debit cards, prepaid cards, mobile wallet devices, mobile payment devices, and combinations thereof. Notably, with the present invention, in one embodiment, by way of example and not limitation, enrollment steps include: a user swiping a payment card through a card reader (whether separate from or co-incident with swiping the card to effect a payment transaction), taking a photo of the payment card or entering the number through an online form, including doing any of the above connected to or associated with a Tablet computer or mobile phone computer, and combinations of these options. There are a multiplicity of methods for customers to activate enrollment in the loyalty, rewards, and/or incentive platform of the present invention, including at least one of: providing a physical form factor for receiving inputs from customers at a merchant location; providing an interactive website with graphic user interface via a data and communications network (e.g., the Internet) for receiving inputs from customers at remote locations from the merchant locations; providing a physical marketing collateral at a merchant location, such as by way of example and not limitation, a tablet computer, a smartphone, a computer with display, etc.; automatically activating a customer enrollment by the system, wherein the enrollment is triggered by a purchase made by the customer using an electronic payment either at a merchant and/or via online (remote) purchase from a merchant within the network of merchants associated with the loyalty and rewards platform of the present invention; and combinations thereof. In the case of providing an interactive website with graphic user interface via a data and communications network (by way of example but not limitation, the Internet) for receiving inputs from customers at remote locations from the merchant locations, the website may be accessed by customers after they input a website URL, provide inputs on a merchant website with a link to a URL for registration and creating a customer profile, receive a text message or SMS with a URL link that directs the customers to a URL for registration and creating a customer profile, providing an email invitation to a customer with a link to a URL for registration and creating a customer profile or other interactive website enrollment or registration page; providing any other digital object online, including an ad with an incentive, and combinations thereof. A sign-up or enrollment incentive may be provided in addition to advertising or other promotion of customer enrollment in the loyalty and rewards platform.

In any case, the enrollment automatically provides for express, customer permission-based access to spend information across all registered electronic payment cards for any issuing bank, and for any card type (e.g., the associations providing electronic payment cards, including VISA, MasterCard, American Express, Discover networks for any issuing bank or financial institution). Because the automatic enrollment is independent of a financial institution and independent of any card issuer, the systems and methods of the present invention provide the first comprehensive multi-merchant, multi-electronic payment form (card, etc.) for loyalty and rewards platforms, including real-time or near real-time upstream and downstream data availability relating to customer spend behavior, thus meeting a longstanding, unmet need for this solution. The systems and methods of the present invention provide for customer spend data to be automatically obtained directly from the electronic payment card networks or associations (e.g., VISA, MasterCard, American Express, and Discover); additionally or alternatively, data is acquired from issuers or processors of the electronic payment cards. Thus, the present invention provides the ability to take data at all from one or more of the associations. Also, the present invention provides the ability to take data from merchant processors or all the processors With this, the loyalty and rewards platform database includes information and access to information from the electronic payment card authorization file or feed; this data is preferably aggregated and integrated by the servers and databases of the systems and methods of the present invention. Furthermore, the systems and methods of the present invention are applicable to and function for all merchants that accept any type of payment cards and/or electronic payment, not only those that use a specific processor. That is part of what is a unique attribute of the present invention that provides a ubiquitous solution and marketplace or network configuration of merchants and customer users. In one example, those customers that use a given processor can enroll all card types, but only for the merchants that use that processor.

Enrollment Mechanism and Business Model.

The systems and methods of the present invention loyalty and rewards platform provides for automatic receipt of all data available to the associations relating to electronic payment card information, while the loyalty and rewards platform provides compensation to the one or more associations only when the loyalty and rewards platform generates revenue under its business model of providing targeted advertising to customers for member merchants. The member merchants preferably have customer-approved visibility to every customer spend event or activity, even though every customer spend event does not generate the redemption of the incentives provided by the member merchants to the target customers under the loyalty and rewards platform of the present invention. By having customer-approved visibility to every customer spend event or activity without having to compensate the associations for access to all of the data (and only providing payment when revenue is generated from the loyalty and rewards platform) the present invention has unique insight into more customer behavior that can inform the targeted advertising and incentives provided under the present invention, and attract more merchant members to participate, which in turn attracts more customer members to participate, thus creating a rapidly automatically growing and evolving loyalty and rewards platform or loyalty and rewards ecosystem that self-perpetuates growth without undue effort by any single member, whether customer or merchant member.

Any and all micro-mechanics of electronic payment device or payment card or payment card account enrollment are considered within the scope of the present invention, such as data entry by customer online or through software on a smartphone, tablet computer, computer, etc., magnetic strip swipe or other reader input at POS or magnetic strip swipe or other reader outside of POS specific to effecting only the consumer card account enrollment, chip and/or PIN, capture image of a card, or any PCI compliant manner, and/or any others described hereinabove, and combinations thereof. By way of example, the enrollment mechanisms include but are not limited to, a web-based API that provides for automatic enrollment with no latency, i.e., the real-time enrollment of an electronic payment card occurs with the customer using the card for a transaction with a participating merchant member, or the customer may register one or more electronic payment cards with an online enrollment with an interactive website, or onsite with a member merchant with a card reader form factor, and/or with an electronic form factor, such as a tablet computer, even without making a purchase at the time of enrollment. Preferably, whenever any payment is made through one or more of the associations or processor, whether cash (in any currency), credit, debit, etc. on electronic payment card accounts, that authorization file and settlement file and corresponding data is automatically provided to the loyalty and rewards platform of the present invention through a communications or data network to the database(s) and server(s) of the loyalty and rewards platform, whenever the customer member makes an electronic payment at the member merchant. The data includes authorization date, time, merchant identifier, location identifier, and combinations thereof.

The loyalty and rewards platform of the present invention provides rewards or loyalty and rewards points or other units to the customer member account, which is associated directly with any of the electronic payment cards of the customer member that are enrolled with the loyalty and rewards platform. The loyalty and rewards points or units are automatically attributed to the customer member account, and are applicable to spend with any and all merchant members within the loyalty and rewards platform in electronic form, without requiring any additional action, selection, or indication by the customer of how or when the loyalty and rewards points or rewards will apply, and to which merchants. Preferably, the loyalty and rewards points are convertible automatically into any incentive available on the loyalty and rewards platform at any time. The format may include automatic credit to the electronic payment card account, prepaid cards, etc., and is preferably “paperless”, i.e., the system automatically indicates, tracks, and stores data on the incentives and points available to any customer at any time, and tracks redemption and/or cash credit to the customer accounts.

From business model standpoint, the present invention systems and methods further provide for a seamless settlement of the redeemed offer by providing for automatic debit or automatic payment by the merchant members accounts, as they provide permission to debit the merchant and/or processor account at the time a customer activates and redeems an offer provided by that merchant within the loyalty and rewards platform of the present invention.

Customer Activation of an Offer.

Preferably, real-time data is used to message customer members about offers from member merchants, including offers to join, earn and redeem loyalty and rewards points or units within the loyalty and rewards platform of the present invention. Following customer enrollment in the loyalty and rewards platform, the customer can see all merchant members associated with the system, search for offers and search for merchants of interest, for merchants within the network and also for merchants that are not yet included in the network. Activation of an offer is by click-select and automatic loading to the electronic payment card(s) associated with the customer profile following enrollment. The offer can be added to the electronic payment card automatically for automatic redemption, by the user “claiming the offer” through an action online such as clicking a link, the offer may be added with a purchase transaction (buy now and redeem later), pre-paid cards, the ability for the automatic redemption on a card, and/or a trigger activation of an offer may be provided online or through customer activity or proximity to a merchant member location.

The present invention systems and methods also preferably leverage email marketing mechanisms, e.g., constant contact, etc. to connect customer behavior to customer action with member merchants. So preferably, all promotions in the loyalty and rewards platform of the present invention are provided in a digital format or on a digital “surface”, that connect to downstream customer behavior and spend as evidenced by the enrolled electronic payment card transactions of the customers with the member merchants. By way of example and not limitation, the customer click-selects a digital advertisement online or presented in an email or website format, and load or input or import the corresponding digital incentive to a customer profile or account on the loyalty and rewards platform of the present invention (the Spring profile) and automatically load it to the electronic payment cards (or accounts) that are associated with that customer profile within the loyalty and rewards platform. Then, any subsequent electronic payment with the corresponding customer cards at the member merchant automatically provide for the redemption or discount associated with the digital incentive offered online by the member merchant.

In one embodiment of the present invention, automatic enrollment through a purchase transaction includes the steps of: the system receiving an electronic payment customer account number or identifier (including for example but not limitation, a credit card capture number); receiving a permission from the corresponding customer (user) corresponding to the electronic payment customer account number or identifier; receiving customer contact information (by way of example and not limitation, name, address, phone number, email address, and combinations thereof); automatically creating a customer profile from the information received; automatically enrolling the customer and corresponding customer profile as a participant (or member) in the loyalty and rewards platform. The present invention systems and methods provide for at least two ways for customers to join the marketplace or network: 1) when a user purchases something, whether an online e-commerce check out or a card present transaction at POS in a store, that transaction also is functionally equivalent to an automated enrollment (and importantly, because the user so indicates and provides a permission); 2) a customer user first joins through one of many potential entry points—for example at a first merchant, Merchant #1. After that, when the user simply pays with an enrolled card at another merchant in the network, that creates the potential for the user to “join” the rewards program of that #2-N merchant on an automatic, opt-out or opt-in basis. This is a very powerful way for all merchants in the network to build their rewards member list because normal swipes is functionally equivalent to joining to customers, if already in from somewhere else. Real-time notice to users based on authorization data (or data coming out of the POS) is important to make this work for the user when swiping and automatically joining thereby at merchant 2-N.

Notably, the present invention systems and methods provide for automatic customer enrollment of multiple cards (or electronic payment devices) of any card type, and/or from different issuing banks, following receipt of near real time authorization or copy of capture data from electronic payment transactions by the customer at the at least one merchant participating in the loyalty and rewards platform of the present invention. At least one primary account number associated with a customer is used for automatic enrollment with the loyalty and rewards platform; other cards or electronic payment accounts may be further included and associated with that customer profile based upon future transactions (and automatic inputting of alternate accounts at the time of the transactions for customers already associated with the loyalty and rewards platform). Customers may create a corresponding customer profile at the time of enrollment.

Optionally, additional method steps include: automatically associating the customer profile with at least one merchant registered within the loyalty and rewards platform of the present invention; automatically generating at least one advertisement, promotion, and/or incentive for the customer based upon patterns generated from customer behavior and corresponding association data that are stored in a database and analyzed by at least one server computer in electronic communication connection with the database. Significantly, no prior art enrollment methods provide for automatic enrollment of multiple cards of any card type and/or from different issuing banks, since the prior art systems and methods do not receive near real time authorization or copy of capture data.

The systems and methods of the present invention provide for activation of an offer (incentive, loyalty and rewards benefit, reward, and combinations thereof) extended by a merchant participating in the loyalty and rewards platform of the present invention to at least one customer, including at least one of the following steps: automatically adding the offer to the electronic payment account of the corresponding customer(s); automatically presenting an offer for the customer(s) to purchase and redeem later in association with at least one of the customer accounts identified or stored with the loyalty and rewards platform; and/or automatically crediting the account and/or triggering the offer when a customer makes a purchase of goods or services associated with the offer and/or the merchant associated with the offer.

Loyalty and Rewards Platform Communication and Data.

The present invention systems and methods provide for the ability to communicate with any customer member following enrollment by any means for any electronic payment card or device account associated with the customer member. The communications methods may be provided by email, text or SMS, native application on mobile and tablet computer devices, automatically through geographic location functionality and corresponding software, email CRM and marketing communications, etc. Advantageously, the presentation, targeting, communicating, tracking, reporting, analytics, offer types, redemption, and customer behaviors relating to spend compared with offers presented are included with the present invention loyalty and rewards platform communications and data associated with the customer electronic payment transactions. All methods of merchant offer discovery by the customers and/or promotion to customers is provided within the scope of the present invention. The data analytics and reporting may be provided to member merchants, to member customers, or to partners of the loyalty and rewards platform to facilitate assessment of success of the loyalty and rewards behavior corresponding to digital incentives provided by any means. Thus, the present invention uniquely provided direct correlation of targeted advertising in any electronic format to actions taken and to spend activity by the customers on a transaction basis and with respect to trends or behavior over time.

Spend Informed User Base and Spend Informed User Base Service(s).

Spend-informed user base or audience and spend informed user base service(s) includes any consumer user active with any form of digital surface or asset, including a web page, email, mobile application, text message, etc., where that activity by the consumer user can be informed by or services enhanced by that user's past or future spend behavior information using a payment mechanism or form factor including a payment card account (including account number) or functionally equivalent mechanism. Examples of use of previous “upstream” payment information include targeting certain messages or advertisements or content to the user based on such data. For example, the presentation of advertisements (ads) or other content to users varies based on user spend information and ability for platform to discern user status (e.g., to identify if the user is in a merchant rewards program or not, if the user has made a purchase or spend at predetermined merchant(s) within last predetermined number of days or not, whether the user spends a financial value above a predetermined amount or not, already in merchants email list or not, and combinations thereof; if the user has spent at predetermined geography scope, location(s), category or time, therefore a content is likely to be relevant to user; enable different pricing to merchant depending on character of user (e.g. new customer within last predetermined timeframe or not) and presentation surface; and combinations thereof.

An example of use of future or “downstream” spend behavior by consumer users includes any tracking of user spend behavior after interacting with content on digital surface.

In another use case, the platform provides an aggregated group of consumer users with platform-registered (or platform-enrolled) corresponding payment card account information, and the platform is operable for receiving by the at least one server computer, storing and analyzing in the database, the consumer users' spend data and product and/or services included in each purchase. A merchant client runs a non-digital marketing campaign or a digital marketing campaign that does not include direct click-stream tracking to the users' spend behavior. The comparative aggregate normalized spend behavior of various users groups and users before and after the campaign be reported and analyzed. Example: 1,000,000 users are enrolled in Spring in Chicago. 50K in a given merchant's rewards program. Merchant runs a radio campaign. The spend behavior of both user pools is tracked and analyzed to show “view through” or “hear through” vs. click through response.

Spend Informed User Base Service(s) should also include any service with a mechanism to credit value to users based on their spend behavior in relation to any marketing or promotion activity or service. For example, crediting a user $X because they took a certain action in relation to a promotion to that user.

Methods of Developing Spend Informed User Base.

Associated with Customer Use of a Payment Card Account.

The present invention systems and methods provide for consumer user sign up mechanisms with the platform that are automatically activated when the consumer user makes a purchase using an electronic payment card account, such as by way of example and not limitation, by making a payment for goods and/or services via a credit card having a magnetic strip at a point of sale (POS) device (“a card-swipe”). Currently, card-swipe works with the platform of the present invention when the consumer user has registered or signed up online or via a platform-enabled mechanism (e.g., a tablet computer located at a merchant that is registered or associated with the platform), subsequently the user makes a transaction at another registered merchant, and the consumer user is presented with a message on a graphic user interface of a display on the POS mechanism, that allows the user to activate another unrelated part of the platform ecosystem (e.g. at an unrelated second merchant's program). These steps may include an opt-out, opt-in or automatic (no message at all) basis.

The systems, methods, and platform of the present invention operate to allow the consumer user to register automatically remotely via different mechanisms and methods that functionally operate to “sign user up once anywhere in the network”, i.e., to provide for the consumer user to register in a single instance within the platform from any one of a variety of methods, mechanisms, and/or activities that include a single purchase or spend by the consumer user at any of the registered merchants within the platform using the at least one consumer user electronic payment card account. By sharp contrast to the present invention, all prior art rewards programs require that users enroll multiple times at multiple merchants, and/or take more than one action to activate rewards or digital incentives with multiple merchants and/or multiple payment card accounts; they must re-enroll the user including their need to provide their payment card account number through at least a second specific subscription process or step(s).

Associated with Payment to a Business or Through a Service.

The present invention systems and methods provide that when a consumer user pays a merchant for goods or services, capturing users or audience for any service other than customer paying their bill for that transaction through any mechanism of card account number capture, and/or a way to communicate with user (e.g. through email or text), whether through user opt-in, opt-out or automatically (without explicit consent). So, for example, the way customers pay through prior art Square's tablet POS (or other similar providers e.g. Breadcrumb, Groupon POS, Shopkeep, etc.), would not allow the service to then convert those customers into users of some other service e.g. a rewards or loyalty program, unless they sign up a different way; this is a longstanding problem with the prior art. The present invention provides for automatic capture of a customer user's payment card account information and/or capture of a customer user email address or text number for a mobile phone or smartphone, followed by and/or associated with automatically generating and sending a message at the at least one server computer over the network to the consumer user's mobile device, wherein the message indicates that the user can opt-in or out of joining the platform automatically. Preferably, the systems, methods, and platforms of the present invention extends to and includes any and all other payment card acceptance vehicles or mechanisms (e.g. VeriFone terminals, conventional POS, payment for something online on a website, etc.).

Conversion of Payment Card Accounts on File.

Many e-commerce companies have large user bases who have purchased something through that company's website and given permission to maintain that card on file. Notable examples include Apple iTunes, Groupon, Livingsocial, Amazon, etc., Braintree and their Venmo e-commerce service that allows sites to share this permission, and the like. For example, if you buy something on Uber and provide a card on file, you can buy something through AirBnB without providing a new payment card, but just using the one in the Venmo enabled service.

Preferably, the systems and methods of the present invention provide for the automatic conversion of these payment-card-on-file accounts into electronic payment card accounts enrolled in a service that enables or utilizes spend informed users, as described herein, and/or registered with the platform of the present invention, which is not described, disclosed, or used in the prior art. By way of example, the following use cases are illustrated for the present invention.

When a consumer user purchases something, the consumer user spend or purchase activity with a payment card account, the system co-incidentally and automatically is enrolling the payment card account and providing a permission to terms of use or privacy policies that are a Spend Informed User service. Whether opt in, opt out or automatically. Once a consumer user has registered with the platform of the present invention, including providing at least one electronic payment card account and a profile, if there is a card-on-file, separate from a purchase transaction, the consumer user provides a permission, such as opt in, opt out, or automatically, to include the other payment card accounts, such as the card-on-file.

Scheduling App+Card Linked Offer.

The present invention provides the system with the ability to present or accept or use any advertisement or marketing content to a consumer user that may be accepted and linked to their electronic payment card account through or in association with or adjacent to their use of any appointment booking or scheduling application. For example and not limitation, the method steps of: making a reservation at a restaurant using Open Table or similar web-based application, or making a reservation at a health or beauty provider using SalonBooker.com, SpaBooker.com, SpaFinder.com, or LifeBooker.com or similar web-based application. Either of these method steps that provide for making an appointment or scheduling a reservation automatically provide the functionality of sign up for the user with the systems and methods of the present invention. Additionally, a time-window based incentive that is conditional upon taking an action or making a step such as scheduling an appointment or reservation using a predetermined website-based application from a remote communications device may be provided, e.g. dine Tuesday after 5 p.m. and receive $20 off your bill.

Protect Products that Monetize.

Digital incentives are operable automatically within any of the at least one consumer user payment card accounts registered with the platform by the consumer user and/or associated with the consumer user profile on the platform. Digital incentives may be provided as a flat rate discount, a flat rate for predetermined products or services in specified, predetermined, and/or quantity, a discount rate as a percentage for total spend or purchase at at least one merchant registered within the system to participate in the platform of the present invention. For example, a digital incentive may provide the consumer user to save $10, save 10%, and/or save $10 or 10%, on the next purchase at predetermined merchant(s) of the platform.

Digital incentives created by and associated with the platform, systems, and methods of the present invention are provided to consumer users can be activated many ways, based on many conditions or automatically, for example, a click-select action by a customer user in a GUI of a website or mobile app GUI automatically activates a digital incentive associated therewith.

Digital incentives (DIs) can have conditions, restrictions, and/or limitations required for their redemption automatically on the consumer user's payment card account(s) registered with the platform and/or associated with the consumer user profile stored on the platform database. By way of example and not limitation, automatically triggering the automatic redemption by satisfying conditions, restrictions, and/or limitations associated with the digital incentive occurs in the following types of scenarios: purchase amount or spend of X value (in a currency) is required to trigger the DI, a predetermined number of visits within a predetermined time frame to a predetermined merchant or merchants are required to trigger the DI, a transaction for purchase or spend must occur within a predetermined time window defined by a start time, or a start time and an end time (e.g., beginning Tuesday after 5 p.m., or Tuesday between 10 a.m. and 2 p.m., etc.), only a limited quantity of items or instances of services are available, customer user must have a certain status (e.g., has not yet completed a transaction with at least one predetermined merchant in last predetermined number of days, or is or is not a member of merchant's rewards program or on their email list), a pre-purchase is required (and then the DI works automatically through use of that or any payment card on the consumer users' profile or platform account, an advance sale product or service for a predetermined merchant as agreed upon in advance, and combinations thereof.

None of the prior art publications and/or commercial providers or promoters of deals provide for any mechanism to electronically link to or integrate with a payment card or with a payment card account for consumer users. In those prior art references, users purchase a deal using a payment card such as a credit card used online for completing the purchase, but any aspect of redemption, including tracking and crediting, is not managed through the user's payment card account, as with the platform, systems and methods of the present invention. The present invention systems, methods, and integrated platform operate to promote a deal or other incentive to consumer users, have consumer users purchase it, or otherwise activate it including through a click-select or other input or event, and/or with a device or mechanism as described herein), and have its presentation and redemption in relation to the corresponding transaction with the merchant associated with and receivable of the deal or incentive, and provide for automatic administration and management of the redemption through the consumer user payment card account.

By way of additional detailed description of the platform, systems and methods of the present invention, included in the functionality and operation for providing for any mechanism to electronically link to or integrate with a payment card or with a payment card account for consumer users, the following illustrative steps, components or features are provided: the purchase or spend behavior of consumer users evidenced by data from the consumer user payment card account(s) is preferably tracked, analyzed, and/or reported, which then provides for significantly improved targeted content and targeted advertisement that is data-confirmable by the purchase or spend behavior of consumer users and the corresponding granularity of the data from their payment card accounts. Additionally and advantageously, consumer users payment card account mechanism is operable to convey value to the user, for example by automatically applying an electronic financial credit related to an incentive to the consumer user through one of their payment card accounts registered with their profile within the platform of the present invention.

Multi-merchant or multi-visit incentive products.

The virtualized computing and network-based platform, systems, and methods of the present invention function to provide consumer users with incentives that are merchant-agnostic, i.e., they may work at more than one merchant or more than one visit. For example, in an alternative embodiment, platform is configured so that the consumer user having a registered consumer user account with at least one consumer user payment card account associated therewith, and having a user profile within the platform, when a consumer user pays a predetermined amount $X and receive an incentive worth $X multiplied by Y, which generates a credit for the multiplied digital incentive (up to a maximum or cap that is predetermined), wherein the multiplied digital incentive value usable in $X increments for each transaction at any merchant in the platform's network. Following the steps of purchasing or otherwise activating via click-select or other GUI in a website or mobile app, a consumer user can visit a platform-registered merchant (digitally online or physically in a merchant location) and automatically receive a digital incentive in a predetermined amount (e.g., $10) and this repeats until up to a maximum predetermined amount or cap (e.g., $200, which is 20 multiplied by $10) worth of digital incentives are aggregated or used. In an alternative embodiment, platform is configured so that the consumer user having a registered consumer user account with at least one consumer user payment card account associated therewith, and having a user profile within the platform, pay $X and receive $X as digital incentive whenever the consumer user visits merchant A until the end of B time period. For example, once activated by purchase or otherwise, a consumer user as patron of a restaurant (merchant A) automatically receives the digital incentive each time they transact within the predetermined time period B. There are other permutations of multi-merchant and multi-visit digital incentive packages that can be formulated; preferably, merchant users of the platform select predetermined digital incentive packages offered by the platform after their registration to participate as sponsoring merchants for a merchant subscription service fee in one business model implementation of the present invention, and/or for a customized digital incentive package having a corresponding customized fee.

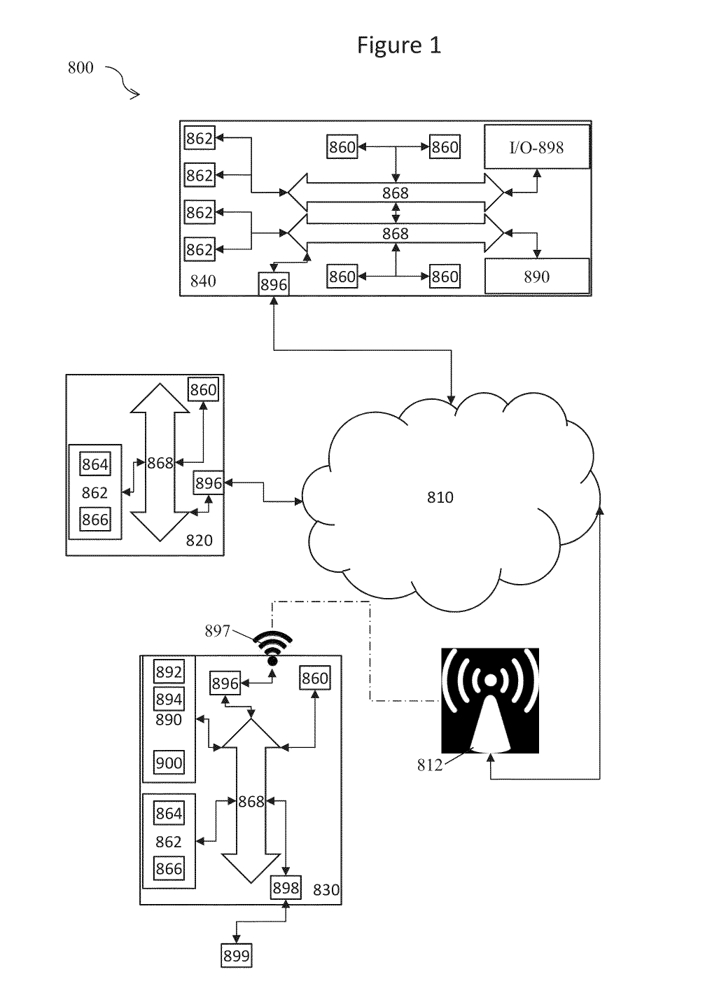

The present invention systems, methods, and platform provide for automated customer loyalty and/or rewards programs that function on, through, and/or in association with payment card accounts of consumer users, preferably those consumer users that are registered to participate in the platform, and who have a customer profile and have registered at least one consumer user payment card account, thereby providing for automated and integrated functionality with any activity for payments of those at least one consumer user payment card account. Thus, the spend behavior evidenced by the activity for payments of those at least one consumer user payment card account is provided automatically and stored within the database(s) associated with the platform and the at least one server computer of the system, illustrated in FIG. 1. The spend behavior includes at least the amount of the purchase and detailed information about the goods and/or services included in each purchase, date and time of purchase, location of purchase (or indication of online website- or mobile app-based purchase), and combinations thereof. The platform for targeted digital incentives of the present invention provides for spend or visit based programs where the consumer user earns a digital incentive for spend behavior, wherein the spend behavior related digital incentives are selected from the following activities: spend at the merchant directly associated with the initial digital incentive (a first merchant), spend at other merchants, earn a reward at the first merchant, earn another reward currency, such as a notional value currency. Notional value currencies are useable by consumer users at one or more merchants affiliated within the integrated platform for marketing, advertising, and management of digital incentives with more than one otherwise unrelated merchants who are participating within the platform. Also, points based currencies redeemable at various places or for various goods and services.

The systems and methods of the present invention also function to provide consumer users the ability to enroll multiple payment cards in their profile and have spent on any of them aggregate up to their benefit on the profile level.

In a business model application of the present invention, the platform access is provided in exchange for payment by consumer users and/or merchant users for subscription-based services which allow access and profile management and maintenance during the subscription services period. In one example of the business method model, each of the consumer users pays a subscription fee on a periodic basis (e.g., monthly) for access to incentives (offers and rewards) and privileges useable at platform-affiliated or registered merchants.

Marketing Products Connect to Customer Rewards Program.

A differentiator from the prior art is that marketing incentive products provided by the present invention platform, systems and methods that merchant clients or registered merchants with the platform use to advertise to potential new customers, also drive customer memberships in their rewards program in a seamless and integrated manner, without requiring additional steps, documentation, or registration by the customer, since the consumer user registers with the platform of the present invention, creates a single profile, registers at least one customer user payment card account with the platform, and is automatically registered for all participating merchant members and their merchant rewards programs. For example, if a business sends an audience a $10 incentive, those potential customers from that audience that accept the digital incentive, register with the present invention platform in a single registration as described herein, and automatically and immediately receive the benefit of that digital incentive, and are automatically enrolled in that merchant's rewards program without requiring a redundant, or second registration step or action by the consumer user, according to the present invention. Thus, the present invention provides for consumer user interaction the platform, and the ad or marketing product digital incentive received and used by the consumer user provide for automatic enrollment and registration in merchant-specific reward programs or membership listing or other mechanism of any kind that allows merchant to have access to that consumer user's spend behavior data and/or to communicate with them (e.g. through email or otherwise) in the future regarding advertising, digital or other incentives, awards rewards, coupons, and combinations thereof, and to track the efficacy of those communications by comparison with the corresponding consumer user spend behavior data, including trends, patterns, confirming specific actions with respect to communications in time, frequency and type of spend, and combinations thereof.

Protecting Access to the Payment Data.

The platform, systems and methods of the present invention protect access to the payment data from any and all payment data sources, including but not limited to card networks (VISA, MasterCard, American Express, Discover, etc.), payment processors associated with merchants, financial institutions and card issuers, Point of Sale (POS) and card acceptance terminals (such as VeriFone), and any combinations thereof.

Methods the Facilitate Redemption of an Offer or Incentive through a Payment Card Account.

Prior art provides for many consumers to purchase offers from distributors, like Groupon or Livingsocial, wherein redemption is managed through the presentation of a voucher by the consumer to the merchant. In most cases, this process is manual, and use a physical paper voucher to present to the merchant for receipt of the goods and/or services. In prior art electronic vouchers, consumers present an electronic voucher through a GUI representation of the voucher, e.g., the Groupon mobile app. Prior art methods also provide for merchants to manage redemption through a device provided by the distributor (e.g., Groupon), however this method still requires a manual entry or other input, such as by scanning a bar code; another process provides for a device provided by the distributor at merchant locations at the POS that employs proximity-based detection if a user of the Groupon mobile app is present, and if so, it facilitates redemption of the electronic voucher.

By contrast to the prior art, the present invention systems and methods facilitate redemption of offers and incentives (“deals”), including those provided by third party distributors (such as Groupon), by allowing consumer users to link the offer to their payment card account. There are several methods providing for redemption of offers and incentives and for managing redemption. By way of example, a consumer user purchases an offer through a deal distributor (e.g. Amazon Local), wherein the deal is provided by a third party on behalf of a merchant; the system provides an electronic voucher by transmitting a message or presenting on a GUI of a computer display or mobile communications device, such as a smartphone, wherein the consumer user receives an electronic voucher including a code or link having an identifier; the consumer user, via a website interactive GUI or mobile device app, enters the identifier if already a member of the platform, or if not a member first registers or joins the platform; the system automatically associates or links the offer or deal represented by the inputted identifier with the consumer user profile on the platform, and with any enrolled payment card accounts associated with the platform; the redemption is automatically executed by the platform of the present invention with the next transaction by the consumer user with the merchant using an enrolled payment card account. In another example, the method steps are similar to the first example described above, however, the user at the time of presentation of the offer or deal to the merchant has not yet linked the offer to their payment card account; in this example, the system accepts the identifier via at least one input mechanism or device at the merchant location, physical and/or virtual; in one embodiment, the consumer user inputs the identifier in a tablet computer that presents platform, with or without branding or identifier of the merchant's customer rewards program; this overall redemption facilitation mechanism is also used to track customer spend behavior and data capture, and provides a way to communicate with the consumer user in the future even if the merchant does not have a structured rewards program. In this use case example, the consumer user enrolls in the platform by providing a communication attribute (by way of example and not limitation, email, and/or phone number for text message) and electronic payment account number or identifier (e.g., enrollment is activated by the step of providing input via swiping on a card reader or magnetic strip mechanism, touch or proximity activation mechanism, smart chip, etc., or other mechanism including but not limited to providing a photo or digital image of the user); an action is taken to link the presented offer to the users Spring account, for example, in an automated method with code entry, bar code scan, QR code scan, or a just a button or GUI interactive selection to “Link Offer”; thereafter, the consumer user completes a purchase transaction with the merchant using an enrolled payment card account, and the platform administers redemption as described hereinabove. Another use case example provides for the merchant not to utilize this platform redemption mechanism to manage the crediting portion of the redemption of the incentive, but instead deducts the value of the incentive from the customer's transaction at the time in-store. So, in this case, the platform does not automatically manage the redemption or crediting of the incentive back to the consumer user's payment card account. But since the consumer user is enrolled then the platform will automatically track and report their payment behavior with their payment card account so that the platform and the merchant may track customer spend related to the redemption transaction and downstream. Notably, in addition to enabling redemption by linking an offer to the payment card account, the merchant also automatically through the platform obtains a member in its customer loyalty or rewards program and/or database and the consumer user obtains the benefits of this membership.

Another redemption mechanism provided by the present invention is the combination of a payment card account mechanism with a software application to a specific “item-level” product or service. Notably, the prior art payment card account data streams on their own do not identify the exact item or product purchased for any given transaction. The present invention provides for automatic redemption of these specific item-level transactions which are specific to a product or service, through the various mechanisms described herein. By way of example and not limitation, one category of mechanisms provides for a member of the merchant staff to confirm a purchase by the user of the eligible item, product, and/or service through a predetermined, platform-supported mechanism, such as activation of a code, button, functional identifier, virtual button, GUI input identifier, active icon, etc., on a tablet computer or consumer user's mobile communications device or smartphone software application (app), etc. Another category includes platform integration with an item level data source, such as the merchant's POS or branded loyalty platform; preferably, the systems and methods of the present invention provide for automatically creating a multiplicity of customer user accounts on the platform wherein the merchant has aggregated its proprietary customer user account information from a loyalty program, a rewards program, a customer mailing list, etc. by importing the aggregated data by the at least one server computer and/or database associated with the systems, methods, and platform of the present invention.

Description of the Figures.

Referring now to the drawings in general, the illustrations are for the purpose of describing a preferred embodiment of the invention and are not intended to limit the invention thereto.

FIG. 1 illustrates an exemplary virtualized computing system for embodiments of the present invention loyalty and rewards platform. FIG. 1 is a schematic diagram of an embodiment of the invention illustrating a computer system, generally described as 800, operating within a communications network 810 and a plurality of computing devices 820, 830, 840. In one embodiment of the invention, the computer system supporting the platform of the present invention 800 includes a cloud-based network 810 for distributed communication via the network's wireless communication antenna 812 and processing by a plurality of mobile communication computing devices 830. In another embodiment of the invention, the computer system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital devices 820, 840, 850 and mobile devices 830, such as a server, blade server, mainframe, mobile phone, a personal digital assistant (PDA), a smart phone, a desktop computer, a netbook computer, a tablet computer, a workstation, a laptop, and other similar computing devices; distributed mobile communication devices, in particular wireless network mobile computer communication devices including but not limited to smartphone devices and tablet computers are preferred at the time of the present invention for use by consumer users as described herein for interfacing with the platform. The components shown here in FIG. 1, their connections and relationships, and their functions, are meant to be exemplary only, and are not meant to limit implementations of the invention described and/or claimed in this document.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers) or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown in FIG. 1, a computing device 840 may use multiple processors 860 and/or multiple buses 868, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to the bus 868. Computing devices may communicate communication media through wired networks, direct-wired connections or wirelessly such as acoustic, RF or infrared through a wireless communication antenna 897 in communication with the network's wireless communication antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications or other data embodying any one or more of the methodologies or functions described herein. The computer readable medium may include the memory 862, the processor 860, and/or the storage device 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory or other solid state memory technology, disks or discs (e.g., digital versatile disks (DVD), HD-DVD, BLU-RAY, compact disc (CD), CD-ROM, floppy disc) or other optical storage, magnetic cassettes, magnetic tape, magnetic disk storage or other magnetic storage devices, or any other medium that can be used to store the computer readable instructions and which can be accessed by the computer system 800. A database is preferably included in the system and connected with at least one server computer of the system described, wherein the database stores consumer users' spend data, including product and/or services for each purchase made with registered electronic payment accounts, information about which are also stored on the database.

It is also contemplated that the computer system 800 may not include all of the components shown in FIG. 1, may include other components that are not explicitly shown in FIG. 1, or may utilize an architecture completely different than that shown in FIG. 1. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The present invention provides for advertising network and “spring-loaded” ad units. These flow even if the user is not signed up, with or without the card on file. They may flow if a user is signed up, whether online and cookied electronically, and in signed-in state or not. This provides a mechanism for gaining new members, financed by the promoting merchant's funding of the incentive and payment for the media.

The present invention provides for all capabilities that online advertising networks have, plus additional payment capabilities, including but not limited to targeting, advertisement serving, etc. Prizes and games may also be included.

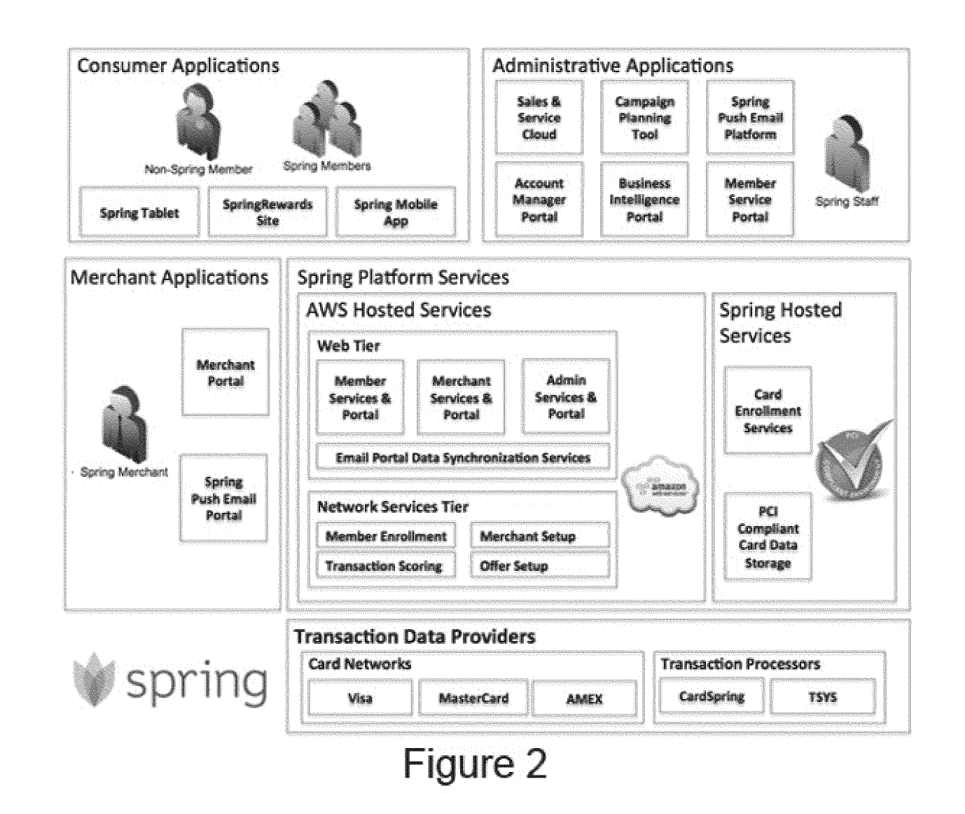

FIG. 2 illustrates a schematic diagram of components of the invention illustrating the consumer applications, merchant applications, administrative applications, platform, hosted services, a web tier, card enrollment services, network services tier including member enrollment, transaction scoring, merchant setup and offer setup modules, portal data synchronization services, consumer users, merchant users or members, transaction data providers and transaction processors. FIG. 2 illustrates one embodiment of the present invention for illustrative purposes only; it is an example implementation of the present invention system, methods, and platform and is provided for illustration purposes and is not intended to exclusively limit the claimed invention. The following description corresponds to FIG. 2 schematic diagram.

Spring Consumer Applications are responsible for enrolling new members and engaging with them. The Spring Tablet is a fast and simple to use Member enrollment application. Tablets are native iOS apps written in Objective-C, typically installed on iPad Mini 2's. The Tablet uses ID Tech Uni-Mag 2 card readers and advanced DUKPT (Dynamic Unique Key per Transaction) encryption algorithms that guarantee secure communication with Spring's Card Enrollment Services. Encrypted card data is transferred to endpoints in the Spring Data Center and decrypted by a Key Appliance from StrongAuth.

Tablet computers capture and transmit Member emails, card tokens and merchant enrollment data to the Spring Platform. The SpringRewards.com web site (aka Member Portal) allows consumers to sign-up for Spring, enroll their credit or debit cards, join Merchant Rewards Programs, Claim Cash Back Offers and Gifts, Purchase Advance Sale Offers, Invite Friends, View Offer Reward, and Transaction Status, and Modify their profile. The responsively designed web site is hosted in the cloud at AWS and built in Ruby, Backbone.js, Bootstrap, HTML, CSS and Javascript. SpringRewards.com is supported by a RESTful set of web services written Ruby. Event driven member SMS and email messages are delivered through Twillio and Amazon Simple Email Services (SES).

Spring Mobile Apps include Native Android and iPhone Mobile Apps for Members will be released early in Q3. These Apps will provide push notifications, geo-location based searching and geo-targeted offering capabilities. These native apps will be built using Apache Cordova, HTML, CSS and Javascript. Spring Administrative Applications enable Spring staff to manage the Spring Platform and Operations.

Spring has customized Sales & Services Clouds and integrated them with the Spring Platform. As Merchants and/or Offers are closed through the sales process they can be added to SpringRewards.com with a push of a button via custom integrations built in APEX code.

Spring Members may open Service Cases or use Live Chat directly from SpringRewards.com, which places these into the platform's Service Cloud.

Campaign Planning Tool: the system supporting Spring Marketing generates predetermined and/or custom offer sets for each Spring Member for use in various campaigns using a rule based relevancy engine. The custom offer sets are determined by scoring all available offers using a custom rule engine that looks at Geographic Data, and Consumer Behavior, Recency and Frequency data to rank each offer. Offer sets can then be published to Spring's Push Email Platform via the Campaign Planning Tool. The Campaign Planning Tools are built in Ruby and run in the AWS Cloud.

The platform (Spring) Push Email Portal allows the platform (Spring) to deliver mass promotional mailings to Spring and Merchant email lists using the MyEmma platform. The Spring Platform integrates with MyEmma in real time via an API that provides membership data for targeting and segmentation. Opt-in and opt-out data is also synchronized in real time. Campaign response data is also synchronized with Spring's Merchant and Account Manager Portals.

Data Synchronization Services are built in to be integrated with the system and methods of the present invention and platform as described hereinabove.

The Account Manager Portal allows Spring Staff to lookup Spring Merchants and review key Membership, Program and Campaign business Metrics.

The application may be hosted in the cloud at AWS and built in Ruby, Backbone.js, HTML, CSS and Javascript.

The Business Intelligence Portal application provides Spring Staff with pull and push reporting of key operational and business metrics. The Spring Business Intelligence Portal is built on the Logi Analytics platform.

The Member Services Portal allows Spring staff to troubleshoot customer issues and perform basic customer service functions. The application is hosted in the cloud at AWS and built in Ruby, Backbone.js, HTML, CSS and Javascript.

Merchant Applications include a Merchant Portal, which allows Spring Merchants to review key Membership, Rewards Program and Campaign business Metrics.

The application is hosted in the cloud at AWS and built in Ruby, Backbone.js, HTML, CSS and Javascript.

Spring Push Email Portal (Optional) Spring (the platform) supports Merchants who wish to deliver their own Newsletter or Communicaton mailings using the MyEmma platform. The Spring Platform integrates with MyEmma in real time via an API which provide membership data for targeting and segmentation. Opt-in and opt-out data is also synchronized in real time. Campaign response data is also synchronized with Spring's Merchant and Account Manager Portals.

Spring Platform Services include a Web Tier wherein all Consumer, Merchant and Administrative applications are supported by a variety of web services hosted in the Cloud at Amazon and built in Ruby.

Network Services Tier includes the platform website, SpringRewards.com, and the Web Tier is integrated with a back end set of services collectively referred to as the Network Services tier. The Network Services tier provides integration of the Spring Platform with external transaction providers such as Visa, Mastercard, American Express, CardSpring and TSYS. These services enroll Members and Cards with the external partners, and are responsible for receiving and scoring card swipe Transactions notifications from these partners. The Network Services tier is built in Java, using the Vert.x application framework.

Spring Data Center: Card Enrollment Services are a special class of Network Services and are hosted in the Spring Data Center for PCI Compliance. Card Data is kept encrypted from point to point and stored in a security key appliance from StrongAuth.

Card Data Services communicate with transaction providers during the enrollment and un-enrollment processes.

FIGS. 3-84 illustrate graphic user interface (GUI) diagrams of embodiments of the invention (corresponds to GUIs from PPA).

Certain modifications and improvements will occur to those skilled in the art upon a reading of the foregoing description. Preferably the loyalty and rewards platform of the present invention is compatible with any electronic payment systems or formats, including any point of sale (POS) electronic payment transaction at a merchant. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for customer loyalty and rewards platform establishment and management of operation, comprising:
at least one server computer supporting the platform constructed and configured for connection over a virtualized cloud-based system for distributed communication via a communication network with at least one remote mobile computing device;
software is operable on the at least one remote mobile computing device to receive inputs from a corresponding at least one consumer user for creating a consumer user profile registered through the at least one server computer and stored in a platform database;
the consumer profile including at least a consumer username, contact information, and at least one consumer user payment account registered with the platform;
the server computer operable for automatically sending, activating, and redeeming at least one digital incentive for a financial amount by applying the financial amount as a credit or discount for a predetermined spend activity by the consumer user at a registered merchant within the platform.

2. The system of claim 1, wherein the at least one remote mobile computing device is selected from a tablet computer, a smartphone, a laptop computer, and combinations thereof.

3. The system of claim 1, further comprising:
a mechanism for automatically registering the consumer user at least one payment card account with the platform;
wherein the mechanism receives information for the at least one payment card account at a point of sale (POS) when the consumer user presents the at least one payment card account for making electronic payment for goods and/or services at the POS.

4. The system of claim 1, wherein the mechanism is a POS payment device.

5. The system of claim 1, wherein the platform provides an aggregated group of consumer users with platform-registered corresponding payment card account information.

6. The system of claim 1, wherein the platform is operable for receiving by the at least one server computer, storing and analyzing in the database, the consumer users' spend data and product and/or services included in each purchase.

7. The system of claim 1, wherein the database stores consumer users' spend data, including product and/or services for each purchase.

8. The system of claim 1, wherein the at least one server computer is operable to provide data analytics and reporting to member merchants, to member customers, and/or to partners of the platform via messaging sent over the communications network to corresponding remotely distributed communications devices.

9. The system of claim 1, wherein the at least one payment account is selected from the group consisting of: credit, debit, electronic payment, and/or card account.

10. The system of claim 1, wherein the customer user profile is automatically associated with at least one digital incentive for redemption with at least one merchant registered within the platform.

11. The system of claim 1, wherein each of the customer user profiles includes at least one credit, debit, and/or other electronic payment card accounts or electronic payment accounts, and a spend history of redeemed promotional or discount offers.

12. The system of claim 1, wherein at least one server computer of the platform automatically activates digital incentives upon confirmation of a trigger event.

13. The system of claim 12, wherein the digital incentive(s) are conditional upon the detection of the trigger event.

14. The system of claim 1, wherein aggregated customer user data is automatically imported and registered with the platform by the at least one server computer.

15. The system of claim 1, wherein each customer user is automatically and immediately enrolled with merchant loyalty programs for all merchants registered with the platform following initial registration for the customer user.

16. The system of claim 1, wherein the customer user registration is received and stored by the at least one server computer following website-based customer user inputs or customer user purchase activity with a customer user electronic payment card at any merchant registered with the platform coupled with receiving an indication of customer user permission.

17. A method for customer loyalty and rewards platform establishment and operation, comprising at least one server computer supporting the platform constructed and configured for connection over a virtualized cloud-based system for distributed communication via a communication network with at least one remote mobile computing device, wherein software is operable on the at least one remote mobile computing device, the method comprising the steps of the server computer operable for:
receiving consumer user inputs from the at least one remote mobile computing device;
creating a consumer user profile registered through the at least one server computer;
storing in a platform database, the consumer profile including at least a consumer username, contact information, and at least one consumer user payment account registered with the platform;
automatically sending, activating, and redeeming at least one digital incentive for a financial amount by applying the financial amount as a credit or discount for a predetermined spend activity by the consumer user at a registered merchant within the platform.

18. The method of claim 17, further including the steps of receiving by the at least one server computer, and storing and analyzing in the database, consumer users' spend data including product and/or services for each purchase.

19. The method of claim 17, further including the steps of the at least one server computer providing data analytics and reporting to member merchants, to member customer users, and/or to partners of the platform.

20. The method of claim 17, credit, debit, electronic payment, and/or card account enrollment automatically, as well as the functions of adding promotional and/or discount offer(s) to profile, adding cards, credit, debit, and other electronic payment card accounts or electronic payment accounts, redeeming promotional or discount offers, real-time automated functionality, providing data for a marketplace of vendors and customers, including account and activity data, providing a coalition network model, and combinations thereof.

21. The method of claim 17, further including the steps of aggregating customer user data associated with predetermined merchants.

22. The method of claim 17, further including the step of the at least one server computer automatically importing and registering aggregated customer user profiles and corresponding data with the platform.

23. The method of claim 17, wherein each customer user is automatically enrolled an all merchant member loyalty programs upon initial registration by the customer user with the platform, without requiring any additional steps.
